SEQUENCE LISTING (99 sequences)

SEQ ID NO: 1 - protein, 119 aa, synthetic construct
  REGION 1..119: note = Synthetic VHH sequence.
DVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 2 - protein, 119 aa, synthetic construct
  REGION 1..119: note = Synthetic VHH sequence.
QVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 3 - protein, 10 aa, synthetic construct
  REGION 1..10: note = Synthetic VHH sequence.
RSIFSINAMD

SEQ ID NO: 4 - protein, 9 aa, synthetic construct
  REGION 1..9: note = Synthetic VHH sequence.
GITRGGTTK

SEQ ID NO: 5 - protein, 11 aa, synthetic construct
  REGION 1..11: note = Synthetic VHH sequence.
LRGEQPWTRDY

SEQ ID NO: 6 - protein, 117 aa, synthetic construct
  REGION 1..117: note = Synthetic VHH sequence
QVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 7 - protein, 10 aa, synthetic construct
  REGION 1..10: note = Synthetic VHH sequence
GTIFRPTAMG

SEQ ID NO: 8 - protein, 9 aa, synthetic construct
  REGION 1..9: note = Synthetic VHH sequence.
TITTGGSTK

SEQ ID NO: 9 - protein, 9 aa, synthetic construct
  REGION 1..9: note = Synthetic VHH sequence.
QWGVRTRDY

SEQ ID NO: 10 - protein, 126 aa, synthetic construct
  REGION 1..126: note = Synthetic VHH sequence.
QVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 11 - protein, 10 aa, synthetic construct
  REGION 1..10: note = Synthetic VHH sequence.
ISDRAFSRHV

SEQ ID NO: 12 - protein, 10 aa, synthetic construct
  REGION 1..10: note = Synthetic VHH sequence.
AIGWTGRRTY

SEQ ID NO: 13 - protein, 15 aa, synthetic construct
  REGION 1..15: note = Synthetic VHH sequence.
SHFYSVSFEINDYDY

SEQ ID NO: 14 - protein, 117 aa, synthetic construct
  REGION 1..117: note = Synthetic VHH sequence.
DVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 15 - protein, 126 aa, synthetic construct
  REGION 1..126: note = Synthetic VHH sequence.
DVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 16 - protein, 118 aa, synthetic construct
  REGION 1..118: note = VHH sequence 40F07
QVQLQESGGGLVQAGGSLRLSCVASGTTFSSYTMGWYRQAPGKQRELLASIEGGGNTDYADSVKGRFTISRDNARNTVYLQMNSLKTEDTAVYYCNAARTWSIFRNYWGQGTQVTVSS

SEQ ID NO: 17 - protein, 115 aa, synthetic construct
  REGION 1..115: note = VHH sequence 41D01
QVQLQESGGGLVQAGGSLRLSCAASGRTFSRYGMGWFRQLPGKQRELVTSITRGGTTTYADSVKGRFTISRDNAKNTVYLQMNSLKPEDTAVYYCNARSIWRDYWGQGTQVTVSS

SEQ ID NO: 18 - protein, 116 aa, synthetic construct
  REGION 1..116: note = VHH sequence 41D06
QVQLQESGGGLVQAGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 19 - protein, 121 aa, synthetic construct
  REGION 1..121: note = VHH sequence 41G10
QVQLQESGGGLVQPGGSLTLSCAATKTGFSINAMGWYRQAPGKQREMVATITSGGTTNYADSVKGRFAISRDNAKNTVSLQMNTLKPEDTALYYCNTEARRYFTRASQVYWGQGTQVTVSS

SEQ ID NO: 20 - protein, 120 aa, synthetic construct
  REGION 1..120: note = VHH sequence 41H05
QVQLQESGGGLVQPGGSLRLSCAASGGIFSINAMGWYRQDPGKQREMVATITSGANTNYTDSVKGRFTISRDNAKNTVYLQMNSLKPEDTAVYYCNAVGRRWYGGYVELWGQGTQVTVSS

SEQ ID NO: 21 - protein, 119 aa, synthetic construct
  REGION 1..119: note = VHH sequence 42C11
QVQLQESGGGLVQPGGSLRLSCAASGSIFSTYVMGWYRQAIGKQRELVATITSSGKTNYAASVKGRFTVSRDITKNTMYLQMNSLKPEDTAVYYCGADRWVLTRWSNYWGQGTQVTVSS

SEQ ID NO: 22 - protein, 116 aa, synthetic construct
  REGION 1..116: note = VHH sequence 42C12
QVQLQESGGGLVQPGGSLRLSCAASGSISSLGWYRQAPGKQREFVASATSGGDTTYADSVKGRFTISRDNSKNTVYLQMNSLKPEDTAVYYCKGQRGVAWTRKEYWGQGTQVTVSS

SEQ ID NO: 23 - protein, 119 aa, synthetic construct
  REGION 1..119: note = VHH sequence 50D03
QVQLQESGGGLVQPGGSLRLSCAASGSIFSTYAMGWYRQAIGKQRELVATITSSGKTNYAASVKGRFTISRDITKNTMYLQMNSLKPEDTAVYYCGADRWVLTRWSNYWGQGTQVTVSS

SEQ ID NO: 24 - protein, 120 aa, synthetic construct
  REGION 1..120: note = VHH sequence 50D07
QVQLQESGGGLVQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 25 - protein, 119 aa, synthetic construct
  REGION 1..119: note = VHH sequence 50E02
QVQLQESGGGLVQPGGSLRLSCAASGSIFSINAMGWYRQAPGKQRELVAAITSDGSTNYADSVKGRFTISRDNAKNTAYLQMNSLKPEDTAVYYCNLRRRTFLKSSDYWGQGTQVTVSS

SEQ ID NO: 26 - protein, 123 aa, synthetic construct
  REGION 1..123: note = VHH sequence 51B08
QVQLQESGGGLVQAGDSLRLSCAASGRRFGSYAMGWFRQVPGKERELVAGISSGGSTKYADSVRGRFTISRDNAKNTVSLQMKSLKPEDTAVYYCNAKYGRWTYTGRPEYDSWGQGTQVTVSS

SEQ ID NO: 27 - protein, 116 aa, synthetic construct
  REGION 1..116: note = VHH sequence 51C06
QVQLQESGGGLVQPGGSLRLSCAASGSIFSSDTMGWYRRAPGKQRELVAAITTGGNTNYADSVKGRFTISRDNAKNTVYLQMNSLQPEDTAVYYCNCRRRWSRDFWGQGTQVTVSS

SEQ ID NO: 28 - protein, 119 aa, synthetic construct
  REGION 1..119: note = VHH sequence 51C08
QVQLQESGGGLVQPGGSLRLSCAASGTIFSIKTMGWYRQAPGKQRELVATISNGGSTNYADSVKGRFTISRDNAKNTVYLQMNSLKPEDTAVYYCNARQQFIGAPYEYWGQGTQVTVSS

SEQ ID NO: 29 - protein, 115 aa, synthetic construct
  REGION 1..115: note = VHH sequence 52A01
QVQLQESGGGLVQAGGSLRLSCTASGAITFSLGTMGWYRQAPGKQRELVASISTGSTNYADSVKGRFTISRDIIKNILYLQMNSLKPEDTAVYSCNARLLWSNYWGQGTQVTVSS

SEQ ID NO: 30 - protein, 117 aa, synthetic construct
  REGION 1..117: note = VHH sequence 52B01
QVQLQESGGGLVQAGESLRLSCAASGSTFSINVMGWYRQAPGEQRELVATISRGGSTNYADSVKGRFTISRDNAKVTVYLQMDSLKPEDTAVYYCNAAGWVGVTNYWGQGTQVTVSS

SEQ ID NO: 31 - protein, 117 aa, synthetic construct
  REGION 1..117: note = VHH sequence 52G05
QVQLQESGGGLVQAGGSLRLSCAASGSTGSISAMGWYRQAPGKQRELVASITRRGSTNYADSVKDRFTISRDNAWNTVYLQMNSLKPEDTAVYYCNARRYYTRNDYWGQGTQVTVSS

SEQ ID NO: 32 - protein, 114 aa, synthetic construct
  REGION 1..114: note = VHH sequence 53A01
QVQLQESGGGLGQAGGSLRLSCEVSGTTFSINTMGWHRQAPGKQRELVASISSGGWTNYADSVKGRFTISRDNAKKTVYLQMNNLKPEDTAVYYCRWGAIGNWYGQGTQVTVSS

SEQ ID NO: 33 - protein, 117 aa, synthetic construct
  REGION 1..117: note = VHH sequence 53F05
QVQLQESGGGLVQPGGSLRLSCAASVRIFGLNAMGWYRQGPGKQRELVASITTGGSTNYAEPVKGRFTISRDNANNTVYLQMNNLKPEDTAVYYCNAERRWGLPNYWGQGTQVTVSS

SEQ ID NO: 34 - protein, 126 aa, synthetic construct
  REGION 1..126: note = VHH sequence 54A02
QVQLQESGGGLVEAGGSLRLSCAASGRTFSRYGMGWFRQAPGKEREFVAANRWSGGSTYYADSVRGRFTISRDNAKNTVYLQMNSLKPEDTAVYYCAAYAHITAWGMRNDYEYDYWGQGTQVTVSS

SEQ ID NO: 35 - protein, 125 aa, synthetic construct
  REGION 1..125: note = VHH sequence 54B01
QVQLQESGGGLVQAGGSLRLSCAATGRTFSRYTMGWFRQAPGKERDFVAGITWTGGSTDYADSVKGRFTISRDNAKNTVYLQMNSLKPEDTAVYYCAAGNLLRLAGQLRRGYDSWGQGTQVTVSS

SEQ ID NO: 36 - protein, 129 aa, synthetic construct
  REGION 1..129: note = VHH sequence 54C01
QVQLQESGGGLVQAGGSLRLSCAASGRTGSRYAMGWFRQAPGKEREFVAAISWSGGSTYYADSVKDRFTISRDNAKNTVYLQMHSLKPEDTAVYYCATRNRAGPHYSRGYTAGQEYDYWGQGTQVTVSS

SEQ ID NO: 37 - protein, 121 aa, synthetic construct
  REGION 1..121: note = VHH sequence 54C04
QVQLQESGGGLVQPGGSLRLSCAASGRIFSINAMGWYRQGPGKERELVVDMTSGGSINYADSVSGRFTISRDNAKNTVYLQMNSLKPEDTAVYYCHANLRTAFWRNGNDYWGQGTQVTVSS

SEQ ID NO: 38 - protein, 115 aa, synthetic construct
  REGION 1..115: note = VHH sequence 54C08
QVQLQESGGGLVQPGGSLRLSCAASGSISSINAMGWYRQAPGKQRELVASITSGGSTNYADSVKGRFTISRDNAKNTVNLQMNSLKPEDTAVYYCSAGPWYRRSWGRGTQVTVSS

SEQ ID NO: 39 - protein, 116 aa, synthetic construct
  REGION 1..116: note = VHH sequence 54C10
QVQLQESGGGLVQPGESLRLSCAASASIFWVNDMGWYRQAPGKQRELVAQITRRGSTNYADSVKGRFTISRDNAKDEVYLQMNSLKPEDTAVYYCNADLAVRGRYWGQGTQVTVSS

SEQ ID NO: 40 - protein, 119 aa, synthetic construct
  REGION 1..119: note = VHH sequence 54C11
QVQLQESGGGLVQPGGSLRLSCAASGSFFPVNDMAWYRQALGNERELVANITRGGSTNYADSVKGRFTISRDNAKNTVYLQMNTLKPEDTAVYYCNVRIGFGWTAKAYWGQGTQVTVSS

SEQ ID NO: 41 - protein, 116 aa, synthetic construct
  REGION 1..116: note = VHH sequence 54D03
QVQLQESGGGLVQPGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 42 - protein, 116 aa, synthetic construct
  REGION 1..116: note = VHH sequence 54D06
QVQLQESGGGLVQPGGSLRLSCAASGSTIRINAMGWYRQAPGKQRELVATITRGGITNYADSVKGRFTISRDNAKFTVYLQMNSLKPEDTAVYYCNARSWVGPEYWGQGTQVTVSS

SEQ ID NO: 43 - protein, 120 aa, synthetic construct
  REGION 1..120: note = VHH sequence 54D10
QVQLQESGGGLVQPGGSLRLSCAASGMTYSIHAMGWYRQAPGKERELVAITSTSGTTDYTDSVKGRFTISRDGANNTVYLQMNSLKSEDTAVYYCHVKTRTWYNGKYDYWGQGTQVTVSS

SEQ ID NO: 44 - protein, 117 aa, synthetic construct
  REGION 1..117: note = VHH sequence 54E01
QVQLQESGGGLVQPGGSLRLSCTASGSIFSINPMGWYRQAPGKQRELVAAITSGGSTNYADYVKGRFTISRDNAKNVVYLQMNSLKPEDTAVYYCNGRSTLWRRDYWGQGTQVTVSS

SEQ ID NO: 45 - protein, 117 aa, synthetic construct
  REGION 1..117: note = VHH sequence 54E05
QVQLQESGGGLVQPGGSLRLSCAASGSIFSINTMGWYRQAPGKQRELVAAITNRGSTNYADFVKGRFTISRDNAKNTVYLQMNSLKPDDTAVYYCNAHRSWPRYDSWGQGTQVTVSS

SEQ ID NO: 46 - protein, 118 aa, synthetic construct
  REGION 1..118: note = VHH sequence 54E10
QVQLQESGGGLVQPGGSLRLSCAASGSIFSFNAMGWYRQAPGKQRELVAAITRGGSTNYADSVKGRFTISRDNANNTVYLQMNSLKPEDTAVYYCNAESRIFRRYDYWGPGTQVTVSS

SEQ ID NO: 47 - protein, 115 aa, synthetic construct
  REGION 1..115: note = VHH sequence 54F01
QVQLQESGGGLVQPGGSLRLSCVTSGSIFGLNLMGWYRQAPGKQRELVATITRGGSTNYADSVKGRFTISRDNAKKTVYLQMNSLKPEDTAVYYCNVDRGWSSYWGQGTQVTVSS

SEQ ID NO: 48 - protein, 119 aa, synthetic construct
  REGION 1..119: note = VHH sequence 54F02
QVQLQESGGGLVQPGGSLRLSCVTSGSIRSINTMGWYRQAPGNERELVATITSGGTTNYADSVKNRFTISRDNAKNTVYLQMNSLKPEDTAVYYCNLHQRAWARSYVYWGQGTQVTVSS

SEQ ID NO: 49 - protein, 117 aa, synthetic construct
  REGION 1..117: note = VHH sequence 54G01
QVQLQESGGGSVQPGGSLRLSCAASGSIFAVNAMGWYRQAPGHQRELVAIISSNSTSNYADSVKGRFTISRDNAKNTVYLQMNSLKPEDTAVYFCYAKRSWFSQEYWGQGTQVTVSS

SEQ ID NO: 50 - protein, 121 aa, synthetic construct
  REGION 1..121: note = VHH sequence 54G08
QVQLQESGGGLVQPGGSLRLSCAASGSIFSFNLMGWYRQAPGKQRELVAAITSSSNTNYADSVKGRFTISRDNAKNTVYLQMNSLKPEDTAVYYCNAQYTITPWGIKKDYWGQGTQVTVSS

SEQ ID NO: 51 - protein, 120 aa, synthetic construct
  REGION 1..120: note = VHH sequence 54G09
QVQLQESGGGLMQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 52 - protein, 117 aa, synthetic construct
  REGION 1..117: note = VHH sequence 55B02
QVQLQESGGGLVQPGESLRLSCVGSGSIFNINSMNWYRQASGKQRELVADMRSDGSTNYADSVKGRFTISRDNARKTVYLQMNSLKPEDTAVYYCHANSIFRSRDYWGQGTQVTVSS

SEQ ID NO: 53 - protein, 125 aa, synthetic construct
  REGION 1..125: note = VHH sequence 55B05
QVQLQESGGGVVQAGDSLRLSCAASGRTFGGYTVAWFRQAPGKEREFVARISWSGIMAYYAESVKGRFTISRDNAKNTVYLQMNSLKPEDTAVYYCASRSQIRSPWSSLDDYDRWGQGTQVTVSS

SEQ ID NO: 54 - protein, 116 aa, synthetic construct
  REGION 1..116: note = VHH sequence 55C05
QVQLQESGGGLVQPGGSLRLSCVVSGSISSMKAMGWHRQAPGKERELVAQITRGDSTNYADSVKGRFTISRDNAKNTVYLQMNSLKPDDTGVYYCNADRFFGRDYWGKGTQVTVSS

SEQ ID NO: 55 - protein, 120 aa, synthetic construct
  REGION 1..120: note = VHH sequence 55D08
QVQLQESGGGLVQPGGSLRLSCAASRSILSISAMGWYRQGPGKQREPVATITSAGSSNYSDSVKGRFTISRDNAKNTAYLQMNSLKPEDTAVYYCKTVYSRPLLGPLEVWGQGTQVTVSS

SEQ ID NO: 56 - protein, 115 aa, synthetic construct
  REGION 1..115: note = VHH sequence 55E02
QVQLQESGGGLVQTGGSLRLSCVASGSMFSSNAMAWYRQAPGKQRELVARILSGGSTNYADSVKGRFTISRGNAKNTVYLQMNSLKPEDTAVYYCNAVRYLVNYWGQGTQVTVSS

SEQ ID NO: 57 - protein, 121 aa, synthetic construct
  REGION 1..121: note = VHH sequence 55E07
QVQLQESGGGSVQVGDSLTLSCVASGRSLDIYGMGWFRQAPGKEREFVARITSGGSTYYADSVKGRFTLSRDNAKNTVYLQMNSLKPEDTAVYYCAAGVVVATSPKFYAYWGQGTQVTVSS

SEQ ID NO: 58 - protein, 116 aa, synthetic construct
  REGION 1..116: note = VHH sequence 55E09
QVQLQESGGGLVQAGGSLRLSCAASKRIFSTYTMGWFRQAPGKEREFVAAIIWSGGRTRYADSVKGRFTISRDNARNTVHLQMNSLEPEDTAVYYCYTRRLGTGYWGQGTQVTVSS

SEQ ID NO: 59 - protein, 115 aa, synthetic construct
  REGION 1..115: note = VHH sequence 55E10
QVQLQESGGGLVQAGGSLRLSCAASGSTFSIQTIGWYRQAPGKQRDRVATISSGGSTNYADSVKGRFTISRDNAKKTVYLQMNNLKPEDTAVYYCNLRYWFRDYWGQGTQVTVSS

SEQ ID NO: 60 - protein, 115 aa, synthetic construct
  REGION 1..115: note = VHH sequence 55F04
QVQLQESGGGLVQPGGSLRLSCAASGSTFSINVRGWYRQAPGKQRELVATITSDGSTNYADSVKGRFTISRDNAKNTAYLQMNSLKPEDTAVYYCNAVRLFRQYWGQGTQVTVSS

SEQ ID NO: 61 - protein, 125 aa, synthetic construct
QVQLQESGGGLVQPGGSLRLSCAASGSIFRLNAMGWYRQAPGKQRELVAAITPGGGNTTYADSVKGRFTISRDNALNTIYLQMNSLKPEDTAVYYCNAGGSSRWYSSRYYPGGYWGQGTQVTVSS

SEQ ID NO: 62 - protein, 126 aa, synthetic construct
  REGION 1..126: note = VHH sequence 55F10
QVQLQESGGGLVQAGGSLRLSCATSGGTFSRYAMGWFRQAPGKERELVATIRRSGSSTYYLDSTKGRFTISRDNAKNTVYLQMNSLKLEDTAVYYCAADSSARALVGGPGNRWDYWGQGTQVTVSS

SEQ ID NO: 63 - protein, 118 aa, synthetic construct
  REGION 1..118: note = VHH sequence 55G02
QVQLQESGGGLVQPGGSLRLSCAASGSIGSINVMGWYRQYPGKQRELVAFITSGGITNYTDSVKGRFAISRDNAQNTVYLQMNSLTPEDTAVYYCHLKNAKNVRPGYWGQGTQVTVSS

SEQ ID NO: 64 - protein, 116 aa, synthetic construct
  REGION 1..116: note = VHH sequence 55G08
QVQLQESGGGLVQPGGSLRLSCRASGGIFGINAMRWYRQAPGKQRELVASISSGGTTDYVESVKGRFTISRDNATNTVDLQMSALKPEDTAVYYCNFVRFWFPDYWGQGTQVTVSS

SEQ ID NO: 65 - protein, 116 aa, synthetic construct
  REGION 1..116: note = VHH sequence 56A05
QVQLQESGGGLVQAGGSLRLSCAASGITFMSNTMGWYRQAPGKQRELVASISSGGSTNYADSVKGRFTISRDNAKKTVYLQMNSLKPEDTAVYYCNARRNVFISSWGQGTQVTVSS

SEQ ID NO: 66 - protein, 114 aa, synthetic construct
  REGION 1..114: note = VHH sequence 56A06
QVQLQESGGGLVQPGGSLRLSCVASGSISVYGMGWYRQAPGKQRELVARITNIGTTNYADSVKGRFTISRDNAKNTVYLQMNSLQPEDTAVYYCNLRRLGRDYWGQGTQVTVSS

SEQ ID NO: 67 - protein, 118 aa, synthetic construct
QVQLQESGGGLVQPGGSLRLSCAASRTALRLNSMGWYRQAPGSQRELVATITRGGTTNYADSVKGRFTISREIGNNTVYLQMNSLEPEDTAVYYCNANFGILVGREYWGKGTQVTVSS

SEQ ID NO: 68 - protein, 116 aa, synthetic construct
  REGION 1..116: note = VHH sequence 56C09
QVQLQESGGGLVQAGGSLRLSCAVSGSIFSILSMAWYRQTPGKQRELVANITSVGSTNYADSVKGRFTISRDIAKKTLYLQMNNLKPEDTAIYYCNTRMPFLGDSWGQGTQVTVSS

SEQ ID NO: 69 - protein, 111 aa, synthetic construct
  REGION 1..111: note = VHH sequence 56C12
QVQLQESGGGLVQAGGSLRLSCAVSAFSFSNRAVSWYRQAPGKSREWVASISGIRITTYTNSVKGRFIISRDNAKKTVYLQMNDLRPEDTGVYRCYMNRYSGQGTQVTVSS

SEQ ID NO: 70 - protein, 117 aa, synthetic construct
  REGION 1..117: note = VHH sequence 56D06
QVQLQESGGGSVQPGGSLRLSCAASGTVFFSISAMGWYRQAPGKQRELVAGISRGGSTKYGDFVKGRFTISRDNGKKTIWLQMNNLQPEDTAIYYCRLTSITGTYLWGQGTQVTVSS

SEQ ID NO: 71 - protein, 114 aa, synthetic construct
  REGION 1..114: note = VHH sequence 56D07
QVQLQESGGGLVQPGGSLRLSCAASGSIFSMKVMGWYRQGPGKLRELVAVITSGGRTNYAESVKGRFTISRDNAKNTVSLQMNSLQPEDTAVYYCYYKTIRPYWGQGTQVTVSS

SEQ ID NO: 72 - protein, 120 aa, synthetic construct
  REGION 1..120: note = VHH sequence 56D10
QVQLQESGGGLVQAGGSLRLSCAASGITFRITTMGWYRQAPGKQRELVASSSSGGTTNYASSVKGRFTISRDNAKNTVYLQMNSLRPEDTAVYYCNARKFITTPWSTDYWGQGTQVTVSS

SEQ ID NO: 73 - protein, 116 aa, synthetic construct
  REGION 1..116: note = VHH sequence 56E04
QVQLQESGGGLVQPGDSLRLSCTPSGSIFNHKATGWYRQAPGSQRELVAKITTGGTTNYADSVKGRFTISRDNAKNTVYLQMSSLKPEDTAVYYCNAERYFATTLWGQGTQVTVSS

SEQ ID NO: 74 - protein, 119 aa, synthetic construct
  REGION 1..119: note = VHH sequence 56E05
QVQLQESGGGLVQAGGSLRLSCAASGITFSNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 75 - protein, 121 aa, synthetic construct
  REGION 1..121: note = VHH sequence 56E08
QVQLQESGGGLVQAGGSLRLSCAASGNIFRINDMGWYRQAPGNQRELVATITSANITNYADSVKGRFTISRDNAKNTVYLQMNSLNPEDTAVYYCTAQAKKWRIGPWSDYWGQGTQVTVSS

SEQ ID NO: 76 - protein, 119 aa, synthetic construct
  REGION 1..119: note = VHH sequence 56F07
QVQLQESGGGLVQPGGSLRLSCAASGRIFSINDMAWYRQAPGKQRELVAIITNDDSTTYADSVKGRFTISRDNAKNTVYLQMNSLKPEDTAVYYCNADINTAIWRRKYWGQGTQVTVSS

SEQ ID NO: 77 - protein, 121 aa, synthetic construct
  REGION 1..121: note = VHH sequence 56F11
QVQLQESGGGLVQSGGSLRLSCVHSKTTFTRNAMGWYRQALGKERELVATITSGGTTNYADSVKGRFTISMDSAKNTVYLQMNSLKPEDTAVYYCNVNTRRIFGGTVREYWGQGTQVTVSS

SEQ ID NO: 78 - protein, 115 aa, synthetic construct
  REGION 1..115: note = VHH sequence 56G07
QVQLQESGGGLVQPGGSLRLSCAVSGSRIFIHDMGWHRQAPGEPRELVATITPFGRRNYSEYVKGRFTVSRDIARNTMSLQMSNLKAEDTGMYYCNVRVNGVDYWGQGTQVTVSS

SEQ ID NO: 79 - protein, 119 aa, synthetic construct
  REGION 1..119: note = VHH sequence 56G08
QVQLQESGGGLVQAGGSLRLSCAISGITFRRPFGISRMGWYRQAPGKERELVATLSRAGTSRYVDSVKGRFTISRDDAKNTLYLQMVSLNPEDTAVYYCYIAQLGTDYWGQGTQVTVSS

SEQ ID NO: 80 - protein, 117 aa, synthetic construct
  REGION 1..117: note = VHH sequence 56G10
QVQLQESGGGLVQAGGSLRLSCVASGITLRMYQVGWYRQAPGKQRELVAEISSRGTTMYADSVKGRFTISRDGAKNIVYLQMNSLEPEDTAVYYCNARAFAFGRNSWGQGTQVTVSS

SEQ ID NO: 81 - protein, 118 aa, synthetic construct
QVQLQESGGGSVQAGGSLRLSCAVSGGTFSNKAMGWYRQSSGKQRALVARISTVGTAHYADSVKGRFTVSKDNAGNTLYLQMNSLKPEDTAVYYCNAQAGRLYLRNYWGQGTQVTVSS

SEQ ID NO: 82 - protein, 119 aa, synthetic construct
  REGION 1..119: note = VHH sequence 56H05
QVQLQESGGGLVQPGESLRLSCVAAASTSITTFNTMAWYRQAPGKQRELVAQINNRDNTEYADSVKGRFIISRGNAKNTSNLQMNDLKSEDTGIYYCNAKRWSWSTGFWGQGTQVTVSS

SEQ ID NO: 83 - protein, 114 aa, synthetic construct
  REGION 1..114: note = VHH sequence 56H07
QVQLQESGGGLVQAGGSLRLSCTASGLTFALGTMGWYRQAPGKQRELVASISTGSTNYADSVKGRFTISRDIIKNILYLQMNSLKPEDTAVYSCNARLWWSNYWGQGTQVTVSS

SEQ ID NO: 84 - protein, 118 aa, synthetic construct
  REGION 1..118: note = VHH sequence 56H08
QVQLQESGGGLVQAGGSLRLSCTASGRTSSVNPMGWYRQAPGKQRELVAVISSDGSTNYADSVKGRFTVSRDNAKNTLYLQMNSLKPEDTAVYYCNANRRWSWGSEYWGQGTQVTVSS

SEQ ID NO: 85 - protein, 119 aa, synthetic construct
  REGION 1..119: note = VHH sequence 57A06
QVQLQESGGGLVQAGGSLRLSCAASGITFTNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 86 - protein, 116 aa, synthetic construct
  REGION 1..116: note = VHH sequence 57B01
QVQLQESGGGLVQAGGSLRLSCEAPVSTFNINAMAWYRQAPGKSRELVARISSGGSTNYADSVKGRFTISRDNAKNTVYLQMNSLKPEDTAVYICYVNRHWGWDYWGQGTQVTVSS

SEQ ID NO: 87 - protein, 122 aa, synthetic construct
  REGION 1..122: note = VHH sequence 57B07
QVQLQESGGGLVQPGGTLRLSCVASGSFRSINAMGWYRQAPGKQRELVATVDSGGYTNYADSVKGRFTISRDNAKNTVYLQMSSLTPEDTAVYYCYAGIYKWPWSVDARDYWGQGTQVTVSS

SEQ ID NO: 88 - protein, 117 aa, synthetic construct
  REGION 1..117: note = VHH sequence 57B11
QVQLQESGGGLVQAGGSLRLSCAASGSSISMNSMGWYRQAPGKERERVALIRSSGGTYYADSVKGRFTISRDNAKNTVYLQMNNLKPEDTAVYYCQARRTWLSSESWGQGTQVTVSS

SEQ ID NO: 89 - protein, 122 aa, synthetic construct
  REGION 1..122: note = VHH sequence 57C07
QVQLQESGGGLVQAGGSLRLSCAVSGSTFGINTMGWYRQAPEKQRELVASISRGGMTNYADSVKGRFIISRDNAKNTVYLQMNSLKPEDTAVYVCNAGIRSRWYGGPITTYWGQGTQVTVSS

SEQ ID NO: 90 - protein, 121 aa, synthetic construct
  REGION 1..121: note = VHH sequence 57C09
QVQLQESGGGLVQAGGSLRLSCAASGSTGSINAMGWYRQGPGKQRDLVASISSGGATNYADSVKGRFTISRDNSKNTVYLQMSSLKPEDTAVYYCNAKKSRWSWSIVHDYWGQGTQVTVSS

SEQ ID NO: 91 - protein, 118 aa, synthetic construct
  REGION 1..118: note = VHH sequence 57D02
QVQLQESGGGSVQTGGSLTLSCTTSGSIFGRSDMGWYRQAPGKQRELVATITRRSRTNYAEFVKGRFTISRDSAKNLVTLQMNSLKPEDTNVYYCNARWGAGGIFSTWGQGTQVTVSS

SEQ ID NO: 92 - protein, 120 aa, synthetic construct
  REGION 1..120: note = VHH sequence 57D09
QVQLQESGGGLVQPGESLRLSCAASGSMSIDAMGWYRQAPGDQRELVASITTGGSTNYADSVKGRFTISRDNAKNTVWLQMNSLKPEDTAVYYCNAKVRLRWFRPPSDYWGQGTQVTVSS

SEQ ID NO: 93 - protein, 122 aa, synthetic construct
  REGION 1..122: note = VHH sequence 57D10
QVQLQESGGGLVQPGGSLRLSCAASGRLLSISTMGWYRRTPEDQREMVASITKDGTTNYADSVKGRLTISRDNAKNTVYLQMNSLKPDDTAVYVCNARATTWVPYRRDAEFWGQGTQVTVSS

SEQ ID NO: 94 - protein, 120 aa, synthetic construct
  REGION 1..120: note = VHH sequence 57E07
QVQLQESGGGLVQAGGSLRLSCAASGSIFGINDMGWYRQAPGKQRDLVADITRSGSTHYVDSVKGRFTISRDNAKNTVYLQMNSLKPEDTAVYYCNADSGSHWWNRRDYWGQGTQVTVSS

SEQ ID NO: 95 - protein, 118 aa, synthetic construct
  REGION 1..118: note = VHH sequence 57E11
QVQLQESGGGLVQPGGSLKLSCAASGFTFSINTMGWYRQAPGKQRELVARISRLRVTNYADSVKGRFTISRDNAKNTVYLQMNSLKPEDTAVYYCNAANWGLAGNEYWGQGTQVTVSS

SEQ ID NO: 96 - protein, 116 aa, synthetic construct
  REGION 1..116: note = VHH sequence 57G01
QVQLQESGGGLVQAGGSLRPSCTASGSTLLINSMGWYRQAPGKQRELVATISNSGTTNYVDAVKGRFAISRDNANHTVYLQMNSLEPEDTAVYYCNAQTFWRRNYWGQGTQVTVSS

SEQ ID NO: 97 - protein, 116 aa, synthetic construct
  REGION 1..116: note = VHH sequence 57G07
QVQLQESGGGLVQAGGSLRLSCAVSGSTSRINAMGWYRQAPGKKRESVATIRRGGNTKYADSVKGRFTISRDNANNTVYLQLNSLKPEDTAVYYCNAHSWLDYDYWGRGTQVTVSS

SEQ ID NO: 98 - protein, 114 aa, synthetic construct
  REGION 1..114: note = VHH sequence 57G08
QVQLQESGGGLVQAGGSLRLSCASRRRINGITMGWYRQAPGKQRELVATIDIHNSTKYADSVKGRFIISRDNGKSMLYLQMNSLKPEDTAVYYCNRIPTFGRYWGQGTQVTVSS

SEQ ID NO: 99 - protein, 118 aa, synthetic construct
  REGION 1..118: note = VHH sequence 57H08
QVQLQESGGGLVQAGGSLRLSCVASGSTFYTFSTKNVGWYRQAPGKQRELVAQQRYDGSTNYADSLQGRFTISRDNAKRTVYLQMNSLKPEDTAVYICNVNRGFISYWGQGTQVTVSS

(19) United States
(12) Patent Application Publication
(10) Pub. No.: US 2026/0026500 A1
(43) Pub. Date: Jan. 29, 2026

(54) AGROCHEMICAL COMPOSITIONS

(71) Applicant: BIOTALYS NV, Gent (BE)

(72) Inventors: Benjamin S BOWER, Raleigh, NC (US); Jan Jozef Lutgart GEERINCK, Gent (BE); Enrico FERRARINI, Gent (BE); Rachel A HILLMER, Raleigh, NC (US)

(21) Appl. No.: 19/143,996

(22) PCT Filed: Dec. 29, 2023
(86) PCT No.: PCT/US2023/086359

§ 371 Date: Jun. 27, 2025

Related U.S. Application Data
(60) Provisional application No. 63/477,624, filed on Dec. 29, 2022.

(51) Int. Cl. A01N 37/46; A01N 63/50; A01P 3/00

(52) U.S. Cl. CPC A01N 37/46; A01N 63/50; A01P 3/00

(57) ABSTRACT

The invention relates to a composition comprising at least one polypeptide and at least one cell wall disrupting agent. The invention further relates to a composition comprising at least one polypeptide and at least one cell wall disrupting agent, for example wherein the at least one polypeptide is an antibody or fragment thereof such as a heavy chain variable domain of a heavy chain antibody (VHH) or a functional fragment thereof. The antibody or fragment thereof may be capable of binding to a fungus. The invention further relates to methods and use of the compositions disclosed herein. The invention relates to methods for protecting or treating a plant or a part of said plant from an infection with a plant pathogenic fungus, a post-harvest treatment method for protecting or treating a harvested plant or a harvested part of said plant from an infection with a plant pathogenic fungus and a method of inhibiting the growth of, or killing, a plant pathogenic fungus, comprising at least the step of applying to a plant or to a part of said plant the composition disclosed herein.

### FIELD OF THE INVENTION

The present invention relates to a composition comprising at least one polypeptide and at least one cell wall disrupting agent, optionally wherein the at least one polypeptide is an antibody or fragment thereof such as a heavy chain variable domain of a heavy chain antibody (VHH) or a functional fragment thereof, which antibody or fragment thereof is capable of binding to a fungus. The invention further relates to methods and use of the compositions disclosed herein. The invention relates to methods for protecting or treating a plant or a part of said plant from an infection with a plant pathogenic fungus, a post-harvest treatment method for protecting or treating a harvested plant or a harvested part of said plant from an infection with a plant pathogenic fungus and a method of inhibiting the growth of, or killing, a plant pathogenic fungus, comprising at least the step of applying to a plant or to a part of said plant the composition disclosed herein.

### BACKGROUND

The presence and persistence of pathogenic fungal infections seen in patients and animals but also in plant crops can be mainly attributed to the selective pressure of broad-spectrum anti-fungals and the general lack of efficacy of anti-fungal agents, which are available at present.

The use of purified or transgenic plants expressing specific cell wall disrupting or degrading enzymes has been suggested in the art. For instance, a bifunctional peptidoglycan/chitin hydrolase isolated from Lactobacillus was shown to prevent hyphae formation of a fungal pathogen (WO2020079278), a purified chitinase from Trichoderma cell was shown to reduce disease severity caused by Botrytis cinerea on cucumber leaves (Aoki Yoshinao, Haga Sanami, Suzuki Shunji, Direct antagonistic activity of chitinase produced by Trichoderma sp SANA20 as biological control agent for grey mould caused by Botrytis cinerea. Cogent Biology, 2020, Vol 6 (1), 1747903), and cell wall degrading enzymes such as glucanases, endochitinases and exochitinases where cloned into transgenic plant to confer them with resistance to fungal pathogens such as fusarium (WO2001016353).

The current applicant has developed several proteinaceous pesticides based on heavy chain variable domain of a heavy chain antibody (VHH). For instance VHH binding to a glucosylceramide of a fungal pest were developed showing antifungal activity (WO 2014/177595, WO 2014/191146 and WO 2016/071438) and more recently a VHH interaction with a lipid fraction of fungal pests have shown the ability of VHH to cause retardation of growth of a spore and even lysis of a spore of a fungal pests such as the economically important fungal plant pests Botrytis cinerea (WO 2021/198396). And although agrochemical compositions comprising anti-fungal agents are available that can act for instance on the cell membrane of fungal pathogens, the anti-fungal agent is not always able to (efficiently) reach its site of action due to the presence of the fungal cell wall. In addition, their remains the challenge, when employing protein based active ingredient (such as enzymes or antibodies or antibody fragments such as VHH) products in agriculture, of the relatively high cost of producing such proteins by fermentation and the high quantities that are often required to treat crops.

Accordingly, there remains a need in the art to provide anti-fungal compositions having improved properties, in particular with the ability to more effectively target the site of action of the anti-fungal agent, as well as reduced the dose rate required for efficient pest control, in a simple and easy to apply manner.

### SUMMARY OF THE INVENTION

The present inventors have identified compositions comprising at least one polypeptide and at least one cell wall disrupting agent, wherein the polypeptide is an antibody or antibody fragment that interacts with the cell membrane. The antibody or antibody fragment may be a heavy chain variable domain of an antibody or a functional fragment thereof.

In a first aspect of the invention there is provided a composition comprising at least one polypeptide and at least one cell wall disrupting agent. In some embodiments the at least one polypeptide is a heavy chain variable domain of a heavy chain antibody (VHH) or a functional fragment thereof.

In some embodiments, the at least one cell wall disrupting agent is a cell wall degrading enzyme, such as a glucanase and/or a chitinase. In some embodiments, the polypeptide comprises or consists of the amino acid sequence set out in any one of SEQ ID Nos 1, 2, 6, 10 or 14 to 99 or an amino acid sequence having at least about 80% sequence identity thereto. In some embodiments, the composition is an agrochemical composition which optionally further comprises one or more agrochemically suitable carriers and/or one or more suitable adjuvants.

In a second aspect of the invention there is provided the use of a composition of the invention as an anti-fungal agent.

In a third aspect of the invention, there is provided the use of a composition of the invention in a method of treating or preventing a plant or a part of said plant from an infection with a plant pathogenic fungus

In a fourth aspect of the invention there is provided a method for protecting or treating a plant or a part of said plant from an infection with a plant pathogenic fungus, at least comprising the step of applying to said plant or to a part of said plant, a composition of the invention, under conditions effective to protect or treat said plant or a part of said plant against said infection with said plant pathogenic fungus.

In a fifth aspect of the invention there is provided a post-harvest treatment method for protecting or treating a harvested plant or a harvested part of said plant from an infection with a plant pathogenic fungus, at least comprising the step of applying to said harvested plant or to a harvested part of said plant, a composition of the invention, under conditions effective to protect or treat said harvested plant or a harvested part of said plant against said infection with said plant pathogenic fungus.

In a sixth aspect of the invention, there is provided a method of inhibiting or killing the growth of a plant pathogenic fungus, comprising at least the step of applying to a plant or to a part of said plant, a composition of the invention.

### Description of the Sequence Listing

| Name | SEQ ID | VHH Amino acid sequence |
|---|---|---|
| VHH-1 | 1 | DVQLVESGGGLVQAGGSLRLSCAASRSIFSINAMDWYRQAPGKQREWVAGITRGGTT |
| | | KYADSVKGRFTISRDNAKKKVYLQMNSLKPEDTAVYYCNVLRGEQPWTRDYWGQGTQ |
| | | VTVSS |
| VHH-1Q | 2 | QVQLVESGGGLVQAGGSLRLSCAASRSIFSINAMDWYRQAPGKQREWVAGITRGGTT |
| | | KYADSVKGRFTISRDNAKKKVYLQMNSLKPEDTAVYYCNVLRGEQPWTRDYWGQGTQ |
| | | VTVSS |
| VHH-1 | 3 | RSIFSINAMD |
| CDR1 | | |
| VHH-1 | 4 | GITRGGTTK |
| CDR2 | | |
| VHH-1 | 5 | LRGEQPWTRDY |
| CDR3 | | |
| VHH-2 | 6 | QVQLQESGGGLVQAGGSLRLSCAASGTIFRPTAMGWYRQAPGKERELVATITTGGST |
| | | KYADSVKGRFTISRGNAKNTVYLQMSSLKPEDTAVYYCNAQWGVRTRDYWGQGTQV |
| | | TVSS |
| VHH-2 | 7 | GTIFRPTAMG |
| CDR1 | | |
| VHH-2 | 8 | TITTGGSTK |
| CDR2 | | |
| VHH-2 | 9 | QWGVRTRDY |
| CDR3 | | |
| VHH-3 | 10 | QVQLQESGGGLVQAGDSLRLSCAASISDRAFSRHVMGWFRQPPGKEREFVAAIGWTG |
| | | RRTYYADSVKGRFTISRDNAMNTVYLQMNSLKPEDTAVYYCAASHFYSVSFEINDYDY |
| | | WGQGTQVTVSS |
| VHH-3 | 11 | ISDRAFSRHV |
| CDR1 | | |
| VHH-3 | 12 | AIGWTGRRTY |
| CDR2 | | |
| VHH-3 | 13 | SHFYSVSFEINDYDY |
| CDR3 | | |
| VHH-2D | 14 | DVQLQESGGGLVQAGGSLRLSCAASGTIFRPTAMGWYRQAPGKERELVATITTGGSTK |
| | | YADSVKGRFTISRGNAKNTVYLQMSSLKPEDTAVYYCNAQWGVRTRDYWGQGTQVT |
| | | VSS |
| VHH-3D | 15 | DVQLQESGGGLVQAGDSLRLSCAASISDRAFSRHVMGWFRQPPGKEREFVAAIGWTG |
| | | RRTYYADSVKGRFTISRDNAMNTVYLQMNSLKPEDTAVYYCAASHFYSVSFEINDYDY |
| | | WGQGTQVTVSS |
| VHH-4 | 16 | QVQLQESGGGLVQAGGSLRLSCVASGTTFSSYTMGWYRQAPGKQRELLASIEGGGNTDYADSV |
| | | KGRFTISRDNARNTVYLQMNSLKTEDTAVYYCNAARTWSIFRNYWGQGTQVTVSS |
| VHH-5 | 17 | QVQLQESGGGLVQAGGSLRLSCAASGRTFSRYGMGWFRQLPGKQRELVTSITRGGTTTYADSV |
| | | KGRFTISRDNAKNTVYLQMNSLKPEDTAVYYCNARSIWRDYWGQGTQVTVSS |
| VHH-6 | 18 | QVQLQESGGGLVQAGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-7 | 19 | QVQLQESGGGLVQPGGSLTLSCAATKTGFSINAMGWYRQAPGKQREMVATITSGGTTNYADSV |
| | | KGRFAISRDNAKNTVSLQMNTLKPEDTALYYCNTEARRYFTRASQVYWGQGTQVTVSS |
| VHH-8 | 20 | QVQLQESGGGLVQPGGSLRLSCAASGGIFSINAMGWYRQDPGKQREMVATITSGANTNYTDSVK |
| | | GRFTISRDNAKNTVYLQMNSLKPEDTAVYYCNAVGRRWYGGYVELWGQGTQVTVSS |
| VHH-9 | 21 | QVQLQESGGGLVQPGGSLRLSCAASGSIFSTYVMGWYRQAIGKQRELVATITSSGKTNYAASVK |
| | | GRFTVSRDITKNTMYLQMNSLKPEDTAVYYCGADRWVLTRWSNYWGQGTQVTVSS |
| VHH-10 | 22 | QVQLQESGGGLVQPGGSLRLSCAASGSISSLGWYRQAPGKQREFVASATSGGDTTYADSVKGR |
| VHH-11 | 23 | FTISRDNSKNTVYLQMNSLKPEDTAVYYCKGQRGVAWTRKEYWGQGTQVTVSS |
| | | QVQLQESGGGLVQPGGSLRLSCAASGSIFSTYAMGWYRQAIGKQRELVATITSSGKTNYAASVK |
| | | GRFTISRDITKNTMYLQMNSLKPEDTAVYYCGADRWVLTRWSNYWGQGTQVTVSS |
| VHH-12 | 24 | QVQLQESGGGLVQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-13 | 25 | QVQLQESGGGLVQPGGSLRLSCAASGSIFSINAMGWYRQAPGKQRELVAAITSDGSTNYADSVK |
| | | GRFTISRDNAKNTAYLQMNSLKPEDTAVYYCNLRRRTFLKSSDYWGQGTQVTVSS |
| VHH-14 | 26 | QVQLQESGGGLVQAGDSLRLSCAASGRRFGSYAMGWFRQVPGKERELVAGISSGGSTKYADSV |
| | | RGRFTISRDNAKNTVSLQMKSLKPEDTAVYYCNAKYGRWTYTGRPEYDSWGQGTQVTVSS |
| VHH-15 | 27 | QVQLQESGGGLVQPGGSLRLSCAASGSIFSSDTMGWYRRAPGKQRELVAAITTGGNTNYADSVK |
| | | GRFTISRDNAKNTVYLQMNSLQPEDTAVYYCNCRRRWSRDFWGQGTQVTVSS |
| VHH-16 | 28 | QVQLQESGGGLVQPGGSLRLSCAASGTIFSIKTMGWYRQAPGKQRELVATISNGGSTNYADSVK |
| | | GRFTISRDNAKNTVYLQMNSLKPEDTAVYYCNARQQFIGAPYEYWGQGTQVTVSS |
| VHH-17 | 29 | QVQLQESGGGLVQAGGSLRLSCTASGAITFSLGTMGWYRQAPGKQRELVASISTGSTNYADSVK |
| | | GRFTISRDIIKNILYLQMNSLKPEDTAVYSCNARLLWSNYWGQGTQVTVSS |
| VHH-18 | 30 | QVQLQESGGGLVQAGESLRLSCAASGSTFSINVMGWYRQAPGEQRELVATISRGGSTNYADSVK |
| | | GRFTISRDNAKVTVYLQMDSLKPEDTAVYYCNAAGWVGVTNYWGQGTQVTVSS |
| VHH-19 | 31 | QVQLQESGGGLVQAGGSLRLSCAASGSTGSISAMGWYRQAPGKQRELVASITRRGSTNYADSV |
| | | KDRFTISRDNAWNTVYLQMNSLKPEDTAVYYCNARRYYTRNDYWGQGTQVTVSS |
| VHH-20 | 32 | QVQLQESGGGLGQAGGSLRLSCEVSGTTFSINTMGWHRQAPGKQRELVASISSGGWTNYADSV |
| | | KGRFTISRDNAKKTVYLQMNNLKPEDTAVYYCRWGAIGNWYGQGTQVTVSS |
| VHH-21 | 33 | QVQLQESGGGLVQPGGSLRLSCAASVRIFGLNAMGWYRQGPGKQRELVASITTGGSTNYAEPV |
| | | KGRFTISRDNANNTVYLQMNNLKPEDTAVYYCNAERRWGLPNYWGQGTQVTVSS |
| VHH-22 | 34 | QVQLQESGGGLVEAGGSLRLSCAASGRTFSRYGMGWFRQAPGKEREFVAANRWSGGSTYYAD |
| | | SVRGRFTISRDNAKNTVYLQMNSLKPEDTAVYYCAAYAHITAWGMRNDYEYDYWGQGTQVTVS |
| | | S |
| VHH-23 | 35 | QVQLQESGGGLVQAGGSLRLSCAATGRTFSRYTMGWFRQAPGKERDFVAGITWTGGSTDYADS |
| | | VKGRFTISRDNAKNTVYLQMNSLKPEDTAVYYCAAGNLLRLAGQLRRGYDSWGQGTQVTVSS |
| VHH-24 | 36 | QVQLQESGGGLVQAGGSLRLSCAASGRTGSRYAMGWFRQAPGKEREFVAAISWSGGSTYYAD |
| | | SVKDRFTISRDNAKNTVYLQMHSLKPEDTAVYYCATRNRAGPHYSRGYTAGQEYDYWGQGTQV |
| | | TVSS |
| VHH-25 | 37 | QVQLQESGGGLVQPGGSLRLSCAASGRIFSINAMGWYRQGPGKERELVVDMTSGGSINYADSV |
| | | SGRFTISRDNAKNTVYLQMNSLKPEDTAVYYCHANLRTAFWRNGNDYWGQGTQVTVSS |
| VHH-26 | 38 | QVQLQESGGGLVQPGGSLRLSCAASGSISSINAMGWYRQAPGKQRELVASITSGGSTNYADSVK |
| | | GRFTISRDNAKNTVNLQMNSLKPEDTAVYYCSAGPWYRRSWGRGTQVTVSS |
| VHH-27 | 39 | QVQLQESGGGLVQPGESLRLSCAASASIFWVNDMGWYRQAPGKQRELVAQITRRGSTNYADSV |
| | | KGRFTISRDNAKDEVYLQMNSLKPEDTAVYYCNADLAVRGRYWGQGTQVTVSS |
| VHH-28 | 40 | QVQLQESGGGLVQPGGSLRLSCAASGSFFPVNDMAWYRQALGNERELVANITRGGSTNYADSV |
| | | KGRFTISRDNAKNTVYLQMNTLKPEDTAVYYCNVRIGFGWTAKAYWGQGTQVTVSS |
| VHH-29 | 41 | QVQLQESGGGLVQPGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-30 | 42 | QVQLQESGGGLVQPGGSLRLSCAASGSTIRINAMGWYRQAPGKQRELVATITRGGITNYADSVK |
| | | GRFTISRDNAKFTVYLQMNSLKPEDTAVYYCNARSWVGPEYWGQGTQVTVSS |
| VHH-31 | 43 | QVQLQESGGGLVQPGGSLRLSCAASGMTYSIHAMGWYRQAPGKERELVAITSTSGTTDYTDSVK |
| | | GRFTISRDGANNTVYLQMNSLKSEDTAVYYCHVKTRTWYNGKYDYWGQGTQVTVSS |
| VHH-32 | 44 | QVQLQESGGGLVQPGGSLRLSCTASGSIFSINPMGWYRQAPGKQRELVAAITSGGSTNYADYVK |
| | | GRFTISRDNAKNVVYLQMNSLKPEDTAVYYCNGRSTLWRRDYWGQGTQVTVSS |
| VHH-33 | 45 | QVQLQESGGGLVQPGGSLRLSCAASGSIFSINTMGWYRQAPGKQRELVAAITNRGSTNYADFVK |
| | | GRFTISRDNAKNTVYLQMNSLKPDDTAVYYCNAHRSWPRYDSWGQGTQVTVSS |
| VHH-34 | 46 | QVQLQESGGGLVQPGGSLRLSCAASGSIFSFNAMGWYRQAPGKQRELVAAITRGGSTNYADSV |
| | | KGRFTISRDNANNTVYLQMNSLKPEDTAVYYCNAESRIFRRYDYWGPGTQVTVSS |
| VHH-35 | 47 | QVQLQESGGGLVQPGGSLRLSCVTSGSIFGLNLMGWYRQAPGKQRELVATITRGGSTNYADSVK |
| | | GRFTISRDNAKKTVYLQMNSLKPEDTAVYYCNVDRGWSSYWGQGTQVTVSS |
| VHH-36 | 48 | QVQLQESGGGLVQPGGSLRLSCVTSGSIRSINTMGWYRQAPGNERELVATITSGGTTNYADSVK |
| | | NRFTISRDNAKNTVYLQMNSLKPEDTAVYYCNLHQRAWARSYVYWGQGTQVTVSS |
| VHH-37 | 49 | QVQLQESGGGSVQPGGSLRLSCAASGSIFAVNAMGWYRQAPGHQRELVAIISSNSTSNYADSVK |
| | | GRFTISRDNAKNTVYLQMNSLKPEDTAVYFCYAKRSWFSQEYWGQGTQVTVSS |
| VHH-38 | 50 | QVQLQESGGGLVQPGGSLRLSCAASGSIFSFNLMGWYRQAPGKQRELVAAITSSSNTNYADSVK |
| | | GRFTISRDNAKNTVYLQMNSLKPEDTAVYYCNAQYTITPWGIKKDYWGQGTQVTVSS |
| VHH-39 | 51 | QVQLQESGGGLMQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-40 | 52 | QVQLQESGGGLVQPGESLRLSCVGSGSIFNINSMNWYRQASGKQRELVADMRSDGSTNYADSV |
| | | KGRFTISRDNARKTVYLQMNSLKPEDTAVYYCHANSIFRSRDYWGQGTQVTVSS |
| VHH-41 | 53 | QVQLQESGGGVVQAGDSLRLSCAASGRTFGGYTVAWFRQAPGKEREFVARISWSGIMAYYAES |
| | | VKGRFTISRDNAKNTVYLQMNSLKPEDTAVYYCASRSQIRSPWSSLDDYDRWGQGTQVTVSS |
| VHH-42 | 54 | QVQLQESGGGLVQPGGSLRLSCVVSGSISSMKAMGWHRQAPGKERELVAQITRGDSTNYADSV |
| | | KGRFTISRDNAKNTVYLQMNSLKPDDTGVYYCNADRFFGRDYWGKGTQVTVSS |
| VHH-43 | 55 | QVQLQESGGGLVQPGGSLRLSCAASRSILSISAMGWYRQGPGKQREPVATITSAGSSNYSDSVK |
| | | GRFTISRDNAKNTAYLQMNSLKPEDTAVYYCKTVYSRPLLGPLEVWGQGTQVTVSS |
| VHH-44 | 56 | QVQLQESGGGLVQTGGSLRLSCVASGSMFSSNAMAWYRQAPGKQRELVARILSGGSTNYADSV |
| | | KGRFTISRGNAKNTVYLQMNSLKPEDTAVYYCNAVRYLVNYWGQGTQVTVSS |
| VHH-45 | 57 | QVQLQESGGGSVQVGDSLTLSCVASGRSLDIYGMGWFRQAPGKEREFVARITSGGSTYYADSV |
| | | KGRFTLSRDNAKNTVYLQMNSLKPEDTAVYYCAAGVVVATSPKFYAYWGQGTQVTVSS |
| VHH-46 | 58 | QVQLQESGGGLVQAGGSLRLSCAASKRIFSTYTMGWFRQAPGKEREFVAAIIWSGGRTRYADSV |
| | | KGRFTISRDNARNTVHLQMNSLEPEDTAVYYCYTRRLGTGYWGQGTQVTVSS |
| VHH-47 | 59 | QVQLQESGGGLVQAGGSLRLSCAASGSTFSIQTIGWYRQAPGKQRDRVATISSGGSTNYADSVK |
| | | GRFTISRDNAKKTVYLQMNNLKPEDTAVYYCNLRYWFRDYWGQGTQVTVSS |
| VHH-48 | 60 | QVQLQESGGGLVQPGGSLRLSCAASGSTFSINVRGWYRQAPGKQRELVATITSDGSTNYADSVK |
| | | GRFTISRDNAKNTAYLQMNSLKPEDTAVYYCNAVRLFRQYWGQGTQVTVSS |
| VHH-49 | 61 | QVQLQESGGGLVQPGGSLRLSCAASGSIFRLNAMGWYRQAPGKQRELVAAITPGGGNTTYADS |
| | | VKGRFTISRDNALNTIYLQMNSLKPEDTAVYYCNAGGSSRWYSSRYYPGGYWGQGTQVTVSS |
| VHH-50 | 62 | QVQLQESGGGLVQAGGSLRLSCATSGGTFSRYAMGWFRQAPGKERELVATIRRSGSSTYYLDS |
| | | TKGRFTISRDNAKNTVYLQMNSLKLEDTAVYYCAADSSARALVGGPGNRWDYWGQGTQVTVSS |
| VHH-51 | 63 | QVQLQESGGGLVQPGGSLRLSCAASGSIGSINVMGWYRQYPGKQRELVAFITSGGITNYTDSVK |
| | | GRFAISRDNAQNTVYLQMNSLTPEDTAVYYCHLKNAKNVRPGYWGQGTQVTVSS |
| VHH-52 | 64 | QVQLQESGGGLVQPGGSLRLSCRASGGIFGINAMRWYRQAPGKQRELVASISSGGTTDYVESVK |
| | | GRFTISRDNATNTVDLQMSALKPEDTAVYYCNFVRFWFPDYWGQGTQVTVSS |
| VHH-53 | 65 | QVQLQESGGGLVQAGGSLRLSCAASGITFMSNTMGWYRQAPGKQRELVASISSGGSTNYADSV |
| | | KGRFTISRDNAKKTVYLQMNSLKPEDTAVYYCNARRNVFISSWGQGTQVTVSS |
| VHH-54 | 66 | QVQLQESGGGLVQPGGSLRLSCVASGSISVYGMGWYRQAPGKQRELVARITNIGTTNYADSVKG |
| | | RFTISRDNAKNTVYLQMNSLQPEDTAVYYCNLRRLGRDYWGQGTQVTVSS |
| VHH-55 | 67 | QVQLQESGGGLVQPGGSLRLSCAASRTALRLNSMGWYRQAPGSQRELVATITRGGTTNYADSV |
| | | KGRFTISREIGNNTVYLQMNSLEPEDTAVYYCNANFGILVGREYWGKGTQVTVSS |
| VHH-56 | 68 | QVQLQESGGGLVQAGGSLRLSCAVSGSIFSILSMAWYRQTPGKQRELVANITSVGSTNYADSVK |
| | | GRFTISRDIAKKTLYLQMNNLKPEDTAIYYCNTRMPFLGDSWGQGTQVTVSS |
| VHH-57 | 69 | QVQLQESGGGLVQAGGSLRLSCAVSAFSFSNRAVSWYRQAPGKSREWVASISGIRITTYTNSVK |
| | | GRFIISRDNAKKTVYLQMNDLRPEDTGVYRCYMNRYSGQGTQVTVSS |
| VHH-58 | 70 | QVQLQESGGGSVQPGGSLRLSCAASGTVFFSISAMGWYRQAPGKQRELVAGISRGGSTKYGDF |
| | | VKGRFTISRDNGKKTIWLQMNNLQPEDTAIYYCRLTSITGTYLWGQGTQVTVSS |
| VHH-59 | 71 | QVQLQESGGGLVQPGGSLRLSCAASGSIFSMKVMGWYRQGPGKLRELVAVITSGGRTNYAESV |
| | | KGRFTISRDNAKNTVSLQMNSLQPEDTAVYYCYYKTIRPYWGQGTQVTVSS |
| VHH-60 | 72 | QVQLQESGGGLVQAGGSLRLSCAASGITFRITTMGWYRQAPGKQRELVASSSSGGTTNYASSVK |
| | | GRFTISRDNAKNTVYLQMNSLRPEDTAVYYCNARKFITTPWSTDYWGQGTQVTVSS |
| VHH-61 | 73 | QVQLQESGGGLVQPGDSLRLSCTPSGSIFNHKATGWYRQAPGSQRELVAKITTGGTTNYADSVK |
| | | GRFTISRDNAKNTVYLQMSSLKPEDTAVYYCNAERYFATTLWGQGTQVTVSS |
| VHH-62 | 74 | QVQLQESGGGLVQAGGSLRLSCAASGITFSNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-63 | 75 | QVQLQESGGGLVQAGGSLRLSCAASGNIFRINDMGWYRQAPGNQRELVATITSANITNYADSVK |
| | | GRFTISRDNAKNTVYLQMNSLNPEDTAVYYCTAQAKKWRIGPWSDYWGQGTQVTVSS |
| VHH-64 | 76 | QVQLQESGGGLVQPGGSLRLSCAASGRIFSINDMAWYRQAPGKQRELVAIITNDDSTTYADSVKG |
| | | RFTISRDNAKNTVYLQMNSLKPEDTAVYYCNADINTAIWRRKYWGQGTQVTVSS |
| VHH-65 | 77 | QVQLQESGGGLVQSGGSLRLSCVHSKTTFTRNAMGWYRQALGKERELVATITSGGTTNYADSVK |
| | | GRFTISMDSAKNTVYLQMNSLKPEDTAVYYCNVNTRRIFGGTVREYWGQGTQVTVSS |
| VHH-66 | 78 | QVQLQESGGGLVQPGGSLRLSCAVSGSRIFIHDMGWHRQAPGEPRELVATITPFGRRNYSEYVK |
| | | GRFTVSRDIARNTMSLQMSNLKAEDTGMYYCNVRVNGVDYWGQGTQVTVSS |
| VHH-67 | 79 | QVQLQESGGGLVQAGGSLRLSCAISGITFRRPFGISRMGWYRQAPGKERELVATLSRAGTSRYV |
| | | DSVKGRFTISRDDAKNTLYLQMVSLNPEDTAVYYCYIAQLGTDYWGQGTQVTVSS |
| VHH-68 | 80 | QVQLQESGGGLVQAGGSLRLSCVASGITLRMYQVGWYRQAPGKQRELVAEISSRGTTMYADSV |
| | | KGRFTISRDGAKNIVYLQMNSLEPEDTAVYYCNARAFAFGRNSWGQGTQVTVSS |
| VHH-69 | 81 | QVQLQESGGGSVQAGGSLRLSCAVSGGTFSNKAMGWYRQSSGKQRALVARISTVGTAHYADSV |
| | | KGRFTVSKDNAGNTLYLQMNSLKPEDTAVYYCNAQAGRLYLRNYWGQGTQVTVSS |
| VHH-70 | 82 | QVQLQESGGGLVQPGESLRLSCVAAASTSITTFNTMAWYRQAPGKQRELVAQINNRDNTEYADS |
| | | VKGRFIISRGNAKNTSNLQMNDLKSEDTGIYYCNAKRWSWSTGFWGQGTQVTVSS |
| VHH-71 | 83 | QVQLQESGGGLVQAGGSLRLSCTASGLTFALGTMGWYRQAPGKQRELVASISTGSTNYADSVK |
| | | GRFTISRDIIKNILYLQMNSLKPEDTAVYSCNARLWWSNYWGQGTQVTVSS |
| VHH-72 | 84 | QVQLQESGGGLVQAGGSLRLSCTASGRTSSVNPMGWYRQAPGKQRELVAVISSDGSTNYADSV |
| | | KGRFTVSRDNAKNTLYLQMNSLKPEDTAVYYCNANRRWSWGSEYWGQGTQVTVSS |
| VHH-73 | 85 | QVQLQESGGGLVQAGGSLRLSCAASGITFTNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-74 | 86 | QVQLQESGGGLVQAGGSLRLSCEAPVSTFNINAMAWYRQAPGKSRELVARISSGGSTNYADSVK |
| | | GRFTISRDNAKNTVYLQMNSLKPEDTAVYICYVNRHWGWDYWGQGTQVTVSS |
| VHH-75 | 87 | QVQLQESGGGLVQPGGTLRLSCVASGSFRSINAMGWYRQAPGKQRELVATVDSGGYTNYADSV |
| | | KGRFTISRDNAKNTVYLQMSSLTPEDTAVYYCYAGIYKWPWSVDARDYWGQGTQVTVSS |
| VHH-76 | 88 | QVQLQESGGGLVQAGGSLRLSCAASGSSISMNSMGWYRQAPGKERERVALIRSSGGTYYADSV |
| | | KGRFTISRDNAKNTVYLQMNNLKPEDTAVYYCQARRTWLSSESWGQGTQVTVSS |
| VHH-77 | 89 | QVQLQESGGGLVQAGGSLRLSCAVSGSTFGINTMGWYRQAPEKQRELVASISRGGMTNYADSV |
| | | KGRFIISRDNAKNTVYLQMNSLKPEDTAVYVCNAGIRSRWYGGPITTYWGQGTQVTVSS |
| VHH-78 | 90 | QVQLQESGGGLVQAGGSLRLSCAASGSTGSINAMGWYRQGPGKQRDLVASISSGGATNYADSV |
| | | KGRFTISRDNSKNTVYLQMSSLKPEDTAVYYCNAKKSRWSWSIVHDYWGQGTQVTVSS |
| VHH-79 | 91 | QVQLQESGGGSVQTGGSLTLSCTTSGSIFGRSDMGWYRQAPGKQRELVATITRRSRTNYAEFVK |
| | | GRFTISRDSAKNLVTLQMNSLKPEDTNVYYCNARWGAGGIFSTWGQGTQVTVSS |
| VHH-80 | 92 | QVQLQESGGGLVQPGESLRLSCAASGSMSIDAMGWYRQAPGDQRELVASITTGGSTNYADSVK |
| | | GRFTISRDNAKNTVWLQMNSLKPEDTAVYYCNAKVRLRWFRPPSDYWGQGTQVTVSS |
| VHH-81 | 93 | QVQLQESGGGLVQPGGSLRLSCAASGRLLSISTMGWYRRTPEDQREMVASITKDGTTNYADSVK |
| | | GRLTISRDNAKNTVYLQMNSLKPDDTAVYVCNARATTWVPYRRDAEFWGQGTQVTVSS |
| VHH-82 | 94 | QVQLQESGGGLVQAGGSLRLSCAASGSIFGINDMGWYRQAPGKQRDLVADITRSGSTHYVDSVK |
| | | GRFTISRDNAKNTVYLQMNSLKPEDTAVYYCNADSGSHWWNRRDYWGQGTQVTVSS |
| VHH-83 | 95 | QVQLQESGGGLVQPGGSLKLSCAASGFTFSINTMGWYRQAPGKQRELVARISRLRVTNYADSVK |
| | | GRFTISRDNAKNTVYLQMNSLKPEDTAVYYCNAANWGLAGNEYWGQGTQVTVSS |
| VHH-84 | 96 | QVQLQESGGGLVQAGGSLRPSCTASGSTLLINSMGWYRQAPGKQRELVATISNSGTTNYVDAVK |
| | | GRFAISRDNANHTVYLQMNSLEPEDTAVYYCNAQTFWRRNYWGQGTQVTVSS |
| VHH-85 | 97 | QVQLQESGGGLVQAGGSLRLSCAVSGSTSRINAMGWYRQAPGKKRESVATIRRGGNTKYADSV |
| | | KGRFTISRDNANNTVYLQLNSLKPEDTAVYYCNAHSWLDYDYWGRGTQVTVSS |
| VHH-86 | 98 | QVQLQESGGGLVQAGGSLRLSCASRRRINGITMGWYRQAPGKQRELVATIDIHNSTKYADSVKG |
| | | RFIISRDNGKSMLYLQMNSLKPEDTAVYYCNRIPTFGRYWGQGTQVTVSS |
| VHH-87 | 99 | QVQLQESGGGLVQAGGSLRLSCVASGSTFYTFSTKNVGWYRQAPGKQRELVAQQRYDGSTNY |
| | | ADSLQGRFTISRDNAKRTVYLQMNSLKPEDTAVYICNVNRGFISYWGQGTQVTVSS |

### DESCRIPTION OF THE FIGURES

FIG. 1: Dose response curves against Botrytis cinerea in % confluency for VHH-1 and Cell wall degrading enzymes (CWDEs) separately (top panels in A and B respectively) as well as the dose response curves for the mixture of VHH-1 and CWDEs with their respective concentrations in the mixture (bottom panels in A and B respectively).

FIG. 2: Dose regimes (as indicated on top of each panel) of the data shown in FIG. 1, where each filled point shows the measured % confluence of a replicate well; open circles show the mean of each treatment group; vertical lines connect show the range for each group.

FIG. 3: Dose response curves against Botrytis cinerea in % confluency for VHH-W and CWDEs separately (top panels in A and B respectively) as well as the dose response curves for the mixture of VHH-W and CWDEs with their respective concentrations in the mixture (bottom panels in A and B respectively).

FIG. 4: Sets out the separate dose regimes (as indicated on top of each panel) of the data shown in FIG. 3, where each filled point shows the measured % confluence of a replicate well; open circles show the mean of each treatment group; vertical lines connect show the range for each group.

FIG. 5: Dose response curves against Botrytis cinerea in % confluency for VHH-X and CWDEs separately (top panels in A and B respectively) as well as the dose response curves for the mixture of VHH-X and CWDEs with their respective concentrations in the mixture (bottom panels in A and B respectively).

FIG. 6: Dose regimes (as indicated on top of each panel) of the data shown in FIG. 5, where each filled point shows the measured % confluence of a replicate well; open circles show the mean of each treatment group; vertical lines connect show the range for each group.

FIG. 7: Dose response curves against Botrytis cinerea in % confluency for VHH-Y and CWDEs separately (top panels in A and B respectively) as well as the dose response curves for the mixture of VHH-Y and CWDEs with their respective concentrations in the mixture (bottom panels in A and B respectively).

FIG. 8: Dose regimes (as indicated on top of each panel) of the data shown in FIG. 7, where each filled point shows the measured % confluence of a replicate well; open circles show the mean of each treatment group; vertical lines connect show the range for each group.

FIG. 9: Dose response curves against Botrytis cinerea in % confluency for VHH-Z and CWDEs separately (top panels in A and B respectively) as well as the dose response curves for the mixture of VHH-Z and CWDEs with their respective concentrations in the mixture (bottom panels in A and B respectively).

FIG. 10: Dose regimes (as indicated on top of each panel) of the data shown in FIG. 9, where each filled point shows the measured % confluence of a replicate well; open circles show the mean of each treatment group; vertical lines connect show the range for each group.

FIG. 11: Protoplast formation by a CWDE, before incubation (FIG. 11A), during incubation with a CWDE (FIG. 11B) and after purification (FIG. 11C).

### DETAILED DESCRIPTION OF THE INVENTION

Reference to any prior art in this specification is not, and should not be taken as, an acknowledgment or any form of suggestion that this prior art forms part of the common general knowledge in any country.

All documents cited in the present specification are hereby incorporated by reference in their entirety. Unless otherwise defined, all terms used in disclosing the invention, including technical and scientific terms, have the meaning as commonly understood by one of ordinary skill in the art to which this invention belongs.

The present invention will be described with respect to particular embodiments but the invention is not limited thereto but only by the claims. Any reference signs in the claims shall not be construed as limiting the scope.

### Definitions

Where the term “comprising” is used in the present description and claims, it does not exclude other elements or steps.

Where an indefinite or definite article is used when referring to a singular noun e.g. “a” or “an”, “the”, this includes a plural of that noun unless something else is specifically stated.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier ‘about’ refers is itself also specifically, and preferably, disclosed.

The following terms or definitions are provided solely to aid in the understanding of the invention. Unless specifically defined herein, all terms used herein have the same meaning as they would to one skilled in the art of the present invention. Practitioners are particularly directed to Sambrook et al., Molecular Cloning: A Laboratory Manual, 2^{nd} ed., Cold Spring Harbor Press, Plainsview, New York (1989); and Ausubel et al., Current Protocols in Molecular Biology (Supplement 47), John Wiley & Sons, New York (1999), for definitions and terms of the art. The definitions provided herein should not be construed to have a scope less than understood by a person of ordinary skill in the art.

Unless indicated otherwise, all methods, steps, techniques and manipulations that are not specifically described in detail can be performed and have been performed in a manner known per se, as will be clear to the skilled person. Reference is for example again made to the standard handbooks, to the general background art referred to above and to the further references cited therein.

As used herein, the terms “polypeptide”, “protein”, “peptide”, and “amino acid sequence” are used interchangeably, and refer to a polymeric form of amino acids of any length, which can include coded and non-coded amino acids, chemically or biochemically modified or derivatized amino acids, and polypeptides having modified peptide backbones.

As used herein, amino acid residues will be indicated either by their full name or according to the standard three-letter or one-letter amino acid code.

As used herein, the terms “nucleic acid molecule”, “polynucleotide”, “polynucleic acid”, “nucleic acid” are used interchangeably and refer to a polymeric form of nucleotides of any length, either deoxyribonucleotides or ribonucleotides, or analogues thereof. Polynucleotides may have any three-dimensional structure, and may perform any function, known or unknown. Non-limiting examples of polynucleotides include a gene, a gene fragment, exons, introns, messenger RNA (mRNA), transfer RNA, ribosomal RNA, ribozymes, cDNA, recombinant polynucleotides, branched polynucleotides, plasmids, vectors, isolated DNA of any sequence, control regions, isolated RNA of any sequence, nucleic acid probes, and primers. The nucleic acid molecule may be linear or circular.

As used herein, the term “homology” denotes at least secondary structural similarity between two macromolecules, particularly between two polypeptides or polynucleotides, from same or different taxons, wherein said similarity is due to shared ancestry. Hence, the term “homologues” denotes so-related macromolecules having said secondary and optionally tertiary structural similarity. For comparing two or more nucleotide sequences, the ‘(percentage of) sequence identity’ between a first nucleotide sequence and a second nucleotide sequence may be calculated using methods known by the person skilled in the art, e.g. by dividing the number of nucleotides in the first nucleotide sequence that are identical to the nucleotides at the corresponding positions in the second nucleotide sequence by the total number of nucleotides in the first nucleotide sequence and multiplying by 100% or by using a known computer algorithm for sequence alignment such as NCBI Blast. In determining the degree of sequence identity between two amino acid sequences, the skilled person may take into account so-called ‘conservative’ amino acid substitutions, which can generally be described as amino acid substitutions in which an amino acid residue is replaced with another amino acid residue of similar chemical structure and which has little or essentially no influence on the function, activity or other biological properties of the polypeptide. Possible conservative amino acid substitutions will be clear to the person skilled in the art. Amino acid sequences and nucleic acid sequences are said to be “exactly the same” if they have 100% sequence identity over their entire length.

As used herein, the terms “complementarity determining region” or “CDR” within the context of antibodies refer to variable regions of either the H (heavy) or the L (light) chains (also abbreviated as VH and VL, respectively) and contain the amino acid sequences capable of specifically binding to antigenic targets. These CDR regions account for the basic specificity of the antibody for a particular antigenic determinant structure. Such regions are also referred to as “hypervariable regions.” The CDRs represent non-contiguous stretches of amino acids within the variable regions but, regardless of species, the positional locations of these critical amino acid sequences within the variable heavy and light chain regions have been found to have similar locations within the amino acid sequences of the variable chains. The variable heavy and light chains of all canonical antibodies each have 3 CDR regions, each non-contiguous with the others (termed L1, L2, L3, H1, H2, H3) for the respective light (L) and heavy (H) chains.

The term “affinity”, as used herein, refers to the degree to which a polypeptide, in particular an immunoglobulin, such as an antibody, or an immunoglobulin fragment, such as a VHH, binds to an antigen so as to shift the equilibrium of antigen and polypeptide toward the presence of a complex formed by their binding. Thus, for example, where an antigen and antibody (fragment) are combined in relatively equal concentration, an antibody (fragment) of high affinity will bind to the available antigen so as to shift the equilibrium toward high concentration of the resulting complex. The dissociation constant is commonly used to describe the affinity between the protein binding domain and the antigenic target. Typically, the dissociation constant is lower than 10⁻⁵ M. Preferably, the dissociation constant is lower than 10⁻⁶ M, more preferably, lower than 10⁻⁷ M. Most preferably, the dissociation constant is lower than 10⁻⁸ M.

The terms “specifically bind” and “specific binding”, as used herein, generally refers to the ability of a polypeptide, in particular an immunoglobulin, such as an antibody, or an immunoglobulin fragment, such as a VHH, to preferentially bind to a particular antigen that is present in a homogeneous mixture of different antigens. In certain embodiments, a specific binding interaction will discriminate between desirable and undesirable antigens in a sample, in some embodiments more than about 10 to 100-fold or more (e.g., more than about 1000- or 10,000-fold).

Accordingly, an amino acid sequence as disclosed herein is said to “specifically bind to” a particular target when that amino acid sequence has affinity for, specificity for and/or is specifically directed against that target (or for at least one part or fragment thereof).

The “specificity” of an amino acid sequence as disclosed herein can be determined based on affinity and/or avidity.

An “IC50 value”, “EC50”, “IC50”, “EC50” or “half maximal inhibitory concentration” as used herein interchangeably is a measure for the potency of a polypeptide or cell wall disrupting agent or compositions as described herein in inhibiting the growth of a fungal pathogen. In practice (also see example 1) the growth of a fungal pathogen is tracked by measuring the confluency of said fungal pathogen in for example a well of a 96-well plate or 384-well plate in the presence of a series of different concentrations of the tested polypeptide or cell wall disrupting agent or compositions as described herein. The confluency data at the time-point at which the non-treated or negative control reaches for example 90% saturation is then taken for each concentration of the polypeptide or cell wall disrupting agent or compositions as described herein. Said confluence values are then plotted against the log transformed concentration values yielding a sigmoidal curve. This sigmoid curve may serve to define an IC50 value. Where this IC50 is the concentration of the polypeptide or cell wall disrupting agent or compositions as described herein where the corresponding confluence value is 50% of the saturated value as estimated by the maximum of the sigmoidal function.

An amino acid sequence as disclosed herein is said to be “specific for a first target antigen of interest as opposed to a second target antigen of interest” when it binds to the first target antigen of interest with an affinity that is at least 5 times, such as at least 10 times, such as at least 100 times, and preferably at least 1000 times higher than the affinity with which that amino acid sequence as disclosed herein binds to the second target antigen of interest. Accordingly, in certain embodiments, when an amino acid sequence as disclosed herein is said to be “specific for” a first target antigen of interest as opposed to a second target antigen of interest, it may specifically bind to (as defined herein) the first target antigen of interest, but not to the second target antigen of interest.

As used herein, the terms “inhibiting”, “reducing” and/or “preventing” may refer to (the use of) an amino acid sequence as disclosed herein that specifically binds to a target antigen of interest and inhibits, reduces and/or prevents the interaction between that target antigen of interest, and its natural binding partner. The terms “inhibiting”, “reducing” and/or “preventing” may also refer to (the use of) an amino acid sequence as disclosed herein that specifically binds to a target antigen of interest and inhibits, reduces and/or prevents a biological activity of that target antigen of interest, as measured using a suitable in vitro, cellular or in vivo assay. Accordingly, “inhibiting”, “reducing” and/or “preventing” may also refer to (the use of) an amino acid sequence as disclosed herein that specifically binds to a target antigen of interest and inhibits, reduces and/or prevents one or more biological or physiological mechanisms, effects, responses, functions pathways or activities in which the target antigen of interest is involved. Such an action of the amino acid sequence as disclosed herein as an antagonist may be determined in any suitable manner and/or using any suitable (in vitro and usually cellular or in vivo) assay known in the art, depending on the target antigen of interest.

Thus, more particularly, “inhibiting”, “reducing” and/or “preventing” using amino acid sequence as disclosed herein may mean either inhibiting, reducing and/or preventing the interaction between a target antigen of interest and its natural binding partner, or, inhibiting, reducing and/or preventing the activity of a target antigen of interest, or, inhibiting, reducing and/or preventing one or more biological or physiological mechanisms, effects, responses, functions, pathways or activities in which the target antigen of interest is involved, such as by at least 10%, but preferably at least 20%, for example by at least 50%, at least 60%, at least 70%, at least 80%, at least 90%, at least 95% or more, as measured using a suitable in vitro, cellular or in vivo assay, compared to the activity of the target antigen of interest in the same assay under the same conditions but without using the amino acid sequence as disclosed herein. In addition, “inhibiting”, “reducing” and/or “preventing” may also mean inducing a decrease in affinity, avidity, specificity and/or selectivity of a target antigen of interest for one or more of its natural binding partners and/or inducing a decrease in the sensitivity of the target antigen of interest for one or more conditions in the medium or surroundings in which the target antigen of interest is present (such as pH, ion strength, the presence of co-factors, etc.), compared to the same conditions but without the presence of the amino acid sequence as disclosed herein. In the context of the present invention, “inhibiting”, “reducing” and/or “preventing” may also involve allosteric inhibition, reduction and/or prevention of the activity of a target antigen of interest.

The inhibiting or antagonizing activity or the enhancing or agonizing activity of an amino acid sequence as disclosed herein may be reversible or irreversible, but for agrochemical, pharmaceutical and pharmacological applications will typically occur reversibly.

An amino acid sequence as disclosed herein is considered to be “(in) essentially isolated (form)” as used herein, when it has been extracted or purified from the host cell and/or medium in which it is produced.

In respect of the amino acid sequences as disclosed herein, the terms “binding region”, “binding site” or “interaction site” present on the amino acid sequences as disclosed herein shall herein have the meaning of a particular site, region, locus, part, or domain present on the target molecule, which particular site, region, locus, part, or domain is responsible for binding to that target molecule. Such binding region thus essentially consists of that particular site, region, locus, part, or domain of the target molecule, which is in contact with the amino acid sequence when bound to that target molecule.

“Plant” as used herein, means an entire plant or a part thereof, including fresh fruit, vegetables and seeds. The plant or plant part may be a live plant or part thereof. Also, the term “plant” as used herein encompasses whole plants, ancestors and progeny of the plants and plant parts, including seeds, shoots, stems, leaves, roots (including tubers), flowers, and tissues and organs, wherein each of the aforementioned comprise the gene/nucleic acid of interest. The term “plant” also encompasses plant cells, suspension cultures, callus tissue, embryos, meristematic regions, gametophytes, sporophytes, pollen and microspores, again wherein each of the aforementioned comprises the gene/nucleic acid of interest.

The choice of suitable control plants is a routine part of an experimental setup and may include corresponding wild type plants or corresponding plants without the gene of interest. The control plant is typically of the same plant species or even of the same variety as the plant to be assessed. The control plant may also be a nullizygote of the plant to be assessed. Nullizygotes are individuals missing the transgene by segregation. A “control plant” as used herein refers not only to whole plants, but also to plant parts, including seeds and seed parts.

“Crop” as used herein means a plant species or variety that is grown to be harvested as food, livestock fodder, fuel raw material, or for any other economic purpose. As a non-limiting example, said crops can be maize, cereals, such as wheat, rye, barley and oats, sorghum, rice, sugar beet and fodder beet, fruit, such as pome fruit (e.g. apples and pears), citrus fruit (e.g. oranges, lemons, limes, grapefruit, or mandarins), stone fruit (e g. peaches, nectarines or plums), nuts (e.g. almonds or walnuts), soft fruit (e.g. cherries, strawberries, blackberries or raspberries), the plantain family or grapevines, leguminous crops, such as beans, lentils, peas and soya, oil crops, such as sunflower, safflower, rapeseed, canola, castor or olives, cucurbits, such as cucumbers, melons or pumpkins, fibre plants, such as cotton, flax or hemp, fuel crops, such as sugarcane, miscanthus or switchgrass, vegetables, such as potatoes, tomatoes, peppers, lettuce, spinach, onions, carrots, egg-plants, asparagus or cabbage, ornamentals, such as flowers (e.g. petunias, pelargoniums, roses, tulips, lilies, or chrysanthemums), shrubs, broad-leaved trees (e.g. poplars or willows) and evergreens (e.g. conifers), grasses, such as lawn, turf or forage grass or other useful plants, such as coffee, tea, tobacco, hops, pepper, rubber or latex plants.

A “pest”, as used here, is an organism that is harmful to plants, animals, humans or human concerns, and includes, but is not limited to crop pests (as later defined), household pests, such as cockroaches, ants, etc., and disease vectors, such as malaria mosquitoes.

A “plant pest”, “plant pathogen” or “crop pest”, as used in the application interchangeably, refers to organisms that specifically cause damage to plants, plant parts or plant products, particularly plants, plant parts or plant products, used in agriculture. Note that the term “plant pest” or “crop pest” is used in the meaning that the pest targets and harms plants. Pests particularly belong to invertebrate animals (e.g. insects (including agricultural pest insects, insect pests of ornamental plants, insect pests of forests). Relevant crop pest examples include, but are not limited to, aphids, caterpillars, flies, wasps, and the like, nematodes (living freely in soil or particularly species that parasitize plant roots, such as root-knot nematode and cyst nematodes such as soybean cyst nematode and potato cyst nematode), mites (such as spider mites, thread-footed mites and gall mites) and gastropods (including slugs such as Deroceras spp., Milax spp., Tandonia sp., Limax spp., Arion spp. and Veronicella spp. and snails such as Helix spp., Cernuella spp., Theba spp., Cochlicella spp., Achatina spp., Succinea spp., Ovachlamys spp., Amphibulima spp., Zachrysia spp., Bradybaena spp., and Pomacea spp.), pathogenic fungi (including Ascomycetes (such as Fusarium spp., Thielaviopsis spp., Verticillium spp., Magnaporthe spp.), Basidiomycetes (such as Rhizoctonia spp., Phakospora spp., Puccinia spp.), and fungal-like Oomycetes (such as Pythium spp. and Phytophthora spp.), bacteria (such as Burkholderia spp. and Proteobacteria such as Xanthomonas spp. and Pseudomonas spp.), Phytoplasma, Spiroplasma, viruses (such as tobacco mosaic virus and cauliflower mosaic virus), and protozoa.

“Microbe”, as used herein, means bacterium, virus, fungus, yeast and the like and “microbial” means derived from a microbe.

“Fungus”, as used herein, means a eukaryotic organism, belonging to the group of Eumycota. The term fungus in the present invention also includes fungal-like organisms such as the Oomycota. Oomycota (or oomycetes) form a distinct phylogenetic lineage of fungus-like eukaryotic microorganisms. This group was originally classified among the fungi but modern insights support a relatively close relationship with the photosynthetic organisms such as brown algae and diatoms, within the group of heterokonts.

“Pest infection” or “pest disease” as used herein refers to any inflammatory condition, disease or disorder in a living organism, such as a plant, animal or human, which is caused by a pest.

“Fungal infection” or “fungal disease” as used herein refers to any inflammatory condition, disease or disorder in a living organism, such as a plant, animal or human, which is caused by a fungus.

“Active substance”, “active ingredient” or “active principle”, as used interchangeably herein, means any biological, biochemical or chemical element and its derivatives, fragments or compounds based thereon, including micro-organisms, having general or specific action against harmful organisms on a subject, and in particular on plants, parts of plants or on plant products, as they occur naturally or by manufacture, including any impurity inevitably resulting from the manufacturing process.

“Agrochemical”, as used herein, means suitable for use in the agrochemical industry (including agriculture, horticulture, floriculture and home and garden uses, but also products intended for non-crop related uses such as public health/pest control operator uses to control undesirable insects and rodents, household uses, such as household fungicides and insecticides and agents, for protecting plants or parts of plants, crops, bulbs, tubers, fruits (e.g. from harmful organisms, diseases or pests); for controlling, preferably promoting or increasing, the growth of plants; and/or for promoting the yield of plants, crops or the parts of plants that are harvested (e.g. its fruits, flowers, seeds etc.). Examples of such substances will be clear to the skilled person and may for example include compounds that are active as insecticides (e.g. contact insecticides or systemic insecticides, including insecticides for household use), herbicides (e.g. contact herbicides or systemic herbicides, including herbicides for household use), fungicides (e.g. contact fungicides or systemic fungicides, including fungicides for household use), nematicides (e.g. contact nematicides or systemic nematicides, including nematicides for household use) and other pesticides or biocides (for example agents for killing insects or snails); as well as fertilizers; growth regulators such as plant hormones; micro-nutrients, safeners, pheromones; repellants; insect baits; and/or active principles that are used to modulate (i.e. increase, decrease, inhibit, enhance and/or trigger) gene expression (and/or other biological or biochemical processes) in or by the targeted plant (e.g. the plant to be protected or the plant to be controlled), such as nucleic acids (e.g., single stranded or double stranded RNA, as for example used in the context of RNAi technology) and other factors, proteins, chemicals, etc. known per se for this purpose, etc. Examples of such agrochemicals will be clear to the skilled person; and for example include, without limitation: glyphosate, paraquat, metolachlor, acetochlor, mesotrione, 2,4-D, atrazine, glufosinate, sulfosate, fenoxaprop, pendimethalin, picloram, trifluralin, bromoxynil, clodinafop, fluroxypyr, nicosulfuron, bensulfuron, imazetapyr, dicamba, imidacloprid, thiamethoxam, fipronil, chlorpyrifos, deltamethrin, lambda-cyhalotrin, endosulfan, methamidophos, carbofuran, clothianidin, cypermethrin, abamectin, diflufenican, spinosad, indoxacarb, bifenthrin, tefluthrin, azoxystrobin, thiamethoxam, tebuconazole, mancozeb, cyazofamid, fluazinam, pyraclostrobin, epoxiconazole, chlorothalonil, copper fungicides, trifloxystrobin, prothioconazole, difenoconazole, carbendazim, propiconazole, thiophanate, sulphur, boscalid and other known agrochemicals or any suitable combination(s) thereof.

An “agrochemical composition” as used herein means a composition for agrochemical use, as further defined, comprising at least one active substance, optionally with one or more additives favouring optimal dispersion, atomization, deposition, leaf wetting, distribution, retention and/or uptake of agrochemicals. It will become clear from the further description herein that an agrochemical composition as used herein includes biological control agents or biological pesticides (including but not limited to biological biocidal, biostatic, fungistatic and fungicidal agents) and these terms will be interchangeably used in the present application. Accordingly, an agrochemical composition as used herein includes compositions comprising at least one biological molecule as an active ingredient, substance or principle for controlling pests in plants or in other agro-related settings (such for example in soil). Non-limiting examples of biological molecules being used as active principles in the agrochemical compositions disclosed herein are proteins (including antibodies and fragments thereof, such as but not limited to heavy chain variable domain fragments of antibodies, including VHH's), nucleic acid sequences, (poly-) saccharides, lipids, vitamins, hormones glycolipids, sterols, and glycerolipids.

As a non-limiting example, the additives in the agrochemical compositions disclosed herein may include but are not limited to diluents, solvents, adjuvants, surfactants, wetting agents, spreading agents, oils, stickers, thickeners, penetrants, buffering agents, acidifiers, anti-settling agents, anti-freeze agents, photo-protectors, defoaming agents, biocides and/or drift control agents.

A “biostatic composition” or a “biostatic agent” as used herein means any active ingredient, substance or principle or a composition comprising any active ingredient, substance or principle for biostatic use (as further defined herein) comprising at least one active biostatic substance or ingredient, optionally combined with one or more additives favouring optimal dispersion, atomization, deposition, leaf wetting, distribution, retention and/or uptake of the active substance or ingredient. As a non-limiting examples such additives are diluents, solvents, adjuvants, (ionic) surfactants, wetting agents, spreading agents, oils, stickers, thickeners, penetrants, buffering agents, acidifiers, anti-settling agents, anti-freeze agents, photo-protectors, defoaming agents, biocides, protease inhibitors and/or drift control agents.

A “biocidal composition” or a “biocidal agent” as used herein means any active ingredient, substance or principle or a composition comprising any active ingredient, substance or principle for biocidal use (as further defined herein) comprising at least one active biocidal substance or ingredient, optionally combined with one or more additives favouring optimal dispersion, atomization, deposition, leaf wetting, distribution, retention and/or uptake of the active substance or ingredient. As a non-limiting examples such additives are diluents, solvents, adjuvants, (ionic) surfactants, wetting agents, spreading agents, oils, stickers, thickeners, penetrants, buffering agents, acidifiers, anti-settling agents, anti-freeze agents, photo-protectors, defoaming agents, biocides, protease inhibitors and/or drift control agents.

A “fungistatic composition” or a “fungistatic agent” as used herein means any active ingredient, substance or principle or a composition comprising any active ingredient, substance or principle for fungistatic use (as further defined herein) comprising at least one active fungistatic substance or ingredient, optionally combined with one or more additives favouring optimal dispersion, atomization, deposition, leaf wetting, distribution, retention and/or uptake of the active substance or ingredient. As a non-limiting examples such additives are diluents, solvents, adjuvants, (ionic) surfactants, wetting agents, spreading agents, oils, stickers, thickeners, penetrants, buffering agents, acidifiers, anti-settling agents, anti-freeze agents, photo-protectors, defoaming agents, biocides, protease inhibitors and/or drift control agents.

A “fungicidal composition” or a “fungicidal agent” as used herein means any active ingredient, substance or principle or a composition comprising any active ingredient, substance or principle for fungicidal use (as further defined herein) comprising at least one active fungicidal substance or ingredient, optionally combined with one or more additives favouring optimal dispersion, atomization, deposition, leaf wetting, distribution, retention and/or uptake of the active substance or ingredient. As a non-limiting examples such additives are diluents, solvents, adjuvants, (ionic) surfactants, wetting agents, spreading agents, oils, stickers, thickeners, penetrants, buffering agents, acidifiers, anti-settling agents, anti-freeze agents, photo-protectors, defoaming agents, biocides, protease inhibitors and/or drift control agents.

“Agrochemical use”, as used herein, not only includes the use of agrochemicals as defined above (for example, pesticides, growth regulators, nutrients/fertilizers, repellants, defoliants etc.) that are suitable and/or intended for use in field grown crops (e.g., agriculture), but also includes the use of agrochemicals as defined above (for example, pesticides, growth regulators, nutrients/fertilizers, repellants, defoliants etc.) that are meant for use in greenhouse grown crops (e.g. horticulture/floriculture) or hydroponic culture systems and even the use of agrochemicals as defined above that are suitable and/or intended for non-crop uses such as uses in private gardens, household uses (for example, herbicides or insecticides for household use), or uses by pest control operators (for example, weed control etc.).

“Biostatic (effect)” or “biostatic use”, as used herein, includes any effect or use of an active substance (optionally comprised in a biostatic, biocidal, fungicidal or fungistatic composition as defined herein) for controlling, modulating or interfering with the harmful activity of a pest, such as a plant pest or a plant pathogen, including but not limited to inhibiting the growth or activity of the pest, altering the behaviour of the pest, and repelling the pest in or on plants, plant parts or in other agro-related settings, such as for example for household uses or in soil.

“Biocidal (effect)” or “biocidal use”, as used herein, includes any effect or use of an active substance (optionally comprised in a biocidal or fungicidal composition as defined herein) for killing the pest in or on plants, plant parts or in other agro-related settings, such as for example for household uses or in soil.

“Anti-fungal” activity or effect refers to fungistatic and/or fungicidal activity or effect.

“Fungistatic (effect)” or “Fungistatic use” or “fungistatic activity”, as used herein, includes any effect or use of an active substance (optionally comprised in a fungicidal or fungistatic composition as defined herein) for controlling, modulating or interfering with the harmful activity of a fungus, including but not limited to inhibiting the growth or activity of the fungus, altering the behaviour of the fungus, and repelling or attracting the fungus in plants, plant parts or in other agro-related settings, such as for example for household uses or in soil.

“Fungicidal (effect)” or “Fungicidal use” or “fungicidal activity”, as used herein, includes any effect or use of an active substance (optionally comprised in a fungicidal composition as defined herein) for killing the fungus in or on plants, plant parts or in other agro-related settings, such as for example for household uses or in soil.

“Pesticidal activity” or “biocidal activity”, as used interchangeably herein, means to interfere with the harmful activity of a pest, including but not limited to killing the pest.

“Biostatic activity”, as used herein, means to interfere with the harmful activity of a pest, including but not limited to inhibiting the growth or activity of the pest, altering the behaviour of the pest, or repelling the pest.

Pesticidal, biocidal, or biostatic activity of an active ingredient, substance or principle or a composition or agent comprising a pesticidal, biocidal, or biostatic active ingredient, substance or principle, can be expressed as the minimum inhibitory activity (MIC) of an agent (expressed in units of concentration such as e.g. mg/mL), without however being restricted thereto.

“Fungicidal activity”, as used herein, means to interfere with the harmful activity of a fungus, including but not limited to killing the fungus.

“Fungistatic activity”, as used herein, means to interfere with the harmful activity of a fungus, including but not limited to inhibiting the growth or activity of the fungus, altering the behaviour of the fungus, and repelling the fungus.

Fungicidal or fungistatic activity of an active ingredient, substance or principle or a composition or agent comprising a pesticidal, biocidal, or biostatic active ingredient, substance or principle, can be expressed as the minimum inhibitory activity (MIC) of an agent (expressed in units of concentration such as e.g. mg/mL), without however being restricted thereto.

A “carrier”, as used herein, means any solid, semi-solid or liquid carrier in or on(to) which an active substance can be suitably incorporated, included, immobilized, adsorbed, absorbed, bound, encapsulated, embedded, attached, or comprised. Non-limiting examples of such carriers include nanocapsules, microcapsules, nanospheres, microspheres, nanoparticles, microparticles, liposomes, vesicles, beads, a gel, weak ionic resin particles, liposomes, cochleate delivery vehicles, small granules, granulates, nano-tubes, bucky-balls, water droplets that are part of an water-in-oil emulsion, oil droplets that are part of an oil-in-water emulsion, organic materials such as cork, wood or other plant-derived materials (e.g. in the form of seed shells, wood chips, pulp, spheres, beads, sheets or any other suitable form), paper or cardboard, inorganic materials such as talc, clay, microcrystalline cellulose, silica, alumina, silicates and zeolites, or even microbial cells (such as yeast cells) or suitable fractions or fragments thereof.

As used herein, the term “antibody” refers to polyclonal antibodies, monoclonal antibodies, humanized antibodies, single-chain antibodies, and fragments thereof such as Fab F(ab)2, Fv, and other fragments that retain the antigen binding function of the parent antibody. As such, an antibody may refer to an immunoglobulin or glycoprotein, or fragment or portion thereof, or to a construct comprising an antigen-binding portion comprised within a modified immunoglobulin-like framework, or to an antigen-binding portion comprised within a construct comprising a non-immunoglobulin-like framework or scaffold.

As used herein, the term “monoclonal antibody” refers to an antibody composition having a homogeneous antibody population. The term is not limited regarding the species or source of the antibody, nor is it intended to be limited by the manner in which it is made. The term encompasses whole immunoglobulins as well as fragments such as Fab, F ab)2, Fv, and others that retain the antigen binding function of the antibody. Monoclonal antibodies of any mammalian species can be used in this invention. In practice, however, the antibodies will typically be of rat or murine origin because of the availability of rat or murine cell lines for use in making the required hybrid cell lines or hybridomas to produce monoclonal antibodies.

As used herein, the term “polyclonal antibody” refers to an antibody composition having a heterogeneous antibody population. Polyclonal antibodies are often derived from the pooled serum from immunized animals or from selected humans.

“Heavy chain variable domain of an antibody or a functional fragment thereof”, as used herein, means (i) the variable domain of the heavy chain of a heavy chain antibody, which is naturally devoid of light chains (also indicated hereafter as V_{HH}), including but not limited to the variable domain of the heavy chain of heavy chain antibodies of camelids or sharks or (ii) the variable domain of the heavy chain of a conventional four-chain antibody (also indicated hereafter as V_{H}), including but not limited to a camelized (as further defined herein) variable domain of the heavy chain of a conventional four-chain antibody (also indicated hereafter as camelized V_{H}).

As further described hereinbelow, the amino acid sequence and structure of a heavy chain variable domain of an antibody can be considered, without however being limited thereto, to be comprised of four framework regions or “FR's”, which are referred to in the art and hereinbelow as “framework region 1” or “FR1”; as “framework region 2” or “FR2”; as “framework region 3” or “FR3”; and as “framework region 4” or “FR4”, respectively, which framework regions are interrupted by three complementary determining regions or “CDR's”, which are referred to in the art as “complementarity determining region 1” or “CDR1”; as “complementarity determining region 2” or “CDR2”; and as “complementarity determining region 3” or “CDR3”, respectively.

As also further described hereinbelow, the total number of amino acid residues in a heavy chain variable domain of an antibody (including a V_{HH} or a V_{H}) can be in the region of 110-130, is preferably 112-115, and is most preferably 113. It should however be noted that parts, fragments or analogs of a heavy chain variable domain of an antibody are not particularly limited as to their length and/or size, as long as such parts, fragments or analogs retain (at least part of) the functional activity, such as the pesticidal, biocidal, biostatic activity, fungicidal or fungistatic activity (as defined herein) and/or retain (at least part of) the binding specificity of the original a heavy chain variable domain of an antibody from which these parts, fragments or analogs are derived from. Parts, fragments or analogs retaining (at least part of) the functional activity, such as the pesticidal, biocidal, biostatic activity, fungicidal or fungistatic activity (as defined herein) and/or retaining (at least part of) the binding specificity of the original heavy chain variable domain of an antibody from which these parts, fragments or analogs are derived from are also further referred to herein as “functional fragments” of a heavy chain variable domain.

A method for numbering the amino acid residues of heavy chain variable domains is the method described by Chothia et al. (Nature 342, 877-883 (1989)), the so-called “AbM definition” and the so-called “contact definition”. Herein, this is the numbering system adopted.

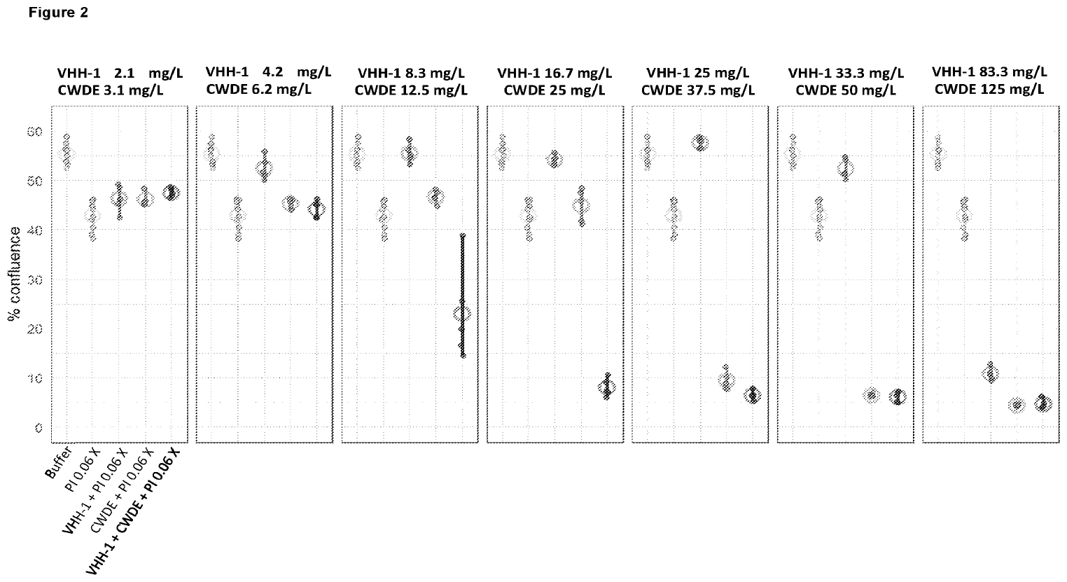

Alternatively, the amino acid residues of a variable domain of a heavy chain variable domain of an antibody (including a V_{HH} or a V_{H}) may be numbered according to the general numbering for heavy chain variable domains given by Kabat et al. (“Sequence of proteins of immunological interest”, US Public Health Services, NIH Bethesda, Md., Publication No. 91), as applied to VHH domains from Camelids in the article of Riechmann and Muyldermans, referred to above (see for example FIG. 2 of said reference).

For a general description of heavy chain antibodies and the variable domains thereof, reference is inter alia made to the following references, which are mentioned as general background art: WO 94/04678, WO 95/04079 and WO 96/34103 of the Vrije Universiteit Brussel; WO 94/25591, WO 99/37681, WO 00/40968, WO 00/43507, WO 00/65057, WO 01/40310, WO 01/44301, EP 1134231 and WO 02/48193 of Unilever; WO 97/49805, WO 01/21817, WO 03/035694, WO 03/054016 and WO 03/055527 of the Vlaams Instituut voor Biotechnologie (VIB); WO 03/050531 of Algonomics N.V. and Ablynx NV; WO 01/90190 by the National Research Council of Canada; WO 03/025020 (=EP 1 433 793) by the Institute of Antibodies; as well as WO 04/041867, WO 04/041862, WO 04/041865, WO 04/041863, WO 04/062551 by Ablynx; Hamers-Casterman et al., Nature 1993 Jun. 3; 363 (6428): 446-8.

Generally, it should be noted that the term “heavy chain variable domain” as used herein in its broadest sense is not limited to a specific biological source or to a specific method of preparation. For example, as will be discussed in more detail below, the heavy chain variable domains of the invention can be obtained (1) by isolating the V_{HH} domain of a naturally occurring heavy chain antibody; (2) by isolating the V_{H} domain of a naturally occurring four-chain antibody (3) by expression of a nucleotide sequence encoding a naturally occurring V_{HH} domain; (4) by expression of a nucleotide sequence encoding a naturally occurring V_{H} domain (5) by “camelization” (as described below) of a naturally occurring V_{H} domain from any animal species, in particular a species of mammal, such as from a human being, or by expression of a nucleic acid encoding such a camelized V_{H} domain; (6) by “camelisation” of a “domain antibody” or “Dab” as described by Ward et al (supra), or by expression of a nucleic acid encoding such a camelized V_{H} domain (7) using synthetic or semi-synthetic techniques for preparing proteins, polypeptides or other amino acid sequences; (8) by preparing a nucleic acid encoding a V_{HH} or a V_{H} using techniques for nucleic acid synthesis, followed by expression of the nucleic acid thus obtained; and/or (9) by any combination of the foregoing. Suitable methods and techniques for performing the foregoing will be clear to the skilled person based on the disclosure herein and for example include the methods and techniques described in more detail hereinbelow.

However, according to a specific embodiment, the heavy chain variable domains as disclosed herein do not have an amino acid sequence that is exactly the same as (i.e. as a degree of sequence identity of 100% with) the amino acid sequence of a naturally occurring V_{H} domain, such as the amino acid sequence of a naturally occurring V_{H} domain from a mammal, and in particular from a human being.

The terms “effective amount” and “effective dose”, as used herein, mean the amount needed to achieve the desired result or results.

As used herein, the terms “determining”, “measuring”, “assessing”, “monitoring” and “assaying” are used interchangeably and include both quantitative and qualitative determinations.

As used herein, the phrase “cell wall disrupting agent” or “cell wall disruption agent” relates to any agent capable of altering the integrity of a cell wall. This can include, but is not limited to degradation, permeabilization, digestion, dissolving, thinning, loosening, weakening and lysis of the cell wall. The cell wall may be any cell wall, such as a bacterial cell wall, a plant cell wall or a fungal cell wall. The cell wall disrupting agent may reduce the integrity of the cell wall.

All documents cited in the present specification are hereby incorporated by reference in their entirety. Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

### Polypeptides

The polypeptides disclosed here are generally capable of binding to or interacting with a fungus. The polypeptides disclosed here are generally (although not exclusively) antibodies or antibody fragments such as heavy chain variable domain of an antibody or a functional fragments thereof. More specifically, a heavy chain variable domain of a heavy chain antibody (VHH) or a functional fragment thereof may be preferred.

The polypeptides of and used in the invention may (specifically) bind to a membrane of a fungus or a component of a membrane of a fungus. Specifically, the polypeptides may bind a component of the plasma membrane of a fungus. The polypeptides may interact with the cell membrane of a fungus. The polypeptides may specifically bind a structural molecular component of the plasma membrane of a fungus. The polypeptides used in the current invention may have, when binding to or interacting with the cell membrane, the effect of disrupting the cell membrane, such as by intercalating in the phospholipid bi-layer either by specifically or non-specifical interactions or binding.

The polypeptides may be capable of (specifically) binding to a lipid-containing fraction of the plasma membrane of a fungus, such as for example a lipid-containing fraction of Botrytis cinerea or other fungus. Said lipid-containing fraction (of Botrytis cinerea or otherwise) may be obtainable by chromatography. The chromatography may be performed on a crude lipid extract (also referred to herein as a total lipid extract, or TLE) obtained from fungal hyphae and/or conidia. The chromatography may be, for example, thin-layer chromatography or normal-phase flash chromatography. The chromatography (for example thin-layer chromatography) may be performed on a substrate, for example a glass plate coated with silica gel. The chromatography may be performed using a chloroform/methanol mixture (for example 85/15% v/v) as the eluent.

For example, said lipid-containing fraction may be obtainable by a method comprising:
fractionating hyphae and/or conidia of a fungus (for example Botrytis cinerea or other fungus) by total lipid extract thin-layer chromatography and selecting the fraction with a Retention Factor (Rf) higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (Rf) higher than the ceramide fraction and lower than the non-polar phospholipids fraction.

Alternatively, the fraction may be obtained using normal-phase flash chromatography. In such a method, the method may comprise:
fractionating hyphae and/or conidia of a fungus (for example Botrytis cinerea or other fungus) by total lipid extract normal-phase flash chromatography, and selecting the fraction with a Retention Factor (Rf) higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH₂Cl₂) and MeOH and using CH₂Cl₂/MeOH (for example 85/15%, v/v) as the eluent, followed by filtration of the fractions through a filter.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH₂Cl₂) and MeOH loading the TLE on to a phase flash cartridge (for example a flash cartridge with 15 μm particles), running the column with CH₂Cl₂/MeOH (85/15%, v/v) as the eluent, and filtering the fractions through a filter (for example a 0.45 μm syringe filter with a nylon membrane) and drying the fractions.

The fractions from the chromatography may be processed prior to testing of binding of the polypeptide to the fraction or of interaction with the fraction. For example, liposomes comprising the fractions may be prepared. Such a method may comprise the use of thin-film hydration. For example, in such a method, liposomes may be prepared using thin-film hydration with the addition of 1,6-diphenyl-1,3,5-hexatriene (DPH). Binding and/or disruption of the membranes by binding of the polypeptide may be measured by a change in fluorescence before and after polypeptide binding (or by reference to a suitable control).

Accordingly, in some embodiments, the polypeptides of and used in the invention may (specifically) bind to a lipid-containing chromatographic fraction of the plasma membrane of a fungus, optionally wherein the lipid-containing chromatographic fraction is prepared into liposomes prior to testing the binding of the polypeptide thereto.

Binding of the polypeptide to a lipid-containing fraction of a fungus may be confirmed by any suitable method, for example bio-layer interferometry. Specific interactions with the lipid-containing fractions may be tested. For example, it may be determined if the polypeptide is able to disrupt the lipid fraction when the fraction is prepared into liposomes, for example using thin-film hydration.

In methods involving chromatography, an extraction step may be performed prior to the step of chromatography. For example, fungal hyphae and/or conidia may be subjected to an extraction step to provide a crude lipid extract or total lipid extract on which the chromatography is performed. For example, in some embodiments, fungal hyphae and/or conidia (for example fungal hyphae and/or conidia of Fusarium oxysporum or Botrytis cinerea) may be extracted at room temperature, for example using chloroform:methanol at 2:1 and 1:2 (v/v) ratios. Extracts so prepared may be combined and dried to provide a crude lipid extract or TLE.

Accordingly, in some embodiments, the polypeptide may be capable of (specifically) binding to a lipid-containing fraction of the plasma membrane of a fungus (such as Fusarium oxysporum or Botrytis cinerea), wherein the lipid-containing fraction of the plasma membrane of the fungus is obtained or obtainable by chromatography. The chromatography may be normal-phase flash chromatography or thin-layer chromatography. Binding of the polypeptide to the lipid to the lipid-containing fraction may be determined according to bio-layer interferometry. In some embodiments, the chromatography step may be performed on a crude lipid fraction obtained or obtainable by a method comprising extracting lipids from fungal hyphae and/or conidia from a fungal sample. The extraction step may use chloroform:methanol at 2:1 and 1:2 (v/v) ratios to provide two extracts, and then combining the extracts.

In methods relating to thin-layer chromatography, the chromatography may comprise the steps of:
fractionating hyphae of the fungus by total lipid extract thin-layer chromatography and selecting the fraction with a Retention Factor (Rf) higher than the ceramide fraction and lower than the non-polar phospholipids fraction.

In some methods relating to thin-layer chromatography, the chromatography may comprise the steps of:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (Rf) higher than the ceramide fraction and lower than the non-polar phospholipids fraction

In methods relating to normal-phase flash chromatography, the chromatography may comprise the steps of:
fractionating hyphae and/or conidia of a fungus (for example Botrytis cinerea or other fungus) by total lipid extract normal-phase flash chromatography, and selecting the fraction with a Retention Factor (Rf) higher than the ceramide fraction and lower than the non-polar phospholipids fraction.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH₂Cl₂) and MeOH and using CH₂Cl₂/MeOH (for example 85/15%, v/v) as the eluent, followed by filtration of the fractions through a filter.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH₂Cl₂) and MeOH loading the TLE on to a phase flash cartridge (for example a flash cartridge with 15 μm particles), running the column with CH₂Cl₂/MeOH (85/15%, v/v) as the eluent, and filtering the fractions through a filter (for example a 0.45 μm syringe filter with a nylon membrane) and drying the fractions.

More specifically polypeptides capable of (specifically) binding to a lipid-containing fraction of the plasma membrane of a fungus, such as for example a lipid-containing fraction of Botrytis cinerea or other fungus, may be antibodies more specifically a VHH antibody or a fragment thereof, more specifically any one of SEQ ID NO: 1, 2, 6, 10, 14 or 15.

Alternatively, the polypeptides may be capable of (specifically) binding to sphinglolipids present in the fungal cell membrane, for instance 9-methyl 4,8-sphingadienine, glycosylceramides, glucosylceramide, monoglucosylceramides, oligoglucosylceramides, gangliosides, sulfatides, ceramides, sphingosine-1-phosphate, ceramide-1-phosphate, galactosylceramide, inositol-phosphorylceramide (IPC), mannosyl-inositol-phosphorylceramide (MIPC), galactosyl-inositol-phosphorylceramide, mannosyl-(inositol-phosphoryl)2-ceramide (M(IP)2C), dimannosyl-inositol-phosphorylceramide (M2IPC), galactosyl-dimannosyl-inositol-phosphorylceramide (GaIM2IPC), mannosyl-di-inositol-diphosphorylceramide,di-inositol-diphosphorylceramide, trigalactosyl-glycosylceramide.

Non-limiting examples of sphingolipids, to which the polypeptides that may be used in the current invention may bind, are glycosylceramides, glucosylceramide, sphingomyelin, monoglycosylceramides, oligoglycosylceramides, gangliosides, sulfatides, ceramides, sphingosine-1-phosphate and ceramide-1-phosphate. In a preferred embodiment the polypeptide may bind to a glucosylceramide of a fungal cell, such as glucosylceramide of a Botrytis or Fusarium fungal cell. More specifically polypeptides capable of binding to sphingolipids, specifically glucosylceramide may be an antibody more specifically a VHH antibody or a fragment thereof, more specifically any one of SEQ ID NO: 16 to SEQ ID NO: 99. In some aspects, the present invention provides a polypeptide comprising or consisting of the amino acid sequence set out in any one of SEQ ID NOs: 1, 2, 6, 10 or 14 to 99, or a sequence having at least 70%, at least 75%, at least 80%, at least 85%, at least 90%, at least 95% or at least 98% identity thereto.

In some aspects, the present invention provides a polypeptide comprising or consisting of the amino acid sequence set out in any one of SEQ ID NOs: 1, 2, 6, 10 or 14 to 99, or a sequence having at least 70%, at least 75%, at least 80%, at least 85%, at least 90%, at least 95% or at least 98% identity thereto.

The CDR and framework regions maybe defined according to the Kabat numbering system.

In some aspects the polypeptide may be a small peptide with anti-microbial properties such as an antimicrobial peptide or AMP. AMPs usually have a length of in the range of from about 10 to about 50 amino acids. AMPs are commonly anionic or cationic (i.e. they are charged) and can be subdivided in 4 classes: (i) anionic peptides which are rich in glutamic and aspartic acids, (ii) linear cationic α-helical peptides, (iii) cationic peptides enriched for specific amino acid rich in proline, arginine, phenylalanine, glycine, tryptophan and (iv) anionic/cationic peptides forming disulfide bonds. More specific examples are plant derived AMPs with antimicrobial activities such as peptides composed of at least two helical domains connected by a linker/turn such as plant-derived amphipathic helix or two helices engineered into a helix-turn-helix (HTH) format in which homologous or heterogeneous helices are connected by a peptide linker. For example, as described in WO2021202476, WO2020072535, WO2020176224 or WO2003000863. More specifically, the AMPs that may be used in the current invention may be AMPs having the ability to disrupt or destabilise the cell membrane of fungal cells. In the invention, when the polypeptide is an AMP, the AMP and the cell wall disrupting agent may act synergistically, for example to allow the IC50 to be reached at a concentration or dose lower. The combination of an AMP and a dell wall disrupting agent may act synergistically in the same way as seen for the combination of other polypeptides and a cell wall disrupting agent, for example the combination of VHHs and cell wall disrupting agents, as seen in the Examples. In this way, effective pest control can be achieved using lower doses or concentrations of each component.

The polypeptides of the invention may be provided in the form of compositions, for example agrochemical compositions. The polypeptides of the invention are provided in the form of compositions further comprising at least one cell wall disrupting agent, as described herein.

### Cell Wall Disrupting Agents

The compositions disclosed herein may contain a cell wall disrupting agent. The cell wall disrupting agent disclosed herein may be any agent capable of disrupting the integrity of the cell wall. More specifically, the cell wall disrupting agent may be a fungal cell wall disrupting agent. In some embodiments, the cell wall disrupting agent is an enzyme. In some preferred embodiments, the cell wall disrupting agent is a cell wall degrading enzyme (CWDE). Therefore, the invention provides for compositions comprising a cell wall degrading enzyme, and methods and uses thereof. In some embodiments, the cell wall degrading enzyme is the only active ingredient in the composition.

In some embodiments, the cell wall disrupting agent is active against a bacterial cell wall. In some embodiments, the cell wall disrupting agent is active against a plant cell wall. In a preferred embodiment, the cell wall disrupting agent is active against a fungal cell wall. In some embodiments, the cell wall disrupting agent is active against a fungal cell wall but is not active against a plant cell wall.

In some embodiments, the cell wall disrupting agent reduces the integrity of the cell wall. The reduction in cell wall integrity may allow molecules to permeate through the cell wall to the cell membrane. In some embodiments, the molecules that permeate through the cell wall are proteins. In preferred embodiments, the proteins that permeate through the cell wall comprise heavy chain variable domains of a heavy chain antibody (VHH) or a functional fragment thereof. In preferred embodiments, the molecules that permeate the cell wall are polypeptides of the composition disclosed herein. In some embodiments the cell wall disrupting agent alone, acts as an anti-pest agent, such as for instance a biostatic agent or a pesticidal agent, including but not limited to a fungistatic or a fungicidal agent.

The cell wall disrupting agent may be a cell wall degrading enzyme. In some embodiments, the composition disclosed herein comprises a mixture of cell wall degrading enzymes. In some embodiments, the composition comprises at least one, at least two, at least 3, at least 4 or at least 5 cell wall degrading enzymes. In some embodiments, the composition comprises multiple cell wall degrading enzymes. In some embodiments, the composition may comprise a cocktail of cell wall disrupting agents. The term “cocktail” relates to a composition comprising one or more enzymes. The cocktail may contain additional agents not directed to cell wall disruption, such as one or more proteases or one or more arabinanases. In some embodiments, the composition may comprise one or more protease inhibitors.

The cell wall degrading enzyme may be a carbohydrolase. The cell wall degrading enzyme may be a cellulase. In some embodiments the cell wall degrading enzyme is selected from the group consisting of glucanases, chitinases, mannanases, xyloglucanases, pectinases, glycosidases and xylanases. In some embodiments the cell wall degrading enzyme is selected from the group consisting of glucanases and chitinases. The invention also contemplates a composition comprising a mixture of enzymes comprising at least one enzyme selected from the group consisting of glucanases, chitinases, mannanases, xyloglucanases, pectinases, glycosidases and xylanases. In some embodiments, the mixture of enzymes in the composition comprises at least one chitinase and at least one glucanase. In some embodiments, the mixture of enzymes in the composition comprises at least two chitinases and at least two glucanases. In some embodiments, the mixture of enzymes in the composition comprises at least one chitinase and at least two different glucanases, or at least two different chitinases and at least one glucanase.

In some embodiments, the cell wall degrading enzyme has chitinolytic activity. The chitinase may be endo-chitinase or exo-chitinase. The exo-chitinase may target the reducing or non-reducing end of the chitin.

In some embodiments the cell wall degrading enzyme is a glucanase. Glucanases are also referred to as lichenases, hydrolases, glycosidases, glycosyl hydrolases, and/or laminarinases. In some embodiments the glucanase is a beta-glucanase, such as beta-1,3-glucanase, and/or beta-1,6-glucanase. The glucanase may be an endo-glucanase or an exo-glucanase. In some embodiments, the glucanase is selected from the group consisting of exo-β-1,3-glucanase (also known as glucan 1,3-beta-glucosidase), endo-β-1,3-glucanase (also known as glucan endo-1,3-beta-D-glucosidase), exo-β-1,6-glucanase (also known as glucan 1,6-alpha-glucosidase), endo-β-1,6-glucanase (also known as glucan endo-1,6-beta-glucosidase) and endo-β-1,3(4)-glucanase. In some embodiments, the composition disclosed herein comprises a glucanase selected from the group consisting of exo-β-1,3-glucanase (also known as glucan 1,3-beta-glucosidase), endo-β-1,3-glucanase (also known as glucan endo-1,3-beta-D-glucosidase), exo-β-1,6-glucanase (also known as glucan 1,6-alpha-glucosidase), and endo-β-1,6-glucanase (also known as glucan endo-1,6-beta-glucosidase), and endo-β-1,3(4)-glucanase and/or any combination thereof.

In some embodiments, the composition disclosed herein does not contain an agent capable of degrading plant cell walls. In some embodiments, the composition does not contain β-1,4-glucanases.

The cell wall degrading enzymes disclosed herein may be naturally occurring or synthetic. The cell wall degrading enzyme may be derived from filamentous fungi, yeasts, viruses, bacteria, archaea, and plants. The cell wall degrading enzymes may be derived from an organism selected from the group consisting of Abracris flavolineata, Acanthocheilonema viteae, Acetivibrio thermocellus, Achlya bisexualis, Achromobacter sp., Acinetobacter sp., Acremonium blochii, Acremonium persicinum, Acremonium sp., Aeromonas caviae, Aeromonas caviae, Aeromonas hydrophila, Aeromonas schubertii, Aeromonas sp., Agaricus bisporus enzyme, Agaricus brasiliensis, Agrius convolvuli, Alicyclobacillus sp., Alkalihalobacillus clausii, Alkalihalobacillus clausii, Alternaria bataticola, Alternaria tenuissima, Alteromonas sp., Amanita muscaria, Amycolatopsis orientalis, Amylomyces rouxii, Anadara broughtonii, Anaeromyces mucronatus, Ananas comosus, Annona cherimola, Antheraea pernyi, Apium graveolens, Aplysia kurodai, Apriona germari, Arabidopsis thaliana, Arcopilus cupreus, Arthrobacter globiformis, Arthrobacter sp., Aspergillus flavus, Aspergillus fumigatus, Aspergillus griseoaurantiacus, Aspergillus nidulans, Aspergillus niger, Aspergillus oryzae, Aspergillus phoenicis, Aspergillus versicolor, Aspergillus sp., Aspergillus usamii, Astragalus membranaceus, Atriplex littoralis, Autographa californica, Avena sativa, Bacillus amyloliquefaciens, Bacillus cereus, Bacillus licheniformis, Bacillus pumilus, Bacillus sp., Bacillus subtilis, Bacillus tequilensis, Bacillus thuringiensis, Bacteroides fragilis, Bacteroides thetaiotaomicron, Basidiomycota, Bambusa oldhamii, Beauveria bassiana, Benincasa hispida, Bipolaris zeicola, Bombyx mori, Bos Taurus, Boscia senegalensis, Botrytis cinerea, Brassica juncea, Brassica oleracea, Brevibacillus formosus, Brevibacillus formosus, Brevibacterium fuscum var. dextranlyticum, Bromus inermis, Brugia malayi, Burkholderia cepacian, Caldicellulosiruptor sp., Calvatia cyanthiformis, Candida albicans, Capra hircus, Carica papaya, Carnobacterium divergens, Carnobacterium maltaromaticum, Casuarina glauca, Cellulomonas fimi, Cellulosimicrobium cellulans, Cellulosimicrobium funkei, Chaetomium globosum, Chaetomium sp., Chaetomium thermophilum, Chelonus sp., Cherax destructor, Chitiniphilus shinanonensis, Chlamys albidus, Chondrus verrucosus, Chromobacterium sp., Cicer arietinum, Citrobacter freundii, Citrus aurantiifolia, Citrus sinensis, Clonostachys rosea, Clostridium paraputrificum, Clostridium sp., Coccidioides immitis, Coprinopsis cinerea, Coprinellus congregates, Corallococcus sp., Cordyceps javanica, Crithidia fasciculata, Crocus sativus, Crocus vernus, Cryptococcus neoformans, Cryptopygus antarcticus, Cucumis melo, Cucumis sativus, Cucurbita maxima, Cupiennius salei, Cyberlindnera jadinii, Cyberlindnera saturnus, Cycas revolute, Daucus carota, Debaryomyces hansenii, Delftia tsuruhatensis, Dichotomopilus indicus, Dioscorea oppositifolia, Dioscorea polystachya, Diversispora versiformis, Drosera rotundifolia, Entamoeba dispar, Entamoeba histolytica, Enterobacter sp., Euglena gracilis, Eulota maakii, Euphorbia characias, Fibrobacter succinogenes, Ficus pumila, Fibrobacter succinogenes, Flavobacterium dormitator, Flavobacterium sp., Formosa algae, Francisella tularensis, Fraxinus excelsior, Fungi imperfecti, Fusarium chlamydosporum, Fusarium fujikuroi, Fusarium oxysporum, Fusarium sambucinum, Gallus gallus, Ganoderma lucidum, Gastrophysa atrocyanea, Gecarcoidea natalis, Gemmabryum coronatum, Geotrichum lactis, Glaciozyma Antarctica, Gladiolus x gandavensis, Glycine max, Gossypium hirsutum, Haemaphysalis longicornis, Haliotis discus hannai, Haliotis tuberculate, Halobacterium salinarum, Helix pomatia, Helminthosporium sesamum, Herpetomonas muscarum, Hevea brasiliensis, Hexagrammos otakii, Homo sapiens, Hordeum vulgare, Humicola insolens, Hydrogenophilus hirschii, Ipomoea carnea, Isoptericolajiangsuensis, Irpex lacteus, Jatropha curcas, Kluyveromyces aestuarii, Kluyveromyces phaseolosporus, Kluyveromyces lactis, Komagataella pastoris, Laccaria laccata, Laceyella putida, Lactiplantibacillus plantarum, Lactobacillus acidophilus, Lactococcus lactis, Lecanicillium fungicola, Leishmania braziliensis, Leishmania donovani, Leishmania infantum, Leishmania major, Leishmania Mexicana, Lemna minor, Lentinula edodes, Leptomonas seymouri, Leucaena leucocephala, Leucoagaricus gongylophorus, Limonium bicolor, Lipomyces lipofer, Littorina kurila, Listeria innocua, Listeria monocytogenes, Listeria seeligeri, Listeria welshimeri, Lotus japonicus, Lysobacter enzymogenes, Macaca fascicularis, Malbranchea chrysosporioidea, Malus domestica, Manduca sexta, Massilia timonae, Melghiribacillus thermohalophilus, Metarhizium anisopliae, Meyerozyma caribbica, Microbispora sp., Mizuhopecten yessoensis, Monascus purpureus, Moritella marina, Mucor hiemalis, Mucor mucedo, Mus musculus, Musa acuminate, Musa sp., Musa x paradisiaca, Mycobacterium tuberculosis, Mythimna separate, Naganishia diffluens, Neotyphodium sp., Nepenthes alata, Neurospora crassa, Niallia circulans, Nicotiana glutinosa, Nicotiana tabacum, Nocardiopsis prasina, Nocardiopsis sp., Oreochromis niloticus, Orpinomyces sp., Orpinomyces sp., Oryza sativa, Ostrinia furnacalis, Ovis aries, Paenibacillus barengoltzii, Paenibacillus ehimensis, Paenibacillus macerans, Paenibacillus sp., Paenibacillus thermoaerophilus, Panax ginseng, Parabacteroides distasonis, Paracoccidioides brasiliensis, Paraphaeosphaeria minitans, Pedobacter sp., Penaeus japonicus, Penaeus vannamei, Penicillium brefeldianum, Penicillium italicum, Penicillium multicolor, Penicillium ochrochloron, Penicillium sp., Pennahia argentata, Periconia byssoides, Perna viridis, Periplaneta Americana, Petroselinum crispum, Phanerodontia chrysosporium, Phaseolus lunatus, Phaseolus vulgaris, Phlebotomus papatasi, Phytolacca Americana, Phytophthora infestans, Picea abies, Pinus pinaster, Piper colubrinum, Piromyces communis, Pisum sativum, Plasmodium gallinaceum, Plasmodium vivax, Pneumocystis carinii, Pneumocystis murina, Pochonia chlamydosporia, Populus trichocarpa, Porodisculus pendulus, Porodisculus pendulus, Prevotella oralis, Prunus avium, Pseudoalteromonas tunicate, Pseudocardium sachalinense, Pseudomonas aeruginosa, Pseudomonas sp., Pseudotsuga menziesii, Pteris ryukyuensis, Pyrenophora tritici-repentis, Pyrococcus furiosus, Pythium insidiosum, Quercus robur, Ralstonia sp., Ralstonia sp, Rasamsonia emersonii, Rattus norvegicus, Rhizoctonia solani, Rhizomucor miehei, Rhizopus microsporus, Rhizopus sp., Rhodothermus marinus, Saccharolobus solfataricus, Saccharomyces cerevisiae, Saccharomycopsis fibuligera, Saccharum hybrid cultivar Yacheng, Saccharophagus degradans, Saccharopolyspora erythraea, Salmonella enterica typhimurium, Samia Cynthia, Sceloporus undulatus garmani, Schizophyllum commune, Schizosaccharomyces japonicus, Schizosaccharomyces pombe, Sclerotium glucanicum, Scomber japonicus, Scorpaena scrofa, Secale cereale, Serratia liquefaciens, Serratia marcescens, Serratia sp., Setaria cervi, Silene vulgaris, Solanum lycopersicum, Solanum tuberosum, Spodoptera frugiperda, Stachybotrys elegans, Stenotrophomonas maltophilia, Stomoxys calcitrans, Streptococcus mitis, Streptococcus mutans, Streptomyces antibioticus, Streptomyces atrovirens, Streptomyces coelicolor, Streptomyces cyaneus, Streptomyces cyanocolor, Streptomyces murinus, Streptomyces rochei, Streptomyces sioyaensis, Streptomyces sp., Streptococcus equinus, Streptomyces eurythermus, Streptomyces fradiae, Streptomyces griseus, Streptomyces ipomoeae, Streptomyces lividans, Streptomyces lydicus, Streptomyces plicatus, Streptomyces prasinopilosus, Streptomyces scabiei, Streptomyces thermoviolaceus, Streptomyces venezuelae, Strongylocentrotus intermedius, Strongylocentrotus purpuratus, Suillus bovinus, Suillus luteus, Sulfurisphaera tokodaii, Sus scrofa, Synechocystis sp., Tamarindus indica, Tenebrio molitor, Theobroma cacao, Thermoascus aurantiacus, Thermobifida fusca, Thermoclostridium stercorarium, Thermococcus chitonophagus, Thermococcus kodakarensis, Thermothelomyces heterothallicus, Thermothelomyces thermophilus, Thermotoga maritima, Thermotoga neapolitana, Thermotoga petrophila, Trametes cinnabarina, Tribolium castaneum, Trichoderma asperellum, Trichoderma atroviride, Trichocladium griseum, Trichoderma harzianum, Trichoderma koningii, Trichoderma longibrachiatum, Trichoderma reesei, Trichoderma sp., Trichoderma virens, Trichoderma viride, Trichoderma sp., Trichosanthes dioica, Triticum aestivum, Trypanosoma lewisi, Valerianella locusta, Verticillium albo-atrum, Verticillium dahlia, Vibrio, Iginolyticus, Vibrio harveyi, Vibrio parahaemolyticus, Vibrio proteolyticus, Vibrio sp., Vicia faba, Vitis inifera, Vitis vinifera, Wickerhamomyces anomalus, Wolfiporia cocos, Xylella fastidiosa, Yarrowia lipolytica, Zea mays, and Zobellia galactanivorans. The cell wall degrading enzymes may be derived from filamentous fungi such as Trichoderma species or Aspergillus species.

In some embodiments, the cell wall disrupting agent is active against a fungal cell wall. The fungal cell wall is composed of chitin (acetylglucosamine polymers), glucans, polysaccharides and mucopolysaccharides, waxes and pigments. The cell wall disrupting agent may act against any component of the cell wall. The cell wall disrupting agent may act against multiple components of the cell wall. Preferably, the cell wall disrupting agent is active against chitin and/or glucans in the fungal cell wall.

The fungus may be a pathogenic fungus, or a fungal pest. The fungus may be a plant pathogenic fungus. The genus of said plant pathogenic fungus may be chosen from the group comprising Alternaria, Ascochyta, Botrytis, Cercospora, Colletotrichum, Diplodia, Erysiphe, Fusarium, Leptosphaeria, Gaeumanomyces, Helminthosporium, Macrophomina, Nectria, Penicillium, Peronospora, Phoma, Phymatotrichum, Phytophthora, Plasmopara, Podosphaera, Puccinia, Pyrenophora, Pyricularia, Pythium, Rhizoctonia, Scerotium, Sclerotinia, Septoria, Thielaviopsis, Uncinula, Venturia, Verticillium, Magnaporthe, Blumeria, Mycosphaerella, Ustilago, Melampsora, Phakospora, Monilinia, Mucor, Rhizopus, and Aspergillus.

### A Cocktail of Enzymes

In some embodiments, the cell wall disrupting agent is obtained or obtainable from a fermentation of one or more microbial species. “Culturing”, “cell culture”, “fermentation”, “fermenting” or “microbial fermentation” as used herein includes suspending the microbial cell in a broth or growth medium, providing sufficient nutrients including but not limited to one or more suitable carbon source (including glucose, sucrose, fructose, lactose, Avicel®, xylose, galactose, ethanol, methanol, or more complex carbon sources such as molasses or wort), nitrogen source (such as yeast extract, peptone or beef extract), trace element (such as iron, copper, magnesium, manganese or calcium), amino acid or salt (such as sodium chloride, magnesium chloride or natrium sulfate) or a suitable buffer (such as phosphate buffer, succinate buffer, HEPES buffer, MOPS buffer or Tris buffer). It can also further involve the agitation of the culture media via for example stirring of purging to allow for adequate mixing and aeration. It can further involve different operational strategies such as batch cultivation, semi-continuous cultivation or continuous cultivation and different starvation or induction regimes according to the requirements of the microbial cell and to allow for an efficient production of the compound of interest or a compound involved in the production of the compound of interest. Alternatively, the microbial cell is grown on a solid substrate in an operational strategy commonly known as solid state fermentation. In a typical fermentation reaction, a microbial cell is propagated in a nutrient rich broth providing the necessary nutrients, salts, minerals, oxygen etc., for the microbial cell to grow and multiply to reach a certain density of cells in the fermentation broth. Generally, the broth will comprise any and all nutrients required for the microbial organism to grow. The skilled person will be aware of the required components of the culture broth or fermentation broth, which may differ depending on the species of microbial cell being cultured. In some embodiments, the culture broth or fermentation broth may comprise a nitrogen source, such as ammonium or peptone. At the end of a fermentation reaction, the fermentation broths may be clarified by removing the cellular material and as such obtaining a microbial fermentation broth that is clarified. Clarification can be achieved in many ways such as commonly known filtration, centrifugation, or precipitation techniques. In some embodiments further downstream processing steps are applied to for instance further concentrate the protein content in the clarified broth by purification. Where the fermentation broth contain one or more cell wall degrading enzymes, the further downstream processing steps may be optimized to increase the concentration of said cell wall degrading enzymes. Common downstream process steps for concentrating or purifying the protein content include filtration, chromatography steps or a combination thereof. When concentrating the protein content of a clarified broth by purification, it is understood that such a purification does not necessarily need to be complete i.e. reaching for example 90% or higher purity. For instance a single filtration step may be use with a molecular weight cut-off lower than the molecular weight of the cell wall degrading enzymes to be concentrated and whereby the retentate, comprising the cell wall degrading enzymes and other larger or similar sized components, is maintained. In some embodiments, the cell wall degrading agent is obtained or obtainable from a method comprising the steps of: a) culturing or fermenting one or more fungal or bacterial species, together or separately, under conditions to allow growth of the fungal or bacterial species; b) obtaining the fermentation broth or broths from step a); c) clarifying the fermentation broth or broths obtained from step b) to remove cellular material; d) optionally purifying the clarified broth or broths from step c) to increase the protein concentration of the broth or broths; and e) combining the broths if the fungal or bacterial species were cultured or fermented separately; thereby providing the cell wall degrading agent. The conditions to allow growth of the species will be known to the skilled person, dependent on what species of fungus or bacteria is being cultured or fermented. Generally it may comprise culturing or fermenting in a broth or growth medium that comprises sufficient nutrients to allow growth (including but not limited to one or more suitable carbon source, nitrogen source, amino acid or salt, or a suitable buffer) under conditions that further provide sufficient heat, light and atmosphere (e.g. oxygen or a lack thereof).

In a preferred embodiment the cell wall disrupting agent is obtained or obtainable from a fermentation of one or more of a fungal species. The fungal species for obtaining cell wall degrading enzymes may preferably be from the division Ascomycota, subdivision Pezizomycotina. In some embodiments, the fungal species may preferably from the Class Sordariomycetes, optionally the Subclass Hypocreomycetidae. In some embodiments, the fungal species may be from an Order selected from the group consisting of Hypocreales, Microascales, Eurotiales, Onygenales and Sordariales. In some embodiments, the fungal species may be from a Family selected from the group consisting of Hypocreaceae, Nectriaceae, Clavicipitaceae and Microascaceae. In some more specific embodiments, the fungal species may be from a Genus selected from the group consisting of Trichoderma (anamorph of Hypocrea), Myceliophthora, Fusarium, Gibberella, Nectria, Stachybotrys, Claviceps, Metarhizium, Villosiclava, Ophiocordyceps, Cephalosporium, Rasamsonia, Neurospora, and Scedosporium. In some further and more specific embodiments, the fungal species may be selected from the group consisting of Trichoderma reesei (Hypocrea jecorina), T. citrinoviridae, T. Iongibrachiatum, T. virens, T. harzianum, T. asperellum, T. atroviridae, T. parareesei, Fusarium oxysporum, F. gramineanum, F. pseudograminearum, F. venenatum, Gibberella fujikuroi, G. moniliformis, G. zeaea, Nectria (Haematonectria) haematococca, Stachybotrys chartarum, S. chlorohalonata, Claviceps purpurea, Metarhizium acridum, M. anisopliae, Villosiclava virens, Ophiocordyceps sinensis, Neurospora crassa, Rasamsonia emersonii, Acremonium (Cephalosporium) chrysogenum, Scedosporium apiospermum, Aspergillus niger, A. awamori, A. oryzae, Chrysosporium lucknowense, Myceliophthora thermophila, Myceliophthora heterothallica, Humicola insolens, Trichoderma harzianum, and Humicola grisea. In one embodiment the cell wall disrupting agent is obtained or obtainable from a fermentation of one or more of a fungal species and where the fungal species is Trichoderma harzianum. In another embodiment the cell wall disrupting agent is obtained or obtainable from a fermentation of one or more of a fungal species and where the fungal species is Aspergillus niger. In a preferred embodiment the cell wall disrupting agent is obtained or obtainable from a fermentation of one or more of a fungal species and where the fungal species are Trichoderma harzianum and Aspergillus niger. In some embodiments, the cell wall degrading agent is obtained or obtainable from a method comprising the steps of: a) culturing or fermenting Trichoderma harzianum and Aspergillus niger, together or separately, under conditions to allow growth of the fungal species; b) obtaining the fermentation broth or broths from step a); c) clarifying the fermentation broth or broths obtained from step b) to remove cellular material; d) optionally purifying the clarified broth or broths from step c) to increase the protein concentration of the broth or broths; and e) combining the broths if the fungal species were cultured or fermented separately; thereby providing the cell wall degrading agent. Such cell wall degrading agents may comprise a mixture (cocktail) of one or more glucanases. Cell wall degrading agents obtained or obtainable from such a method may be referred to herein as VinoTaste Pro.

In some embodiments, the cell wall disrupting agent is obtained or obtainable from a fermentation of one or more microbial species and where microbial species is selected from the kingdom Bacteria. In particular, the Bacteria may be selected from the group consisting of Escherichia coli (E. coli), Bacillus species, Pseudomonas species, Corynebacterium species, Streptomyces species, Lactococcus species, Shigella species, Streptococcus species, Neisseria species, Geobacillus species, Bifidobacterium species, Azotobacter species, Arthobacter species, Bordetella species, Lactobacillus species, Staphylococcus species. In a preferred embodiments, the cell wall disrupting agent is obtained from a fermentation of one or more bacterial species and where said bacterial species is Arthobacter luteus. In some embodiments, the cell wall degrading agent is obtained or obtainable from a method comprising the steps of: a) culturing or fermenting Arthobacter luteus, under conditions to allow growth of the bacterial species; b) obtaining the fermentation broth from step a); c) clarifying the fermentation broth obtained from step b) to remove cellular material; and d) optionally purifying the clarified broth from step c) to increase the protein concentration of the broth; thereby providing the cell wall degrading agent. Cell wall degrading agents obtained or obtainable from such a method may be referred to herein as Zymolyase.

Where the cell wall disrupting agent is obtained or obtainable from a fermentation of one or more microbial species, the resulting cell wall disrupting agent may be a cocktail (i.e. a mixture) of enzymes or where further purification steps, such as chromatograph steps, are performed a pure or essentially pure cell wall disrupting enzyme may be obtained. In a preferred embodiment, the cell wall disrupting agent is a cocktail. In some embodiments the cell wall disrupting agent may be a cocktail (i.e. mixture) of enzymes, such as VinoTaste™ Pro (Novozymes) or Zymolyase (amsbio or zymo research). The disclosure also explicitly covers the use of VinoTaste Pro as a cell wall disrupting agent. In some embodiments, VinoTaste Pro is the only active ingredient in the composition.

The cocktail may contain at least one cell wall disrupting agent selected from glucanase and chitinase. The cocktail may comprise at least one, at least 2, at least 3, at least 4 or at least 5 glucanases and/or chitinases. The cocktail may comprise at least one glucanase, such as a β-glucanase, endo-β-1,3-glucanase, endo-1,3(4)-β-glucanase, endo-1,3(4)-β-D-glucanase, exo-1,3-β-D-glucanase, or any combination thereof. In some embodiments, the cocktail does not comprise a pectinase and/or a protease.

The disclosure also covers a composition comprising cell wall disrupting agents that do not contain a polypeptide. In some embodiments, the composition comprises only a cell wall disruption agent as the active ingredient. In some embodiments, the invention relates to uses of cell wall disrupting agents, or a cocktail thereof, such as VinoTaste Pro, in methods for protecting or treating a plant or a part of said plant from an infection with a plant pathogenic fungus, a post-harvest treatment method for protecting or treating a harvested plant or a harvested part of said plant from an infection with a plant pathogenic fungus and a method of inhibiting the growth of, or killing, a plant pathogenic fungus. In some embodiments, the methods comprise at least the step of applying to a plant or to a part of said plant the composition disclosed herein. In some embodiments the cell wall disrupting agent is VinoTaste™ Pro. In some embodiments, the cell wall disrupting agent comprises one or more β glucanase and one optionally one or more additional components that do not act on the cell wall, for example one or more pectinase, one or more proteinase and one or more arabinose.

### Testing Cell Wall Disrupting Agents

A cell wall disrupting agent, either an individual cell wall disrupting enzyme or a cocktail or mixture of two or more cell wall disrupting enzymes, may be identified by subjecting a fungal species, such as a plant pathogenic species, to increasing amounts of the cell wall disrupting agent and observing said fungal species using standard brightfield or phase contrast microscopy with a magnification factor of 200× or more. A cell wall disrupting agent may lead at a sufficiently high concentration to the formation of protoplasts, indicating that the cell wall has been removed. protoplasts may be maintained in a correct buffer solution with a isotonic osmotic pressure (as opposed to a hypotonic buffer solution leading to collapse of the protoplasts or a hypertonic buffer solution leading to the rupture of protoplasts). A specific example of a buffer solution that may be used is the FF1 buffer consisting of 29.58 g MgSO4·7H2O, 1.37 g NaH2PO4·2H2O, 100 ml MQ water (pH 5.8). This buffer may for example be used to assess protoplasts formation of Botrytis cinerea, but the skilled person will know that many other buffers may be used as long as they are isotonic relative to the interior of the protoplasts and allow for the cell wall disrupting enzyme to be active. This assay is exemplified in Example 3 for Botrytis cinerea. The concentration required to obtain protoplasts may not be the concentration that is required in the compositions of the current invention. That is to say, for assessing the ability of a cell wall degrading agent to disrupt the fungal cell wall, a high concentration may be required to observe protoplast formation, whereas in practice the concentration to observe an effect such as an anti-fungal effect may be lower. Without wanting to be bound by theory, it may be proposed that at lower concentrations of the cell wall degrading agent, smaller disruptions of the cell wall may already be sufficient to allow the polypeptide to have an improved chance of acting on the cell membrane (for example a VHH binding to a target on the cell membrane) to show an improved efficacy.

In some embodiments, the cell wall disrupting agent is active across temperatures of from about 0 to about 60° C. In some embodiments, the cell wall disrupting agent is active at temperatures above 0° C. In some embodiments, the cell wall disrupting agent is active at temperatures from about 0 to about 10° C. In some embodiments, the cell wall disrupting agent is active at temperatures from about 0 to about 20° C. In some embodiments, the cell wall disrupting agent is active at temperatures from about 0 to about 30° C. In some embodiments, the cell wall disrupting agent is active at temperatures from about 0 to about 40° C. In some embodiments, the cell wall disrupting agent is active at temperatures from about 0 to about 50° C. In some embodiments, the cell wall disrupting agent is active during cold storage (from about 0 to about 10° C.) and at warmer temperatures up to 50° C. In some embodiments the cell wall disrupting agent is resistant to denaturation. In some embodiments, the cell wall disrupting agent is not temperature sensitive. In some embodiments the activity of the cell wall disrupting agent is not affected by temperature. In some embodiments the activity of the cell wall disrupting agent peaks at around 10° C., around 20° C., around 30° C., around 40° C., or around 50° C.

In some embodiments, the cell wall disrupting agent is active during cold storage (below about 10° C.), at room temperature (from about 10 to about 25° C.), and under sunny growing conditions, such as about 25 to about 35° C.

In some embodiments, the cell wall disrupting agent is an enzyme. In some embodiments, the cell wall disrupting agent is a cell wall degrading enzyme. In some embodiments the cell wall degrading enzyme is active across temperatures of from about 0 to about 60° C. In some embodiments the cell wall degrading enzyme is active across temperatures of from about 0 to about 50° C. In some embodiments, the cell wall degrading enzyme is active at temperatures above 0° C. In some embodiments, the cell wall degrading enzyme is active at temperatures from about 0 to about 10° C. In some embodiments, the cell wall degrading enzyme is active at temperatures from about 0 to about 20° C. In some embodiments, the cell wall degrading enzyme is active at temperatures from about 0 to about 30° C. In some embodiments, the cell wall degrading enzyme is active at temperatures from about 0 to about 40° C. In some embodiments, the cell wall degrading enzyme is active at temperatures from about 0 to about 50° C. In some embodiments, the cell wall degrading enzyme is active at temperatures above about 5° C. In some embodiments, the cell wall degrading enzyme is active at temperatures from about 5 to about 10° C. In some embodiments, the cell wall degrading enzyme is active at temperatures from about 5 to about 20° C. In some embodiments, the cell wall degrading enzyme is active at temperatures from about 5 to about 30° C. In some embodiments, the cell wall degrading enzyme is active at temperatures from about 5 to about 40° C. In some embodiments, the cell wall degrading enzyme is active at temperatures from about 5 to about 50° C.

In some embodiments the cell wall degrading enzyme is resistant to denaturation at temperatures of from about 0 to about 60° C. In some embodiments the cell wall degrading enzyme is resistant to denaturation at temperatures of from about 0 to about 50° C. In some embodiments, the cell wall degrading enzyme is resistant to denaturation at temperatures above 0° C. In some embodiments, the cell wall degrading enzyme is resistant to denaturation at temperatures from about 0 to about 10° C. In some embodiments, the cell wall degrading enzyme is resistant to denaturation at temperatures from about 0 to about 20° C. In some embodiments, the cell wall degrading enzyme is resistant to denaturation at temperatures from about 0 to about 30° C. In some embodiments, the cell wall degrading enzyme is resistant to denaturation at temperatures from about 0 to about 40° C. In some embodiments, the cell wall degrading enzyme is resistant to denaturation at temperatures from about 0 to about 50° C. In some embodiments, the cell wall degrading enzyme is resistant to denaturation at temperatures above about 5° C. In some embodiments, the cell wall degrading enzyme is resistant to denaturation at temperatures from about 5 to about 10° C. In some embodiments, the cell wall degrading enzyme is resistant to denaturation at temperatures from about 5 to about 20° C. In some embodiments, the cell wall degrading enzyme is resistant to denaturation at temperatures from about 5 to about 30° C. In some embodiments, the cell wall degrading enzyme is resistant to denaturation at temperatures from about 5 to about 40° C. In some embodiments, the cell wall degrading enzyme is resistant to denaturation at temperatures from about 5 to about 50° C.

In some embodiments, the cell wall degrading enzyme is active during cold storage (from about 0 to about 10° C.) and at warmer temperatures up to 50° C. In some embodiments the cell wall degrading enzyme is resistant to denaturation. In some embodiments, the cell wall degrading enzyme is not temperature sensitive. In some embodiments the activity of the cell wall degrading enzyme is not affected by temperature. In some embodiments the activity of the cell wall degrading enzyme peaks at around 10° C., around 20° C., around 30° C., around 40° C., or around 50° C.

In some embodiments, the cell wall degrading enzyme is active during cold storage (below about 10° C.), at room temperature (from about 10 to about 25° C.), and under sunny growing conditions, such as about 25 to about 35° C.

The cell wall disrupting agent as described herein may be provided in the form of compositions, for example agrochemical compositions. The cell wall disrupting agent of the invention are provided in the form of compositions further comprising polypeptides, as described herein. The cell wall disrupting agent may be co-administered with the polypeptides as described herein. Co-administration occurs by administering a composition comprising both a polypeptide and a cell wall disruption agent.

### Compositions

The compositions disclosed herein are comprised of at least one polypeptide and at least one cell wall disrupting agent as described herein. The at least one polypeptide may be an antibody such as a heavy chain variable domain of a heavy chain antibody (VHH) or a functional fragment thereof. Alternatively, the at least one polypeptide may be an AMP. The at least one cell disrupting agent may be an enzyme.

The compositions disclosed herein may comprise at least one VHH or functional fragment thereof. The at least one VHH may be selected from the group consisting of SEQ ID Nos: 1, 2, 6, 10 or 14 to 99.

In some embodiments, the composition disclosed herein comprises:
a CDR1 comprising or consisting of a sequence selected from the group consisting of SEQ ID NOs 3, 7 and 11;
a CDR2 comprising or consisting of a sequence selected from the group consisting of SEQ ID NOs: 4, 8 and 12; and
a CDR3 comprising or consisting of a sequence selected from the group consisting of SEQ ID NOs: 5, 9 and 13.

In some embodiments, the composition disclosed herein comprises:
a CDR1 comprising or consisting of the sequence of SEQ ID NO 3, a CDR2 comprising or consisting of the sequence of SEQ ID NO: 4 and a CDR3 comprising or consisting of the sequence of SEQ ID NO: 5;
a CDR1 comprising or consisting of the sequence of SEQ ID NO: 7, a CDR2 comprising or consisting of the sequence of SEQ ID NO: 8 and a CDR3 comprising or consisting of the sequence of SEQ ID NO: 9 or
a CDR1 comprising or consisting of the sequence of SEQ ID NO: 11, a CDR2 comprising or consisting of the sequence of SEQ ID NO: 12 and a CDR3 comprising or consisting of the sequence of SEQ ID NO: 13.

In some embodiments, the composition comprises a VHH comprising a CDR1 comprising or consisting of the sequence of SEQ ID NO: 3, a CDR2 comprising or consisting of the sequence of SEQ ID NO: 4 and a CDR3 comprising or consisting of the sequence of SEQ ID NO: 5.

In some embodiments, the compositions disclosed herein comprises a VHH disclosed in WO2014/177595 or WO2014/191146, the entire contents of which are incorporated herein by reference. More specifically the composition may comprise a VHH comprising an amino acid sequence chosen from the group consisting of SEQ ID NO's: 1 to 84 from WO2014/177595 or WO2014/191146 which refer to SEQ ID Nos 16 to 99 of this application.

The compositions disclosed herein may comprise at least one cell wall disrupting agent. The cell wall disrupting agent may be an enzyme. The enzyme may be a cell wall degrading enzyme, such as, but not limited to an endo-1,3-beta-D-glucanase, an exo-1,3-beta-D-glucanase and a chitinase. The endo-1,3-beta-D-glucanase, exo-1,3-beta-D-glucanase and chitinase may be from Trichoderma species or an Aspergillus species.

The compositions disclosed herein may include at least on VHH or functional fragment thereof and at least one cell wall disrupting agent. In some embodiments, the VHH is any one of SEQ ID No: 1, 2, 6, 10 or 14 to 99 and the cell wall disrupting agent is an endo-1,3-beta-D-glucanase, an exo-1,3-beta-D-glucanase and/or a chitinase. In some embodiments, the VHH is any one of SEQ ID No: 1, 2, 6, 10 or 14 to 99 and the cell wall disrupting agent is a glucanase. In some embodiments, the VHH is any one of SEQ ID No: 1, 2, 6, 10 or 14 to 99 and the cell wall disrupting agent is a chitinase.

In some embodiments, the polypeptide and cell wall disrupting agent disclosed herein may target the same fungal spore. In some embodiments, the polypeptide and cell wall disrupting agent disclosed herein may target the same fungal cell. In some embodiments, the polypeptide and cell wall disrupting agent disclosed herein may target the same fungal mycelium.

The invention also provides agrochemical compositions comprising at least one polypeptide as described herein and at least one cell wall disrupting agent as described herein.

Accordingly, the compositions as disclosed herein can be used to modulate, such as to decrease or inhibit, the biological function of a plant pest. The modulation of plant pest function may be enhanced when the composition is used compared to individual constituents of the composition. The modulation may affect the natural biological activities (such as, but not limited to, growth) of the pest and/or one or more biological pathways in which the structural target of that pest is involved.

Furthermore, the compositions comprising at least one polypeptide and at least one cell wall disrupting agent as disclosed herein may have several additional advantages over the traditional immunoglobulin and non-immunoglobulin binding agents known in the art. Indeed, in certain embodiments, the polypeptides as disclosed herein have an improved activity when combined with at least one cell wall disrupting agent. Without being bound by theory, it is envisioned that the cell wall disrupting agents provide an even more facilitated access of the polypeptides to targets at the surface of the pest, such as the fungal pest or inside the pest, such as a fungal pest.

In one specific, but non-limiting embodiment, the at least one polypeptide comprised in the compositions as disclosed herein may be a polypeptide comprising or, under suitable conditions (such as physiological conditions) capable of forming an immunoglobulin fold (i.e. by folding). Reference is inter alia made to the review by Halaby et al., J. (1999) Protein Eng. 12, 563-71. Preferably, when properly folded so as to form an immunoglobulin fold, such a polypeptide sequence is capable of specific binding (as defined herein) to a target or an antigen; and more preferably capable of binding to a pest target or a pest antigen with an affinity (suitably measured and/or expressed as a K_{D}-value (actual or apparent), a K_{A}-value (actual or apparent), a kₒₙ-rate and/or a k_{off}-rate, or alternatively as an IC₅₀ value, as further described herein) that is as defined herein. Also, parts, fragments, analogues, mutants, variants, alleles and/or derivatives of such polypeptide sequences are preferably such that they comprise an immunoglobulin fold or are capable for forming, under suitable conditions, an immunoglobulin fold.

In particular embodiments, the invention provides an agrochemical composition or a biological pesticide composition for combating plant pests, more particularly a plant fungus, which composition comprises at least one polypeptide, and at least one cell wall disrupting agent, as the active substances.

In certain further embodiments, the invention provides an agrochemical composition for combating plant pests, which composition comprises at least two (different) polypeptides and at least two (different) cell wall degrading enzymes as the active substance.

In still further embodiments, the invention provides an agrochemical composition for combating plant pests, which composition comprises at least three (different) polypeptides and at least three (different) cell wall degrading enzymes as the active substance. Additional combinations of different polypeptides and cell wall degrading enzymes are also envisaged, such as compositions containing one polypeptide and two or more cell wall degrading enzymes, or vice versa.

The agrochemical composition according to the invention is an agrochemical composition, as defined herein, for combating plant pests, as defined before, meaning that the agrochemical composition, more in particular the active substance, as defined before, comprised in the agrochemical composition, is able to interfere with, preferably to reduce or to arrest, the harmful effects of one or more plant pests on one or more plants, preferably crops.

The polypeptides or amino acid sequences comprised in the compositions disclosed herein can be naturally occurring polypeptides or amino acid sequences, they can be derived from a naturally occurring polypeptide, or alternatively they can be entirely artificially designed or synthesised. The polypeptides or amino acid sequences can be immunoglobulin-based or they can be based on domains present in proteins, including but not limited to microbial proteins, protease inhibitors, toxins, fibronectin, lipocalins, single chain antiparallel coiled coil proteins or repeat motif proteins. Non-limiting examples of such polypeptides, with the herein described ranges of amino acid lengths, include carbohydrate binding domains (CBD) (Blake et al (2006) J. Biol. Chem. 281, 29321-29329), heavy chain antibodies (hcAb), single domain antibodies (sdAb), minibodies (Tramontano et al (1994) J. Mol. Recognition 7, 9-24), the variable domain of camelid heavy chain antibodies (VHH), the variable domain of the new antigen receptors (VNAR), affibodies (Nygren P. A. (2008) FEBS J. 275, 2668-2676), alphabodies (see WO2010066740), designed ankyrin-repeat domains (DARPins) (Stumpp et al (2008) Drug Discovery Today 13, 695-701), anticalins (Skerra et al (2008) FEBS J. 275, 2677-2683), knottins (Kolmar et al (2008) FEBS J. 275, 2684-2690) and engineered CH2 domains (nanoantibodies, see Dimitrov D S (2009) mAbs 1, 26-28). In particular, the polypeptides or amino acid sequences as disclosed herein consist of a single polypeptide chain and are not post-translationally modified. More particularly, the polypeptides or amino acid sequences as disclosed are derived from an innate or adaptive immune system, preferably from a protein of an innate or adaptive immune system. Still more particularly, the polypeptides or amino acid sequences as disclosed herein are derived from an immunoglobulin. Most particularly, the polypeptides or amino acid sequences as disclosed herein comprise 4 framework regions and 3 complementary determining regions, or any suitable fragment thereof (which will then usually contain at least some of the amino acid residues that form at least one of the complementary determining regions). In particular, the polypeptides or amino acid sequences as disclosed herein are easy to produce at high yield, preferably in a microbial recombinant expression system, and convenient to isolate and/or purify subsequently. Particularly, the polypeptides or amino acid sequences as disclosed herein are selected from the group consisting of DARPins, knottins, alphabodies and V_{HH}'s. More particularly, the polypeptides or amino acid sequences as disclosed herein are selected from the group consisting of alphabodies and V_{HH}'S. Most particularly, the polypeptides or amino acid sequences as disclosed herein are VHH's.

In particular, the at least one polypeptide comprised in the compositions disclosed herein may consist of a single polypeptide chain and is not post-translationally modified. More particularly, the at least one polypeptide comprised in the compositions disclosed herein may be derived from an innate or adaptive immune system, preferably from a protein of an innate or adaptive immune system. Still more particularly, the at least one polypeptide comprised in the compositions disclosed herein as disclosed herein may be derived from an immunoglobulin. Most particularly, the at least one polypeptide comprised in the compositions disclosed herein may comprise 4 framework regions and 3 complementary determining regions, or any suitable fragment thereof (which will then usually contain at least some of the amino acid residues that form at least one of the complementary determining regions). In particular, the at least one polypeptide comprised in the compositions disclosed herein are easy to produce at high yield, preferably in a microbial recombinant expression system, and convenient to isolate and/or purify subsequently.

In particular, but non-limiting, embodiments, the polypeptides as disclosed herein may be polypeptides that comprise at least one amino acid sequence that is chosen from the group consisting of the CDR1 sequences, CDR2 sequences and CDR3 sequences that are described herein. In particular, a polypeptide as disclosed herein may comprise at least one antigen binding site, wherein said antigen binding site comprises at least one combination of a CDR1 sequence, a CDR2 sequence and a CDR3 sequence that are described herein.

Any polypeptide comprised in the compositions as disclosed herein and having one of these CDR sequence combinations is preferably such that it can specifically bind (as defined herein) to a pest target or a pest antigen, and more in particular such that it specifically binds to a target of a plant pathogen, in particular with dissociation constant (Kd) of 10⁻⁸ moles/liter or less of said polypeptide in solution.

Dissociation constants (Kd) can be estimated based on the results of an ELISA. In equilibrium analysis as in ELISA, the Kd can be calculated from the equilibrium binding response. Where the ELISA plate wells are coated with a target antigen, and where the target antigen may be a lipid-containing fraction of the membrane of Botrytis cinerea, such a method may further use a range of concentrations of a polypeptide binding the target antigen. Where the ELISA generally provides a quantitative adsorption measure for each polypeptide concentration representing binding of the polypeptide to the target antigen, the range of concentration of a polypeptide may for example be 0.5, 1, 2.5, 5, and 10 μM. The most suitable range of concentrations used can vary depending on the affinity of the polypeptide to the target antigen. The corresponding absorption values as determined by ELISA may result in a sigmoid curve when absorption values are plotted against the logarithmic conversion of the polypeptide concentrations. This sigmoid curve may serve to define an IC50 value. Where this IC50 is the concentration of polypeptide where the corresponding absorption value is 50% of the saturated value as estimated by the maximum of the sigmoidal function, the Kd can be estimated by 1/Ka were the association constant (Ka) can be estimated as 1/IC50. Thus Kd corresponds to the analyte concentration that reaches equilibrium at 50% binding saturation. Commonly computation methods can be used for these calculations. For example, this can be done using GraphPad. In some embodiments, the Kd may be determined by surface plasmon resonance (SPR).

The IC50 may be the IC50 for inhibition of spore germination and/or mycelial growth (i.e. the concentration (μM) that inhibits 50% of spore germination and/or mycelial growth) for example of Fusarium oxysporum and/or Botrytis cinerea. In some embodiments, the polypeptides have an IC50 of less than about 10 μM, for example less than about 1 μM for inhibition of spore germination and/or mycelial growth. In some embodiments, the cell wall degrading enzymes have an IC50 of less than about 10 μM, for example less than about 1 μM for inhibition of spore germination and/or mycelial growth. In a more preferred embodiment, the composition comprising at least one polypeptide and at least one cell wall degrading enzyme has an IC50 of less than about 10 μM, for example less than about 1 μM, or less than 0.1 μM, or even less than 0.01 μM for inhibition of spore germination and/or mycelial growth.

The Kd may be the Kd for binding to the lipid-containing fraction, which may be obtained as described elsewhere herein (i.e. by chromatographic methods, and may be the lipid-containing fraction from a fungus such as Fusarium oxysporum or Botrytis cinerea). The Kd of the polypeptides may be less than about 10 μM, for example less than about 1 μM. The Kd may be determined according to any suitable method. For example the Kd may be determined by bio-layer interferometry (BLI), for example on Octet. The assay used to determine the Kd may be an ELISA assay.

Specific binding of a polypeptide to a pest target can be determined in any suitable manner known per se, including, for example biopanning, Scatchard analysis and/or competitive binding assays, such as radioimmunoassays (RIA), enzyme immunoassays (EIA) and sandwich competition assays, and the different variants thereof known in the art.

In a preferred embodiment, the polypeptide, is obtained by affinity selection against a particular pest target molecule and said polypeptide has a high affinity for said pest target molecule: typically, the dissociation constant of the binding between the polypeptide and its pest target molecule is lower than 10⁻⁵ M, more preferably, the dissociation constant is lower than 10⁻⁶ M, even more preferably, the dissociation constant is lower than 10⁻⁷ M, most preferably, the dissociation constant is lower than 10⁻⁸ M.

In particular embodiments, the at least one polypeptide comprised in the compositions disclosed herein has a minimum inhibitory concentration (MIC) value for said plant pathogenic fungus of 1.0 μg/mL or less of said variable domain in solution.

Also disclosed herein are polypeptides of or a sub-range as disclosed herein before, obtained by affinity selection to a specific plant pest target, which is able to inhibit the growth and/or the activity of a crop pest at a minimum inhibitory concentration of from about 0.00001 to 1 μM. In specific embodiments the minimum inhibitory concentrations are between 0.0001 to 1 μM, between 0.001 to 1 μM, between 0.01 to 1 μM, between 0.1 to 1 μM, between 0.0001 to 0.1 μM, between 0.001 to 0.1 μM, between 0.01 to 0.1 μM, between 0.00001 to 0.01 μM, between 0.0001 to 0.01 μM, or between 0.001 to 0.01 μM. In other specific embodiments the minimum inhibitory concentrations are from about 0.0001 to about 1 μM, from about 0.001 to about 1 μM, from about 0.01 to about 1 μM, from about 0.1 to about 1 μM, from about 0.0001 to about 0.1 μM, from about 0.001 to about 0.1 μM, from about 0.01 to about 0.1 μM, from about 0.00001 to about 0.01 μM, from about 0.0001 to about 0.01 μM, or from about 0.001 to about 0.01 μM

The Minimal Inhibitory Concentration or the MIC value is the lowest concentration of an agent such as a polypeptide that inhibits the visible growth of the crop or plant pest after incubation. For example the minimum fungicidal concentration (MFC) is considered as the lowest concentration of polypeptide which prevents growth and reduces the fungal inoculum by at least 99.90% within 24 h. MFCs (Minimal Fungal Concentrations) can be determined on agar plates but can also be conveniently determined in fluids (e.g. in microwell plates) depending on the type of the fungus and the assay conditions.

In further particular embodiments, the compositions as disclosed herein at least comprise a polypeptide which comprises an amino acid sequence selected from the group consisting of SEQ ID NOs: 1, 2, 6, 10 or 14 to 99 or an amino acid sequence having at least about 80% sequence identify to either thereto (and which polypeptide is capable of binding to a fungus).

In particular embodiments, the polypeptides in the compositions as disclosed herein are heavy chain variable domains that comprises, consist or essentially consist of four framework regions (FR1 to FR4 respectively) and three complementarity determining regions (CDR1 to CDR3 respectively); or any suitable fragment of such a heavy chain variable domain (which will then usually contain at least some of the amino acid residues that form at least one of the CDRs, as further described herein). The sequences of the framework regions may be variable, or they may be specified.

The polypeptides as disclosed herein may in particular be an antibody, such as for instance a heavy chain antibody. In further particular embodiments, the polypeptides as disclosed herein may be a heavy chain variable domain sequence of an antibody that is derived from a conventional four-chain antibody (such as, without limitation, a V_{H} sequence that is derived from a human antibody) or be a so-called V_{HH}-sequence (as defined herein) that is derived from a so-called “heavy chain antibody” (as defined herein).

In particular embodiments, the compositions as disclosed herein, at least comprise a heavy chain variable domain sequence derived of an antibody or a functional fragment thereof, such as but not limited to a camelid heavy chain antibody or a functional fragment thereof, which variable domain sequence thus may be for instance a heavy chain variable domain of a camelid heavy chain antibody (VHH).

However, it should be noted that the invention is not limited as to the origin of the polypeptides comprised in the compositions disclosed herein (or of the nucleotide sequence of the invention used to express it), nor as to the way that the polypeptides or nucleotide sequences thereof is (or has been) generated or obtained. Thus, the polypeptides in the compositions disclosed herein may be naturally occurring polypeptides (from any suitable species) or synthetic or semi-synthetic polypeptides. In a specific but non-limiting embodiment of the invention, the polypeptide is a naturally occurring immunoglobulin sequence (from any suitable species) or a synthetic or semi-synthetic immunoglobulin sequence, including but not limited to “camelized” immunoglobulin sequences, as well as immunoglobulin sequences that have been obtained by techniques such as affinity maturation (for example, starting from synthetic, random or naturally occurring immunoglobulin sequences), CDR grafting, veneering, combining fragments derived from different immunoglobulin sequences, PCR assembly using overlapping primers, and similar techniques for engineering immunoglobulin sequences well known to the skilled person; or any suitable combination of any of the foregoing.

The polypeptide sequences of the compositions disclosed herein may in particular be a domain antibody (or an heavy chain variable domain that is suitable for use as a domain antibody), a single domain antibody (or an heavy chain variable domain that is suitable for use as a single domain antibody), or a “dAb” (or an heavy chain variable domain that is suitable for use as a dAb); other single variable domains, or any suitable fragment of any one thereof. For a general description of (single) domain antibodies, reference is also made to the prior art cited above, as well as to EP 0 368 684. For the term “dAb's”, reference is for example made to Ward et al. (Nature 1989 Oct. 12; 341 (6242): 544-6), to Holt et al., Trends Biotechnol., 2003, 21(11):484-490; as well as to for example WO 06/030220, WO 06/003388 and other published patent applications of Domantis Ltd.

Thus, in particular embodiments, the present invention provides compositions comprising polypeptides with the (general) structure
FR1-CDR1-FR2-CDR2-FR3-CDR3-FR4

in which FR1 to FR4 refer to framework regions 1 to 4, respectively, and in which CDR1 to CDR3 refer to the complementarity determining regions 1 to 3, respectively, and are as further defined herein.

In particular, the invention in some specific embodiments provides agrochemical compositions comprising at least one polypeptide that is directed against a pest target, such as a fungal target, and that has at least 70%, at least 75%, at least 80%, preferably at least 85%, such as at least 90% or at least 95% or at least 96%, at least 98%, at least 99% sequence identity or more sequence identity with at least one of the amino acid sequences of SEQ ID NOs: 1, 2, 6, 10 or 14 to 99), and nucleic acid sequences that encode such amino acid sequences.

Some particularly preferred polypeptide sequences as disclosed herein are those which can bind to and/or are directed against a pest, such as a fungus, and which have at least 90% (for example at least 95% or at least 97%) amino acid identity with at least one of the amino acid sequences of SEQ ID NOs: 1, 2, 6, 10 or 14 to 99 wherein any variation in sequence compared to the reference sequence (i.e. the specified SEQ ID NO sequence) occurs only in the CDR regions. Some particularly preferred polypeptide sequences as disclosed herein are those which can bind to and/or are directed against a pest, such as a fungus, and which have at least 90% (for example at least 95% or at least 97%, at least 98, at least 99%) amino acid identity with at least one of the amino acid sequences of SEQ ID NOs: 1, 2, 6, 10 or 14 to 99 wherein any variation in sequence compared to the reference sequence (i.e. specified SEQ ID NO sequence) occurs only in the framework regions. In other embodiments, variations in the sequence compared to the reference sequence (i.e. the specified SEQ ID NO sequence) may occur in the CDR regions and/or the framework regions. In some embodiments, variations in the sequence compared to the reference sequence (i.e. the specified SEQ ID NO sequence) may occur in the CDR3 region.

Again, such polypeptides may be derived in any suitable manner and from any suitable source, and may for example be naturally occurring V_{HH} sequences (i.e. from a suitable species of Camelid) or synthetic or semi-synthetic heavy chain variable domains, including but not limited to “camelized” immunoglobulin sequences (and in particular camelized heavy chain variable domain sequences), as well as those that have been obtained by techniques such as affinity maturation (for example, starting from synthetic, random or naturally occurring immunoglobulin sequences), CDR grafting, veneering, combining fragments derived from different immunoglobulin sequences, PCR assembly using overlapping primers, and similar techniques for engineering immunoglobulin sequences well known to the skilled person; or any suitable combination of any of the foregoing as further described herein.

The polypeptide disclosed herein generally bind to a plasma membrane components of a target. Preferably, the target is a fungus, fungal pest, pathogen fungus and/or plant pathogenic fungus. The compositions disclosed herein comprise a polypeptide as disclosed herein and a cell wall disrupting agent (as disclosed herein).

The cell wall disrupting agent comprised in the compositions disclosed herein can be naturally occurring agents, they can be derived from a naturally occurring agent, or alternatively they can be entirely artificially designed or synthesised.

The cell wall disrupting agent may disrupt the cell wall of the target. More specifically, the cell wall disrupting agent may disrupt the cell wall of a fungal target. Disrupting the cell wall may increase permeability of substances or compositions through the cell wall. In preferred embodiments, the cell wall disrupting agent disrupts the cell wall to allow the polypeptide to permeate through the cell wall. In some embodiments, the cell wall disrupting agent may allow increased quantities of polypeptide to permeate through the cell wall. In some embodiments, the cell wall disrupting agent may allow the polypeptide to permeate the cell wall faster. In some embodiments, the composition as disclosed herein has greater efficacy as a plant pest agent than either the cell wall disrupting agent or polypeptide alone. In some embodiments, the effect of the composition is synergistic compared to the cell wall disrupting agent and polypeptide alone at comparable concentrations. In some embodiments the effect of the composition is additive compared to the cell wall disrupting agent and polypeptide alone at comparable concentrations. In some embodiments the IC50 of the polypeptide in the composition as disclosed herein is reduced compared to the polypeptide alone, or compared to when the polypeptide is in a composition that does not contain a cell wall disrupting agent. The reduction in the IC50 may be at least 2-fold, at least 5-fold, at least 10-fold, at least 100-fold, or greater, compared to the polypeptide used alone, or compared to a composition comprising the polypeptide that does not contain a cell wall disrupting agent.

In some embodiments the IC50 of the cell wall disrupting agent in the composition as disclosed herein is reduced compared to the cell wall disrupting agent alone, or compared to when the cell wall disrupting agent is in a composition that does not contain a polypeptide. The reduction in the IC50 may be at least 2-fold, at least 5-fold, at least 10-fold, at least 100-fold, or greater, compared to the cell wall disrupting agent used alone, or compared to a composition comprising the cell wall disrupting agent that does not contain a polypeptide.

In some embodiments the IC50 of both the cell wall disrupting agent and the polypeptide in the composition as disclosed herein is reduced compared to the cell wall disrupting agent or polypeptide alone, or compared to when the cell wall disrupting agent or polypeptide is in a composition that does not contain a polypeptide or cell wall disrupting agent respectively. In other words, the IC50 of the composition may be reduced compared to the IC50 of a composition comprising only one of the cell wall disrupting agent and the polypeptide. The reduction in the IC50 may be at least 2-fold, at least 5-fold, at least 10-fold, at least 100-fold, or greater, compared to the cell wall disrupting agent or polypeptide used alone, or compared to a composition comprising the polypeptide or the cell wall disrupting agent that does not respectively contain a cell wall disrupting agent or polypeptide.

It is understood that the compositions or the biological control compositions as disclosed herein are stable, both during storage and during utilization, meaning that the integrity of the agrochemical composition is maintained under storage and/or utilization conditions of the agrochemical composition, which may include elevated temperatures, freeze-thaw cycles, changes in pH or in ionic strength, UV-irradiation, presence of harmful chemicals and the like. More preferably, the polypeptide, and the cell wall disrupting agent remain stable in the agrochemical composition, meaning that the integrity and the pesticidal activity of the substances is maintained under storage and/or utilization conditions of the agrochemical composition, which may include elevated temperatures, freeze-thaw cycles, changes in pH or in ionic strength, UV-irradiation, presence of harmful chemicals and the like. Most preferably, said polypeptide, and the cell wall disrupting agent, remain stable in the agrochemical composition when the agrochemical composition is stored at ambient temperature for a period of two years. Preferably, the agrochemical composition of the present invention retains at least about 70% activity, more preferably at least about 80% activity, most preferably at least about 90% activity or more. Optionally, the polypeptide and/or the cell wall disrupting agent may be comprised in a carrier, as defined, to protect the substances from harmful effects caused by other components in the agrochemical composition or from harmful effects during storage or during application. Examples of suitable carriers include, but are not limited to alginates, gums, starch, β-cyclodextrins, celluloses, polyurea, polyurethane, polyester, microbial cells or clay.

The agrochemical composition may occur in any type of formulation, preferred formulations are powders, wettable powders, wettable granules, water dispersible granules, emulsions, emulsifiable concentrates, dusts, suspensions, suspension concentrates, suspoemulsions (mixtures of suspensions and emulsions), capsule suspensions, aqueous dispersions, oil dispersions, aerosols, pastes, foams, slurries or flowable concentrates.

The polypeptide and/or cell wall disrupting agent, may be the only active substances in the agrochemical or biological control composition according to the invention, however, it is also possible that the composition comprises one or more additional agrochemicals, as defined, in addition to the polypeptide and cell wall disrupting agent. Such additional agrochemicals or biological control compositions may have a different effect on plant pests as the polypeptide or cell wall disrupting agent, they may have a synergistic effect with the polypeptide or and cell wall disrupting agent, or they may even modify the activity of the polypeptide or cell wall disrupting agent on certain plants.

Suitable additional agrochemicals can be herbicides, insecticides, fungicides, nematicides, acaricides, bactericides, viricides, plant growth regulators, safeners and the like. Such agrochemicals may be chemicals or may be biological substances, for example a microbial. They include, but are not limited to glyphosate, paraquat, metolachlor, acetochlor, mesotrione, 2,4-D,atrazine, glufosinate, sulfosate, fenoxaprop, pendimethalin, picloram, trifluralin, bromoxynil, clodinafop, fluroxypyr, nicosulfuron, bensulfuron, imazetapyr, dicamba, imidacloprid, thiamethoxam, fipronil, chlorpyrifos, deltamethrin, lambda-cyhalotrin, endosulfan, methamidophos, carbofuran, clothianidin, cypermethrin, abamectin, diflufenican, spinosad, indoxacarb, bifenthrin, tefluthrin, azoxystrobin, thiamethoxam, tebuconazole, mancozeb, cyazofamid, fluazinam, pyraclostrobin, epoxiconazole, chlorothalonil, copper fungicides (for example copper oxychloride, copper hydroxide), trifloxystrobin, prothioconazole, difenoconazole, carbendazim, propiconazole, thiophanate, sulphur, boscalid, tricyclazole, hexaconazole, metalaxyl, benomyl, kitazin, tebuconazole, tridemorph, propineb, streptornycin sulfate and oxytetracycline and other known agrochemicals or any suitable combination(s) thereof.

Suitable additional agrochemicals may be a biological substance, such as a microbial, for example a Pseudomonas strain, a Bacillus strain or a Streptomyces strain.

In some embodiments, the composition disclosed herein, when applied to a fungus or to a plant or part of a plant comprising or infected by a fungus, the cell wall disrupting agent disrupts the cell wall of said fungus.

### Targets

In particular embodiments, the polypeptides comprised in the compositions disclosed herein are obtained by affinity selection against a particular pest target such as a fungal antigen or a fungal target. Obtaining suitable polypeptides by affinity selection against a particular pest target may for example be performed by screening a set, collection or library of cells that express polypeptides on their surface (e.g. bacteriophages) for binding against a pest target molecule, which molecule is known in the art to be a target for a pesticide; all of which may be performed in a manner known per se, essentially comprising the following non-limiting steps: a) obtaining an isolated solution or suspension of a pest target molecule, which molecule is known to be a target for a pesticide; b) bio-panning phages or other cells from a polypeptide library against said target molecule; c) isolating the phages or other cells binding to the target molecule; d) determining the nucleotide sequence encoding the polypeptide insert from individual binding phages or other cells; e) producing an amount of polypeptide according to this sequence using recombinant protein expression and f) determining the affinity of said polypeptide for said pest target and optionally g) testing the pesticidal activity of said polypeptide in a bio-assay for said pest. Various methods may be used to determine the affinity between the polypeptide and the pest target molecule, including for example, enzyme linked immunosorbent assays (ELISA) or Surface Plasmon Resonance (SPR) assays, which are common practice in the art, for example, as described in Sambrook et al. (2001), Molecular Cloning, A Laboratory Manual. Third Edition. Cold Spring Harbor Laboratory Press, Cold Spring Harbor, NY. The dissociation constant is commonly used to describe the affinity between a polypeptide and its pest target molecule. Typically, the dissociation constant of the binding between the polypeptide and its pest target molecule is lower than 10⁻⁵ M, more preferably, the dissociation constant is lower than 10⁻⁶ M, even more preferably, the dissociation constant is lower than 10⁻⁷ M, most preferably, the dissociation constant is lower than 10⁻⁸ M.

Pest target molecules as disclosed herein are molecules occurring in or on pest organisms and which, when bound and/or inhibited, kill or arrest, inhibit or reduce the growth or pesticidal activity of said pest organism. Such suitable target molecules are readily available from existing literature or patent databases for the skilled person and include, without limitation secreted parasitism proteins such as 16D10 as suitable pest target molecules for root knot nematodes (Huang et al (2006) PNAS 103: 14302-14306), the V-ATPase proton pump as suitable pest target molecule for coleopteran, hemipteran, dipteran insect species and nematodes (Knight A J and Behm C A (2011) Ex. Parasitol. September 19), the tetraspanin PLS1 as suitable fungal pest target molecule for B. cinerea and M. grisea (Gourgues et al (2002) Biochem. Biophys. Res. Commun. 297: 1197) or the proton-pumping-ATPase as antifungal target (Manavathu E K et al (1999) Antimicrob Agents and Chemotherapy, December p. 2950). It is understood that preferred pest target molecules are accessible in the extra-cellular space (as opposed to intracellular pest targets).

More particularly, a pest target to which the at least one polypeptide of the agrochemical compositions as disclosed herein bind, may be a plasma membrane component of a pest. A plasma membrane component of a pest as used herein may be any component comprised in or being part of (i.e. at least a part of which is associated with, present in, connected to or bound to) the plasma membrane phospholipid bilayer or any of the proteins embedded therein of a cell of the pest. In particular embodiments, a plasma membrane component of a pest may be a phospholipid, a glycoprotein, a carbohydrate or cholesterol.

In particular embodiments, the plasma membrane component of a pest to which the at least one polypeptide in the compositions disclosed herein specifically binds is not a protein.

Thus, in particular embodiments, the plasma membrane component of a pest to which the at least one polypeptide in the compositions disclosed herein specifically bind is a lipid, such as for instance a phospholipid, a carbohydrate or cholesterol.

In certain particular embodiments, the target to which the polypeptides in the agrochemical compositions of the present invention bind is not a cell wall component.

In certain specific embodiments, the target to which the polypeptides in the agrochemical compositions of the present invention bind is not chitin.

In a preferred embodiment, the plant pest(s) that is/are combated by the agrochemical composition or biological control composition as disclosed herein is a fungus, such as a plant pathogenic fungus, as defined before. Fungi can be highly detrimental for plants and can cause substantial harvest losses in crops. Plant pathogenic fungi include necrotrophic fungi and biotrophic fungi, and include ascomycetes, basidiomycetes and oomycetes.

Examples of plant pathogenic fungi are known in the art and include, but are not limited to, those selected from the group consisting of the Genera: Alternaria; Ascochyta; Botrytis; Cercospora; Colletotrichum; Diplodia; Erysiphe; Fusarium; Leptosphaeria; Gaeumanomyces; Helminthosporium; Macrophomina; Nectria; Oidium, Peronospora; Phakopsora; Phoma; Phymatotrichum; Phytophthora; Plasmopara; Podosphaera; Puccinia; Puthium; Pyrenophora; Pyricularia; Pythium; Rhizoctonia; Scerotium; Sclerotinia; Septoria; Thielaviopsis; Uncinula; Venturia; and Verticillium. Specific examples of plant fungi infections which may be combated with the agrochemical compositions of the invention include, powdery mildew and Botrytis cinerea in fruit and vegetable crops such as grapes and strawberries. Additional specific examples of plant fungi infections which may be combated with the agrochemical compositions of the invention include Erysiphe graminis in cereals, Erysiphe cichoracearum and Sphaerotheca fuliginea in cucurbits, Podosphaera leucotricha in apples, Podosphaera aphanis, for example to treat powdery mildew, for example on strawberry, Podosphaera xanthii, for example to treat powdery mildew, for example on cucumber, Oidium neolycopersici, for example to treat powdery mildew, for example on tomatoes, Uncinula necator in vines, Puccinia sp. in cereals, Rhizoctonia sp. in cotton, potatoes, rice and lawns, Ustilago sp. in cereals and sugarcane, Venturia inaequalis (scab) in apples, Helminthosporium sp. in cereals, Septoria nodorum in wheat, Septoria tritici in wheat, Rhynchosporium secalis on barley, Botrytis cinerea (gray mold) in strawberries, tomatoes and grapes, Cercospora arachidicola in groundnuts, Peronospora tabacina in tobacco, or other Peronospora in various crops, Pseudocercosporella herpotrichoides in wheat and barley, Pyrenophera teres in barley, Pyricularia oryzae in rice, Phytophthora infestans in potatoes and tomatoes, Fusarium sp. (such as Fusarium oxysporum) and Verticillium sp. in various plants, Plasmopara viticola in grapes, Alternaria sp. in fruit and vegetables, Pseudoperonospora cubensis in cucumbers, Mycosphaerella fijiensis in banana, Ascochyta sp. in chickpeas, Leptosphaeria sp. on canola, Phakopsora spp., such as Phakopsora pachyrhizi, and Colleotrichum sp. in various crops, for example Colletotrichum orbiculare which may cause anthracnose in squash. The compositions according to the invention are active against normally sensitive and resistant species and against all or some stages in the life cycle of the plant pathogenic fungus.

In particular embodiments, the agrochemical compositions as disclosed herein are directed against a plant pathogenic fungus from the genus chosen from the group comprising Alternaria, Ascochyta, Botrytis, Cercospora, Colletotrichum, Diplodia, Erysiphe, Fusarium, Leptosphaeria, Gaeumanomyces, Helminthosporium, Macrophomina, Nectria, Oidium, Penicillium, Peronospora, Phoma, Phymatotrichum, Phytophthora, Plasmopara, Podosphaera, Puccinia, Pyrenophora, Pyricularia, Pythium, Rhizoctonia, Scerotium, Sclerotinia, Septoria, Thielaviopsis, Uncinula, Venturia, Verticillium, Magnaporthe, Blumeria, Mycosphaerella, Ustilago, Melampsora, Phakopsora, Monilinia, Mucor, Rhizopus, and Aspergillus.

In a more specific embodiment, the agrochemical compositions as disclosed herein are directed against a plant pathogenic fungus according to the species chosen from the group comprising Alternaria alternata, Alternaria aroborescens, Alternaria solani, Botrytis cinerea, Cercospora beticola Colletotrichum orbiculare, Colletotrichum gloeosporioides, Colletotrichum lindemuthianum, Colletotrichum coccodes, Colletotrichum Musea, Colletotrichum Fruticola, Fusarium graminearum, Fusarium culmorum, Fusarium oxysporum, Penicillium digitatum, Penicillium Italicum, Phakopsora pachvrhizi, Uncinula necator, Oidium Neolycopersici, Podosphaera aphanis and Podosphaera xanthii.

In certain embodiments, the polypeptides disclosed herein are capable of binding to a plant pathogenic fungus from the genus of one or more or all of Botrytis, Colletotrichum, Podosphaera and Alternaria.

In certain embodiments, the polypeptides disclosed herein are capable of binding to a plant pathogenic fungus from the species of one or more or all of Botrytis cinerea, Colletotrichum goeosporioides, Podosphaera xanthii and Alternaria alternata.

In certain particular embodiments, the compositions as disclosed herein at least comprise a polypeptide, which specifically binds to a target of a fungus from the fungal species Botrytis, Fusarium or Penicillium, such as a plasma membrane component of a fungus.

In particular embodiments, the present invention provides agrochemical compositions comprising polypeptides that are specifically directed against a structural molecular component of the plasma cell membrane of a pest.

In particular embodiments, the present invention provides agrochemical compositions comprising polypeptides that are specifically directed against a structural molecular component of the plasma cell membrane of a pest, which is not a protein.

In yet another particular embodiment plant pests are plant pathogenic bacteria including, but not limited to, Acidovorax avenae subsp. avenae (causing bacterial brown stripe of rice), Acidovorax avenae subsp. cattleyae (causing bacterial brown spot of cattleya), Acidovorax konjaci Konnyaku (causing bacterial leaf blight), Agrobacterium rhizogenes (causing hairy root of melon), Agrobacterium tumefaciens (causing crown gall), Burkholderia andropogonis (causing bacterial spot of carnation), Burkholderia caryophylli (causing bacterial wilt of carnation), Burkholderia cepacia (causing bacterial brown spot of cymbidium), Burkholderia gladioli pv. gladioli (causing neck rot of gladiolus), Burkholderia glumae (causing bacterial grain rot of rice), Burkholderia plantarii (causing bacterial seedling blight of rice), Clavibacter michiganensis subsp. michiganensis (causing bacterial canker of tomato), Clavibacter michiganensis subsp. sepedonicus (causing ring rot of potato), Clostridium spp. (causing slimy rot of potato), Curtobacterium flaccumfaciens (causing bacterial canker of onion), Erwinia amylovora (causing fire blight of pear), Erwinia ananas (causing bacterial palea browning of rice), Erwinia carotovora subsp. atroseptica (causing black leg of potato), Erwinia carotovora subsp. carotovora (causing bacterial soft rot of vegetables), Erwinia chrysanthemi (causing bacterial seedling blight of taro), Erwinia chrysanthemi pv. zeae (causing bacterial foot rot of rice), Erwinia herbicola pv. millettiae (causing bacterial gall of wisteria), Pseudomonas cichorii (causing bacterial spot of chrysanthemum), Pseudomonas corrugate Pith (causing necrosis of tomato), Pseudomonas fuscovaginae (causing sheath brown rot of rice), Pseudomonas marginalis pv. marginalis (causing soft rot of cabbage) Pseudomonas rubrisubalbicans (causing mottled stripe of sugar cane), Pseudomonas syringae pv. aptata (causing bacterial blight of sugar beet), Pseudomonas syringae pv. atropurpurea (causing halo blight of ryegrass), Pseudomonas syringae pv. castaneae (causing bacterial canker of chestnut), Pseudomonas syringae pv. glycinea (causing bacterial blight of soybean), Pseudomonas syringae pv. lachrymans (causing bacterial spot of cucumber), Pseudomonas syringae pv. maculicola (causing bacterial black spot of cabbage), Pseudomonas syringae pv. mori (causing bacterial blight of mulberry), Pseudomonas syringae pv. morsprunorum (causing bacterial canker of plums), Pseudomonas syringae pv. oryzae (causing halo blight of rice), Pseudomonas syringae pv. phaseolicola (causing halo blight of kidney bean), Pseudomonas syringae pv. pisi (causing bacterial blight of garden pea), Pseudomonas syringae pv. sesame (causing bacterial spot of sesame), Pseudomonas syringae pv. striafaciens (causing bacterial stripe blight of oats), Pseudomonas syringae pv. syringae (causing bacterial brown spot of small red bead), Pseudomonas syringae pv. tabaci (causing wild fire of tobacco), Pseudomonas syringae pv. theae (causing bacterial shoot blight of tea), Pseudomonas syringae pv. tomato (causing bacterial leaf spot of tomato), Pseudomonas viridiflava (causing bacterial brown spot of kidney bean), Ralstonia solanacearum (causing bacterial wilt), Rathayibacter rathayi (causing bacterial head blight of orchardgrass), Streptomyces scabies (causing common scab of potato), Streptomyces ipomoea (causing soil rot of sweet potato), Xanthomonas albilineans (causing white streak of sugar cane), Xanthomonas campestris pv. cerealis (causing bacterial streak of rye), Xanthomonas campestris pv. campestris (causing black rot), Xanthomonas campestris pv. citri (causing canker of citrus), Xanthomonas campestris pv. cucurbitae (causing bacterial brown spot of cucumber), Xanthomonas campestris pv. glycines (causing bacterial pastule of soybean), Xanthomonas campestris pv. incanae (causing black rot of stock), Xanthomonas campestris pv. (causing angular leaf spot of cotton malvacearum), Xanthomonas campestris pv. (causing bacterial canker of mango), Mangiferaeindicae Xanthomonas campestris pv. mellea (causing wisconsin bacterial leaf spot of tobacco), Xanthomonas campestris pv. (causing bacterial spot of great nigromaculans burdock), Xanthomonas campestris pv. phaseoli (causing bacterial pastule of kidney bean), Xanthomonas campestris pv. pisi (causing bacterial stem-rot of kidney bean), Xanthomonas campestris pv. pruni (causing bacterial shot hole of peach), Xanthomonas campestris pv. raphani (causing bacterial spot of Japanese radish), Xanthomonas campestris pv. ricini (causing bacterial spot of castor-oil plant), Xanthomonas campestris pv. theicola (causing canker of tea), Xanthomonas campestris pv. translucens (causing bacterial blight of orchardgrass), Xanthomonas campestris pv. vesicatoria (causing bacterial spot of tomato), Xanthomonas oryzae pv. oryzae (causing bacterial leaf blight of rice).

In yet another embodiment the agrochemical formulations of the invention can also be used to combat plant pests such as bacteria, insects, arachnids, helminths, viruses, nematodes and molluscs encountered in agriculture, in horticulture, in forests, in gardens and in leisure facilities. The compositions according to the invention are active against normally sensitive and resistant species and against all or some stages of development. These plant pests include: pests from the phylum: Arthropoda, in particular from the class of the arachnids, for example Acarus spp., Aceria sheldoni, Aculops spp., Aculus spp., Amblyomma spp., Amphitetranychus viennensis, Argas spp., Boophilus spp., Brevipalpus spp., Bryobia praetiosa, Centruroides spp., Chorioptes spp., Dermanyssus gallinae, Dermatophagoides pteronyssius, Dermatophagoides farinae, Dermacentor spp., Eotetranychus spp., Epitrimerus pyri, Eutetranychus spp., Eriophyes spp., Halotydeus destructor, Hemitarsonemus spp., Hyalomma spp., Ixodes spp., Latrodectus spp., Loxosceles spp., Metatetranychus spp., Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vaejovis spp., Vasates lycopersici.

Still other examples are from the order of the Anoplura (Phthiraptera), for example, Damalinia spp., Haematopinus spp., Linognathus spp., Pediculus spp., Ptirus pubis, Trichodectes spp.

Still other examples are from the order of the Chilopoda, for example, Geophilus spp., Scutigera spp.

Still other examples are from the order of the Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllotreta spp., Popillia japonica, Premnotrypes spp., Prostephanus truncatus, Psylliodes spp., Ptinus spp., Rhizobius ventralis, Rhizopertha dominica, Sitophilus spp., Sphenophorus spp., Stegobium paniceum, Sternechus spp., Symphyletes spp., Tanymecus spp., Tenebrio molitor, Tribolium spp., Trogoderma spp., Tychius spp., Xylotrechus spp., Zabrus spp.

Still other examples are from the order of the Collembola, for example, Onychiurus armatus.

Still other examples are from the order of the Diplopoda, for example, Blaniulus guttulatus.

Still other examples are from the order of the Diptera, for example, Aedes spp., Agromyza spp., Anastrepha spp., Anopheles spp., Asphondylia spp., Bactrocera spp., Bibio hortulanus, Calliphora erythrocephala, Ceratitis capitata, Chironomus spp., Chrysomyia spp., Chrysops spp., Cochliomyia spp., Contarinia spp., Cordylobia anthropophaga, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hylemyia spp., Hyppobosca spp., Hypoderma spp., Liriomyza spp., Lucilia spp., Lutzomia spp., Mansonia spp., Musca spp., Nezara spp., Oestrus spp., Oscinella frit, Pegomyia spp., Phlebotomus spp., Phorbia spp., Phormia spp., Prodiplosis spp., Psila rosae, Rhagoletis spp., Sarcophaga spp., Simulium spp., Stomoxys spp., Tabanus spp., Tannia spp., Tetanops spp., Tipula spp.

Still other examples are from the order of the Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

Still other examples are from the order of the Homoptera, for example, Acyrthosipon spp., Acrogonia spp., Aeneolamia spp., Agonoscena spp., Aleurodes spp., Aleurolobus barodensis, Aleurothrixus spp., Amrasca spp., Anuraphis cardui, Aonidiella spp., Aphanostigma pin, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp, Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

Still other examples are from the order of the Hymenoptera, for example, Acromyrmex spp., Athalia spp., Atta spp., Diprion spp., Hoplocampa spp., Lasius spp., Monomorium pharaonis, Solenopsis invicta, Tapinoma spp., Vespa spp.

Still other examples are from the order of the Isopoda, for example, Armadillidium vulgare, Oniscus asellus, Porcellio scaber.

Still other examples are from the order of the Isoptera, for example, Coptotermes spp., Cornitermes cumulans, Cryptotermes spp., Incisitermes spp., Microtermes obesi, Odontotermes spp., Reticulitermes spp.

Still other examples are from the order of the Lepidoptera, for example, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Chematobia brumata, Chilo spp., Choristoneura spp., Clysia ambiguella, Cnaphalocerus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tecia solanivora, Thermesia gemmatalis, Tinea pellionella, Tineola bisselliella, Tortrix spp., Trichophaga tapetzella, Trichoplusia spp., Tuta absoluta, Virachola spp.

Still other examples are from the order of the Orthoptera, for example, Acheta domesticus, Blatta orientalis, Blattella germanica, Dichroplus spp., Gryllotalpa spp., Leucophaea maderae, Locusta spp., Melanoplus spp., Periplaneta spp., Pulex irritans, Schistocerca gregaria, Supella longipalpa.

Still other examples are from the order of the Siphonaptera, for example, Ceratophyllus spp., Ctenocephalides spp., Tunga penetrans, Xenopsylla cheopis.

Still other examples are from the order of the Symphyla, for example, Scutigerella spp.

Still other examples are from the order of the Thysanoptera, for example, Anaphothrips obscurus, Baliothrips biformis, Drepanothris reuteri, Enneothrips flavens, Frankliniella spp., Heliothrips spp., Hercinothrips femoralis, Rhipiphorothrips cruentatus, Scirtothrips spp., Taeniothrips cardamoni, Thrips spp.

Still other examples are from the order of the Zygentoma (=Thysanura), for example, Lepisma saccharina, Thermobia domestica. for example Lepisma saccharina, Thermobia domestica.

In another embodiment pests of the phylum Mollusca, in particular from the class of the Bivalvia, for example Dreissena spp. are also important plant pests.

In another embodiment pests of the class of the Gastropoda are important plant pests, for example, Anion spp., Biomphalaria spp., Bulinus spp., Deroceras spp., Galba spp., Lymnaea spp., Oncomelania spp., Pomacea spp., Succinea spp.

In yet another embodiment plant pests are from the phylum Nematoda are important plant pests, i.e. phytoparasitic nematodes, thus meaning plant parasitic nematodes that cause damage to plants. Plant nematodes encompass plant parasitic nematodes and nematodes living in the soil. Plant parasitic nematodes include, but are not limited to, ectoparasites such as Xiphinema spp., Longidorus spp., and Trichodorus spp.; semiparasites such as Tylenchulus spp.; migratory endoparasites such as Pratylenchus spp., Radopholus spp., and Scutellonerna. spp.; sedentary parasites such as Heterodera spp., Globodera spp., and Meloidogyne spp., and stem and leaf endoparasites such as Ditylenchus spp., Aphelenchoides spp., and Hirshmaniella spp. In addition, harmful root parasitic soil nematodes are cyst-forming nematodes of the genera Heterodera or Globodera, and/or root knot nematodes of the genus Meloidogyne. Harmful species of these genera are for example Meloidogyne incognata, Heterodera glycines (soybean cyst nematode), Globodera pallida and Globodera rostochiensis (potato cyst nematode). Still other important genera of importance as plant pests comprise Rotylenchulus spp., Paratriclodorus spp., Pratylenchus penetrans, Radolophus simuli, Ditylenchus dispaci, Tylenchulus semipenetrans, Xiphinema spp., Bursaphelenchus spp., and the like. in particular Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

In some embodiments the polypeptides of the composition target a plasma membrane component. In preferred embodiments, the cell wall disrupting agents described herein aid the polypeptide in reaching the plasma membrane. In some embodiments, the cell wall disrupting agents affects the integrity of the cell wall, and allows the polypeptides of the composition to permeate through to the plasma membrane.

In some embodiments, the cell wall disrupting agents target components of the fungal cell wall. In some embodiments the cell wall disrupting agent is an enzyme, preferably a cell wall degrading enzyme. The enzyme may target chitin in the fungal cell wall. The enzyme may therefore have chitinolytic activity. The enzyme may be an exo-chitinase or an endo-chitinase. The enzyme may target glucans in the cell wall. The enzyme may have exo-glucanases or endo-glucanases activity. In some embodiments, the composition disclosed herein contains at least one, at least two, at least three, at least four cell wall disrupting agents. In some embodiment's, the composition comprises a chitinase and/or a glucanases. The inventors specifically contemplate the combination of any polypeptide disclosed herein with any cell wall disrupting agent disclosed herein.

### Forms of Target Antigen

It will be appreciated based on the disclosure herein that for agrochemical and biological control applications, the polypeptides of the compositions as disclosed herein may be directed against or specifically bind to several different forms of the pest target, for example a fungal target.

It is also expected that the polypeptides of the compositions as disclosed herein will bind to a number of naturally occurring or synthetic analogues, variants, mutants, alleles, parts and fragments of their pest target. More particularly, it is expected that the polypeptides of the compositions as disclosed herein will bind to at least to those analogues, variants, mutants, alleles, parts and fragments of the target that (still) contain the binding site, part or domain of the natural target to which those polypeptides bind. In preferred embodiments the polypeptides of the invention bind a fungal plasma membrane component.

### Formulations

It is envisaged that the polypeptide and/or cell wall disrupting agent content contained in the composition as disclosed herein may vary within a wide range and it is generally up to the manufacturer to modify the concentration range of particular active substances according to specific crop pest which is to be attenuated.

The composition of the invention may be formulated into any type of formulation, preferred formulations are powders, wettable powders, wettable granules, water dispersible granules, emulsions, emulsifiable concentrates, dusts, suspensions, suspension concentrates, suspoemulsions (mixtures of suspensions and emulsions), capsule suspensions, aqueous dispersions, oil dispersions, aerosols, pastes, foams, slurries or flowable concentrates.

In particular embodiments, the present invention provides agrochemical compositions comprising at least one polypeptide and at least one cell wall disrupting agent. The polypide and/or cell wall disrupting agent are present in an amount effective to protect or treat a plant or a part of said plant from an infection or other biological interaction with said plant pathogen.

In a specific embodiment the concentration of the polypeptide contained in the agrochemical composition may be at least 0.0001% by weight.

In a specific embodiment the concentration of the polypeptide contained in the agrochemical composition may be up to 50% by weight.

In a specific embodiment the concentration of the polypeptide contained in the agrochemical composition may be from 0.0001% to 50% by weight.

In particular embodiments, the present invention provides agrochemical compositions comprising at least one polypeptide, wherein the concentration of the at least one polypeptide in the agrochemical composition ranges from 0.001% to 50% by weight.

In yet another specific embodiment the concentration of the polypeptide contained in the agrochemical composition may be from 0.001% to 50% by weight. In yet another specific embodiment the concentration of the polypeptide contained in the agrochemical composition may be from 0.01% to 50% by weight. In yet another specific embodiment the concentration of the polypeptide contained in the agrochemical composition may be from 0.1% to 50% by weight.

In yet another specific embodiment the concentration of the polypeptide contained in the agrochemical composition may be from 1% to 50% by weight. In yet another specific embodiment the concentration of the polypeptide contained in the agrochemical composition may be from 10% to 50% by weight. In yet another specific embodiment the concentration of the polypeptide contained in the agrochemical composition may be from 0.0001% to 40% by weight. In yet another specific embodiment the concentration of the polypeptide contained in the agrochemical composition may be from 0.001% to 40% by weight. In yet another specific embodiment the concentration of the polypeptide contained in the agrochemical composition may be from 0.01% to 40% by weight. In yet another specific embodiment the concentration of the polypeptide contained in the agrochemical composition may be from 0.1% to 40% by weight. In yet another specific embodiment the concentration of the polypeptide contained in the agrochemical composition may be from 1% to 40% by weight. In yet another specific embodiment the concentration of the polypeptide contained in the agrochemical composition may be from 0.0001% to 30% by weight. In yet another specific embodiment the concentration of the polypeptide contained in the agrochemical composition may be from 0.001% to 30% by weight. In yet another specific embodiment the concentration of the polypeptide contained in the agrochemical composition may be from 0.01% to 30% by weight. In yet another specific embodiment the concentration of the polypeptide contained in the agrochemical composition may be from 0.1% to 30% by weight. In yet another specific embodiment the concentration of the polypeptide contained in the agrochemical composition may be from 1% to 30% by weight. In yet another specific embodiment the concentration of the polypeptide contained in the agrochemical composition may be from 0.0001% to 10% by weight. In yet another specific embodiment the concentration of the polypeptide contained in the agrochemical composition may be from 0.001% to 10% by weight. In yet another specific embodiment the concentration of the polypeptide contained in the agrochemical composition may be from 0.01% to 10% by weight. In yet another specific embodiment the concentration of the polypeptide contained in the agrochemical composition may be from 0.1% to 10% by weight. In yet another specific embodiment the concentration of the polypeptide contained in the agrochemical composition may be from 1% to 10% by weight. In yet another specific embodiment the concentration of the polypeptide contained in the agrochemical composition may be from 0.0001% to 1% by weight. In yet another specific embodiment the concentration of the polypeptide contained in the agrochemical composition may be from 0.001% to 1% by weight. In yet another specific embodiment the concentration of the polypeptide contained in the agrochemical composition may be from 0.01% to 1% by weight. In yet another specific embodiment the concentration of the polypeptide contained in the agrochemical composition may be from 0.1% to 1% by weight.

In a specific embodiment the concentration of the cell wall disrupting agent contained in the agrochemical composition may be at least 0.0001% by weight.

In a specific embodiment the concentration of the cell wall disrupting agent contained in the agrochemical composition may be up to 50% by weight.

In a specific embodiment the concentration of the cell wall disrupting agent contained in the agrochemical composition may be from 0.0001% to 50% by weight.

In particular embodiments, the present invention provides agrochemical compositions comprising at least one cell wall disrupting agent, wherein the concentration of the at least one cell wall disrupting agent in the agrochemical composition ranges from 0.001% to 50% by weight.

In yet another specific embodiment the concentration of the cell wall disrupting agent contained in the agrochemical composition may be from 0.001% to 50% by weight. In yet another specific embodiment the concentration of the cell wall disrupting agent contained in the agrochemical composition may be from 0.01% to 50% by weight. In yet another specific embodiment the concentration of the cell wall disrupting agent contained in the agrochemical composition may be from 0.1% to 50% by weight.

In yet another specific embodiment the concentration of the cell wall disrupting agent contained in the agrochemical composition may be from 1% to 50% by weight. In yet another specific embodiment the concentration of the cell wall disrupting agent contained in the agrochemical composition may be from 10% to 50% by weight. In yet another specific embodiment the concentration of the cell wall disrupting agent contained in the agrochemical composition may be from 0.0001% to 40% by weight. In yet another specific embodiment the concentration of the cell wall disrupting agent contained in the agrochemical composition may be from 0.001% to 40% by weight. In yet another specific embodiment the concentration of the cell wall disrupting agent contained in the agrochemical composition may be from 0.01% to 40% by weight. In yet another specific embodiment the concentration of the cell wall disrupting agent contained in the agrochemical composition may be from 0.1% to 40% by weight. In yet another specific embodiment the concentration of the cell wall disrupting agent contained in the agrochemical composition may be from 1% to 40% by weight. In yet another specific embodiment the concentration of the cell wall disrupting agent contained in the agrochemical composition may be from 0.0001% to 30% by weight. In yet another specific embodiment the concentration of the cell wall disrupting agent contained in the agrochemical composition may be from 0.001% to 30% by weight. In yet another specific embodiment the concentration of the cell wall disrupting agent contained in the agrochemical composition may be from 0.01% to 30% by weight. In yet another specific embodiment the concentration of the cell wall disrupting agent contained in the agrochemical composition may be from 0.1% to 30% by weight. In yet another specific embodiment the concentration of the cell wall disrupting agent contained in the agrochemical composition may be from 1% to 30% by weight. In yet another specific embodiment the concentration of the cell wall disrupting agent contained in the agrochemical composition may be from 0.0001% to 10% by weight. In yet another specific embodiment the concentration of the cell wall disrupting agent contained in the agrochemical composition may be from 0.001% to 10% by weight. In yet another specific embodiment the concentration of the cell wall disrupting agent contained in the agrochemical composition may be from 0.01% to 10% by weight. In yet another specific embodiment the concentration of the cell wall disrupting agent contained in the agrochemical composition may be from 0.1% to 10% by weight. In yet another specific embodiment the concentration of the cell wall disrupting agent contained in the agrochemical composition may be from 1% to 10% by weight. In yet another specific embodiment the concentration of the cell wall disrupting agent contained in the agrochemical composition may be from 0.0001% to 1% by weight In yet another specific embodiment the concentration of the cell wall disrupting agent contained in the agrochemical composition may be from 0.001% to 1% by weight. In yet another specific embodiment the concentration of the cell wall disrupting agent contained in the agrochemical composition may be from 0.01% to 1% by weight. In yet another specific embodiment the concentration of the cell wall disrupting agent contained in the agrochemical composition may be from 0.1% to 1% by weight.

In a preferred embodiment the total concentration of both the polypeptide (such as the VHH antibody) and cell wall disrupting agent contained in the agrochemical composition is between 5% and 50% by weight. In a more preferred embodiment the total concentration of both the polypeptide (such as the VHH antibody) contained and cell wall disrupting agent in the agrochemical composition is between 5% and 20% by weight. Compositions that comprise a combination of a polypeptide and a cell wall disrupting agent may allow for a reduction in the amount of one or both of the components since they may work synergistically, for example to achieve an IC50 at lower doses. In some cases the combination of the polypeptide and the cell wall disrupting agent allows the concentration of one or both of the components to be reduced by up to 50% (or more) whilst achieving the same or even a higher level of pest control.

In particular embodiments, the agrochemical compositions disclosed herein comprise at least one polypeptide, which is formulated in an aqueous solution. In particular embodiments, the agrochemical compositions disclosed herein comprise at least one cell wall disrupting agent, which is formulated in an aqueous solution.

In embodiments in which the compositions comprise a polypeptide and a cell wall disrupting agent may comprise the two components in a variety of different ratios. In some embodiments, the compositions comprise a cell wall disrupting agent and a polypeptide in a range of from 1:10 to 10: 1, or from 1:5 to 5:1, or from 1:2 to 2:1, or from 0.5:1 to 2:1.

In further particular embodiments, the agrochemical compositions disclosed herein comprise at least one polypeptide and at least one cell wall disrupting agent and further comprises an agrochemically suitable carrier and/or one or more suitable adjuvants.

The compositions according to the invention may comprise, in addition to the anti-pest polypeptide described above and the cell wall disrupting agent, solid or liquid carriers which are acceptable in the pest treatment of plants and/or parts of plants and/or surfactants which are also acceptable in the pest treatment of plants and/or parts of plants. In particular, there may be used inert and customary carriers and customary surfactants. These compositions cover not only compositions ready to be applied to the plants and/or parts of plants to be treated by immersion or using a suitable device, but also the commercial concentrated compositions which have to be diluted before application to the plants and/or parts of plants.

These agrochemical compositions according to the invention may also contain any sort of other ingredients such as, for example, protective colloids, adhesives, thickeners, thixotropic agents, penetrating agents, stabilizers, sequestrants, texturing agents, flavoring agents, taste enhancers, sugars, sweeteners, colorants and the like. More generally, the active substances, i.e. the at least one heavy chain variable domain, may be combined with any solid or liquid additives corresponding to the usual formulation techniques.

These agrochemical compositions according to the invention may also contain any sort of other active ingredient such as, for example, other anti-bacterial or anti-fungal active ingredients.

The term “carrier”, in the present disclosure, denotes a natural or synthetic organic or inorganic substance with which the anti-pest active substance is combined to facilitate its application to plants and/or one or more plant parts. This carrier is therefore generally inert and should be acceptable in the agri-sector. The carrier may be solid (clays, natural or synthetic silicates, silica, resins, waxes, solid fertilizers, and the like) or liquid (water, alcohols, in particular butanol, and the like).

The surfactant may be an emulsifying agent, a dispersing agent or a wetting agent of the ionic or nonionic type or a mixture of such surfactants. There may be mentioned, for example, salts of polyacrylic acids, salts of lignosulphonic acids, salts of phenolsulphonic or naphthalenesulphonic acids, polycondensates of ethylene oxide with fatty alcohols or with fatty acids or with fatty amines, substituted phenols (in particular alkylphenols or arylphenols), salts of esters of sulphosuccinic acids, derivatives of taurine (in particular alkyl taurates), phosphoric esters of polyoxyethylated phenols or alcohols, esters of fatty acids and polyols, sulphate, sulphonate and phosphate functional group-containing derivatives of the above compounds. The presence of at least one surfactant is generally essential when the inert carrier is not soluble in water and when the vector agent for application is water.

The agrochemical compositions as disclosed herein are themselves in fairly diverse, solid or liquid, forms.

As solid composition forms, there may be mentioned dustable powders (content of active substance which may be up to 100%) and granules, in particular those obtained by extrusion, by compacting, by impregnation of a granulated carrier, by granulation using a powder as starting material (the content of active substance in these granules being between 0.5 and 80% for these latter cases). Such solid compositions may be optionally used in the form of a liquid which is viscous to a greater or lesser degree, depending on the type of application desired, for example by diluting in water.

As liquid composition forms or forms intended to constitute liquid compositions during application, there may be mentioned solutions, in particular water-soluble concentrates, emulsions, suspension concentrates, wettable powders (or spraying powder), oils and waxes.

The suspension concentrates, which can be applied by spraying, are prepared so as to obtain a stable fluid product which does not form a deposit and they usually contain from 10 to 75% of active substance, from 0.5 to 15% of surfactants, from 0.1 to 10% of thixotropic agents, from 0 to 10% of appropriate additives, such as antifoams, corrosion inhibitors, stabilizers, penetrating agents and adhesives and, as carrier, water or an organic liquid in which the active substance is not or not very soluble: some organic solids or inorganic salts may be dissolved in the carrier to help prevent sedimentation or as antigels for water.

The agrochemical compositions as disclosed herein can be used as such, in form of their formulations or as the use forms prepared therefrom, such as aerosol dispenser, capsule suspension, cold fogging concentrate, hot fogging concentrate, encapsulated granule, fine granule, flowable concentrate for seed treatment, ready-to-use solutions, dustable powder, emulsifiable concentrate, emulsion oil in water, emulsion water in oil, macrogranule, macrogranule, oil dispersible powder, oil miscible flowable concentrate, oil miscible liquid, froths, paste, seed coated with a pesticide, suspension concentrate (flowable concentrate), suspensions-emulsions-concentrates, soluble concentrate, suspensions, soluble powder, granule, water soluble granules or tablets, water soluble powder for seed treatment, wettable powder, natural and synthetic materials impregnated with active compound, micro-encapsulation in polymeric materials and in jackets for seed, microencapsulation biological particles, for example those described in WO2018/201160, WO2018/201161 and WO2019/060903, as well as ULV-cold and hot fogging formulations, gas (under pressure), gas generating product, plant rodlet, powder for dry seed treatment, solution for seed treatment, ultra-low volume (ULV) liquid, ultra-low volume (ULV) suspension, water dispersible granules or tablets, water dispersible powder for slurry treatment.

These formulations are prepared in a known manner by mixing the active compounds or active compound combinations with customary additives, such as, for example, customary extenders and also solvents or diluents, emulsifiers, dispersants, and/or bonding or fixing agent, wetting agents, water repellents, if appropriate siccatives and UV stabilisers, colorants, pigments, defoamers, preservatives, secondary thickeners, adhesives, gibberellins and water as well further processing auxiliaries.

These compositions include not only compositions which are ready to be applied to the plant or seed to be treated by means of a suitable device, such as a spraying or dusting device, but also concentrated commercial compositions which must be diluted before application to the crop.

### Methods of Plant Protection or Treatment

In certain aspects, the present invention provides methods for protecting or treating a plant or a part of a plant from an infection or other biological interaction with a plant pathogen, at least comprising the step of applying to the plant or to a part of the plant, an agrochemical composition as disclosed herein. The composition may be applied under conditions effective to protect or treat the plant or a part of the plant against that infection or biological interaction with the plant pathogen.

In particular embodiments, these methods comprise applying to the plant or to a part of the plant an agrochemical composition as disclosed herein for example at an application rate higher than 50 g of the agrochemical composition per hectare, such as but not limited to an application rate higher than 75 g of the agrochemical composition per hectare, such as an application rate higher than 100 g of the agrochemical composition per hectare, or in particular an application rate higher than 200 g of the agrochemical composition per hectare.

In particular embodiments, these methods comprise applying to the plant or to a part of the plant an agrochemical composition as disclosed herein for example at an application rate between 50 g and 1000 g of the agrochemical composition per hectare, such as but not limited to an application rate of between 50 g and 800 g of the agrochemical composition per hectare, in particular an application rate of between 75 g and 500 g of the agrochemical composition per hectare, such as between 75 g and 200 g of the agrochemical composition per hectare or between 75 g and 150 g per hectare.

In yet another embodiment, the invention provides methods for combating or inhibiting plant pests, which methods comprise applying an agrochemical or biological control composition according to the invention to a plant, such as a crop, or a part of a plant or a crop, for example at an application rate below 100 g of said polypeptide per hectare. In specific embodiments the application rate is below 50 g/ha, below 40 g/ha, below 35 g/ha, below 30 g/ha, below 25 g/ha, below 20 g/ha, below 15 g/ha, below 10 g/ha, below 5 g/ha, below 1 g/ha or even lower amounts of polypeptide/ha and where said polypeptide is present in the composition together with at least one cell wall degrading agent. In a more preferred embodiment, the application rate of the polypeptide when present in the composition according to the invention is between 5 g/ha and 50 g/ha and where said polypeptide is present in the composition together with at least one cell wall degrading agent.

Similarly, the invention provides methods for combating or inhibiting plant pests, which methods comprise applying an agrochemical or biological control composition according to the invention to a plant, such as a crop, or a part of a plant or a crop, for example at an application rate below 100 g of said cell wall disrupting agent per hectare. In specific embodiments the application rate is below 50 g/ha, below 40 g/ha, below 35 g/ha, below 30 g/ha, below 25 g/ha, below 20 g/ha, below 15 g/ha, below 10 g/ha, below 5 g/ha, below 1 g/ha or even lower amounts of cell wall disrupting agent/ha and where said cell wall degrading agent is present in the composition together with at least one polypeptide. In a more preferred embodiment, the application rate of the cell wall disrupting agent when present in the composition according to the invention is between 5 g/ha and 50 g/ha and where said cell wall degrading agent is present in the composition together with at least one polypeptide.

Therefore, the invention provides methods for combating or inhibiting plant pests, which methods comprise applying an agrochemical or biological control composition according to the invention to a plant, such as a crop, or a part of a plant or a crop, for example at an application rate of below 200 g of total weight of said polypeptide and cell wall disrupting agent per hectare. In specific embodiments the application rate is below 100 g/ha, below 80 g/ha, below 70 g/ha, below 60 g/ha, below 50 g/ha, below 40 g/ha, below 30 g/ha, below 20 g/ha, below 10 g/ha, below 2 g/ha or even lower amounts of total weight of the polypeptide and cell wall disrupting agent/ha. In a more preferred embodiment, the application rate of the polypeptide and cell wall disrupting agent when present in the composition according to the invention is between 10 g/ha and 100 g/ha.

In some embodiments the cell wall degrading agent is applied to a crop, or a part of a plant or a crop without the polypeptide being present in the agrochemical composition.

It is understood depending on the crop and the environmental pressure of the plant pests that the farmer can vary the application rate. These application rates variances are specified in the technical sheet delivered with the specific agrochemical composition.

In yet another embodiment, the invention provides the use of the agrochemical or biological control compositions of the invention in combating or inhibiting plant pests. In yet another embodiment, the invention provides the use of the agrochemical or biological control compositions of the invention in a method of combating or inhibiting plant pests.

Applying an agrochemical or biological control composition or polypeptide according to the invention to a crop may be done using any suitable method for applying an agrochemical or biological control composition to a crop, including, but not limited to spraying (including high volume (HV), low volume (LV) and ultra-low volume (ULV) spraying), brushing, dressing, dripping, coating, dipping, immersing, spreading, fogging, applying as small droplets, a mist or an aerosol.

Thus, in particular embodiments, the methods for protecting or treating a plant or a part of a plant from an infection or other biological interaction with a plant pathogen as disclosed herein, comprise applying the agrochemical composition to the plant or to a part of the plant for example by spraying, atomizing, foaming, fogging, culturing in hydroculture, culturing in hydroponics, coating, submerging, and/or encrusting.

In certain particular embodiments, the present invention provides methods of inhibiting, preventing, reducing or controlling the growth of a plant pathogen, comprising at least the step of applying to a plant or to a part of said plant, an agrochemical composition as disclosed herein.

In certain other embodiments, the present invention provides methods for of killing a plant pathogen, comprising at least the step of applying to a plant or to a part of said plant, an agrochemical composition or polypeptide as disclosed herein.

Alternatively, the application rate of the agrochemical composition according to the invention, meaning the amount of the agrochemical composition that is applied to the crop, is such that less than 100 g, 50 g, 40 g, 35 g, 30 g, 25 g, 20 g, 20 g, 15 g, 10 g, 5 g, 1 g or even lower than 1 g but preferably between 5 g and 50 g of the polypeptide and 100 g, 50 g, 40 g, 35 g, 30 g, 25 g, 20 g, 20 g, 15 g, 10 g, 5 g, 1 g or even lower than 1 g but preferably between 5 g and 50 g of the cell wall disrupting agent, comprised in the agrochemical or biological control composition according to the invention, is applied to the crop per hectare. It being understood that the amount of the at least one polypeptide and/or the at least one cell wall degrading agent is reduced as compared to when the agrochemical composition would containing either the at least one polypeptide or the at least one cell wall degrading agent alone. In some embodiments, the polypeptide and the cell wall disrupting agent act synergistically to allow a reduction in one or both components in the composition. In some embodiments, the combined concentration of the polypeptide and the cell wall disrupting agent when present in a single composition may be lower than the equivalent combined concentrations of the polypeptide and the cell wall disrupting agent when present in separate compositions, because of the synergy seen when the two components are combined in a single composition.

According to the methods as disclosed herein, the agrochemical or biological control composition can be applied once to a crop, or it can be applied two or more times after each other with an interval between every two applications. According to the method of the present invention, the agrochemical or biological control composition according to the invention can be applied alone or in mixture with other materials, preferably other agrochemical or biological control compositions, to the crop; alternatively, the agrochemical or biological control composition according to the invention can be applied separately to the crop with other materials, preferably other agrochemical or biological control compositions, applied at different times to the same crop. According to the method of the present invention, the agrochemical or biological control composition according to the invention may be applied to the crop prophylactically, or alternatively, may be applied once target pests have been identified on the particular crop to be treated.

The agrochemical compositions as disclosed herein can be applied directly to a plant, a crop or to one or more parts of the plant by the above mentioned methods, such as directly to the entire plant or directly to one or more parts of the plant, either in a pre-harvest or in a post-harvest stage. Pre-harvest application may have an effect post-harvest. In certain further embodiments, the agrochemical compositions as disclosed herein can be applied directly to one or more parts of the plant by the above mentioned methods, such as directly to the stalks, leaves, tubers, stems, shoots, the seeds, the fruits, the roots, the flowers, grains, the buds etc.

The method of treatment as disclosed herein can also be used in the field of protecting storage goods against attack of plant pathogens. In this method of treatment, application of a composition of the invention may be pre-harvest or post-harvest. According to the present invention, the term “storage goods” is understood to denote natural substances of vegetable or animal origin and their processed forms, which have been taken from the natural life cycle and for which long-term protection is desired. Storage goods of vegetable origin, such as plants or parts thereof, for example stalks, leaves, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The combinations according the present invention can prevent disadvantageous effects such as decay, discoloration or mold. Preferably “storage goods” is understood to denote natural substances of vegetable origin and their processed forms, more preferably fruits and their processed forms, such as pomes, stone fruits, soft fruits and citrus fruits and their processed forms.

The agrochemical compositions as disclosed herein can also be applied indirectly to a plant, a crop or to one or more parts of the plant by the above mentioned methods, such as indirectly to the entire plant or indirectly to one or more parts of the plant, either in a pre-harvest or in a post-harvest stage. The agrochemical compositions as disclosed herein can be applied close to harvest, such as about three weeks pre-harvest, for example two weeks pre-harvest or one week prior to harvest or less than one week pre-harvest. Pre-harvest application may have an effect post-harvest. Thus, in certain embodiments, the agrochemical compositions as disclosed herein can be applied indirectly to a plant, a crop or to one or more parts of the plant by the above mentioned methods, such as by applying the agrochemical composition to the surroundings or to the medium in which the plant or the one or more parts of the plant are growing or are stored, such as for instance but not limited to the air, the soil, the hydroponic culture, the hydroculture, or the liquid medium, such as for instance the aqueous liquid medium or water, in which the plant or the one or more parts of the plant are growing or are stored.

The agrochemical compositions as disclosed herein can be applied directly as a component of an integrated pest management approach.

It thus should be generally understood in the context of this application that the treatment of plants and plant parts with the agrochemical compositions as disclosed herein is carried out directly or by action on their environment, habitat or storage area by means of the normal treatment methods, for example by watering (drenching), drip irrigation, spraying, vaporizing, atomizing, broadcasting, dusting, foaming, spreading-on, and as a powder. It is furthermore possible to apply the compositions by the ultra-low volume method, or to inject the active compound preparation or the active compound itself into the soil.

In particular embodiments, the methods for protecting or treating a plant or a part of a plant from an infection or other biological interaction with a plant pathogen as disclosed herein, comprise applying the agrochemical composition to the plant or to a part of the plant either in a pre-harvest or in a post-harvest stage.

According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes, squash, strawberries, grapes, pumpkin and peaches. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers.

The plant species to which the agrochemical compositions as disclosed herein can be applied can for example be but are not limited to maize, soya bean, alfalfa, cotton, sunflower, Brassica oil seeds such as Brassica napus (e.g. canola, rape-seed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cu-curbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflow-er, Brussels sprouts, pak choi, kohlrabi, radishes, horseradish, cress and Chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e g. poppy), Asparagaceae (e.g. asparagus); useful plants and ornamental plants in the garden and woods including turf, lawn, grass and Stevia rebaudiana; and in each case genetically modified types of these plants.

In a preferred embodiment of the treatment methods disclosed herein, the crop is selected from the group consisting of field crops, grasses, fruits and vegetables, lawns, trees and ornamental plants.

In certain aspects, the present invention thus also provides post-harvest treatment methods for protecting or treating a harvested plant or a harvested part of the plant from an infection or other biological interaction with a plant pathogen, at least comprising the step of applying to the harvested plant or to a harvested part of the plant, an agrochemical composition as disclosed herein, under conditions effective to protect or treat the harvested plant or a harvested part of the plant against the infection or biological interaction with the plant pathogen. According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes, pumpkin and peaches. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers. According to further specific embodiments, the harvested produce is cut grass or wood.

Post-harvest disorders are e.g. Ienticel spots, scorch, senescent breakdown, bitter pit, scald, water core, browning, vascular breakdown, CO₂ injury, CO₂ or O₂ deficiency, and softening.

Fungal diseases may be caused for example by the following fungi: Mycosphaerella spp., Mycosphaerella musae, Mycosphaerella fragariae, Mycosphaerella citri; Mucor spp., e.g. Mucor piriformis; Monilinia spp., e.g. Monilinia fructigena, Monilinia laxa; Phomopsis spp., Phomopsis natalensis; Colletotrichum spp., e.g. Colletotrichum musae, Colletotrichum gloeosporioides, Colletotrichum coccodes; Verticillium spp., e.g. VerticiHium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mail; Stemphyllium spp., e.g. Stemphyllium vesica um; Thielaviopsis spp., e.g. Thielaviopsis paradoxy; Aspergillus spp., e.g. Aspergillus niger, Aspergillus carbonari us; Nectria spp., e.g. Nectria galligena; Cercospora spp., e.g. Cercospora angreci, Cercospora apii, Cercospora atrofiliformis, Cercospora musae, Cercospora zeae-maydis.

In further aspects, the present invention provides uses of the agrochemical compositions as disclosed herein as an anti-pest agent, such as for instance a biostatic agent or a pesticidal agent, including but not limited to a fungistatic or a fungicidal agent.

In a particular embodiment, the plant pests combated by the method according to the present invention are plant pathogenic fungi, as defined before. Lesion number, lesion size, and extent of sporulation of fungal pathogens may all be decreased as a result of the application of the method according to the present invention.

The present invention will now be illustrated by way of the following non-limiting Examples.

### EXAMPLES

### Example 1: In Vitro Antifungal Assay

The antifungal activity of a composition comprising at least one polypeptide and at least one cell wall disrupting agent, wherein the at least one polypeptide is a heavy chain variable domain of a heavy chain antibody (VHH) or a functional fragment thereof is assessed in vitro against a plant pathogenic fungus such as Botrytis cinerea R16.

Two-fold dilutions of said composition and two-fold dilutions of the individual VHH and cell wall disrupting agents are prepared separately in 96-well microtiter plates. Either 20 μl of these dilutions or 20 μl of water as a control, are added to 80 μl of fungal spore suspension (1 E+05 spores/ml in half strength potato dextrose broth (PDB)), starting with a concentration of 10 μM. The test plates are incubated for 36 h at 25° C. using the IncuCyte Zoom live cell imaging system. All tests are performed in at least 2 replicates.

The results of the antifungal activity assay indicate a clear dose-dependent growth inhibition pattern. Furthermore the combination of a VHH and a cell wall degrading enzyme show an increased effect as opposed to a VHH or cell wall degrading enzyme alone. Activities are expressed as the % fungal growth as a function of the concentration of the composition (μM).

### Example 2: Cell Wall Degrading Enzymes and VHH Antibody Inhibit Botrytis cinerea in an In Vitro Antifungal Assay

VHHs were selected based on previous screenings of antifungal VHHs. The VHH-1 antibody was taken from WO2021198396 and causes retardation of the growth of a spore of a fungus and/or lysis of a spore of a fungus and where this fungus may be Botrytis cinerea. The other VHH-W, VHH-X, VHH-Y and VHH-Z used in this example are VHHs that interact and/or bind to the cell membrane of fungal species, such as plant pathogenic fungal species, causing retardation of the growth of a spore of a fungus and/or lysis of a spore of a fungus and where this fungus may be Botrytis cinerea. Cell Wall Degrading Enzymes, or CWDEs in short, were selected based on the screening of commercially available CWDE. More specifically a CWDE mixture was used in these examples. More specifically the CWDE of these examples was the commercially available enzyme cocktail VinoTaste Pro available from Novozymes and reported to comprise B-glucanase activity.

The antifungal activity of VHHs, in combination with CWDEs, was assessed in an in vitro assay against the plant pathogenic fungus Botrytis cinerea. The current in vitro assay is a standard microtiter plate-based antifungal assay against Botrytis cinerea based on confluence analysis using an IncuCyte S3 System tracking the outgrowth of fungal spores overtime until saturation is reached. VHHs and CWDEs were assessed in serial dilutions, alone and in combination. The CWDEs were mixed with one VHH at a fixed ratio and serially diluted in 10 mM sterile HEPES buffer pH 7. Standard 384-well microtiter plates, black, clear bottom, were loaded with 50 μl of each treatment. When indicated, protease inhibitor (Halt™ Protease Inhibitor Cocktail (100×), Thermo Fisher Scientific) was added at a final concentration of 0.06× (indicated as PI 0.06×). Negative controls were loaded with 50 μl of 10 mM HEPES, and protease inhibitor, as indicated. A negative control without protease inhibitor was included in each assay. Each well was then loaded with 40 μl of Botrytis cinerea spores, diluted in sterile 1×PDB (Potato Dextrose Broth, Difco™). Each well was loaded with approximately 2·10\hat{ }3 spores. Botrytis cinerea spores were harvest from 2 weeks old PDA (Potato Dextrose Agar, Difco™) plates, filtered and suspended in ultra purified mQ water. Spores were stored at 4° C. before usage. Plates were scanned with an IncuCyte S3 (Sartorius) for 3 days, every 2 hours, phase only, 10× magnification. IncuCyte S3 was stored in an incubator at 23° C. Confluence was calculated with IncuCyte software version 2021C (Essen BioScience Inc.). Each assay was repeated at least twice with at least 5 technical replicates and with minimal adjustments. Since the CWDE mixture contained sufficient background protease activity to degrade the VHH, a protease inhibitor dose that prevented this degradation was applied at the same concentration to all indicated test wells (indicated as PI 0.06×, see above). Note that the CWDE mixture used herein will contain enzymes that have no effect on the fungal cell wall (such as for example pectinases or proteases of which the activity was inhibited) and therefore the total concentration of protein that was estimated to be present in the CWDE mixture used here, and as indicated by the manufacturer, for which the IC50 value is reached were overestimated.

### Example 2.1 Cell Wall Degrading Enzymes from Filamentous Fungi and VHH Antibody VHH-1

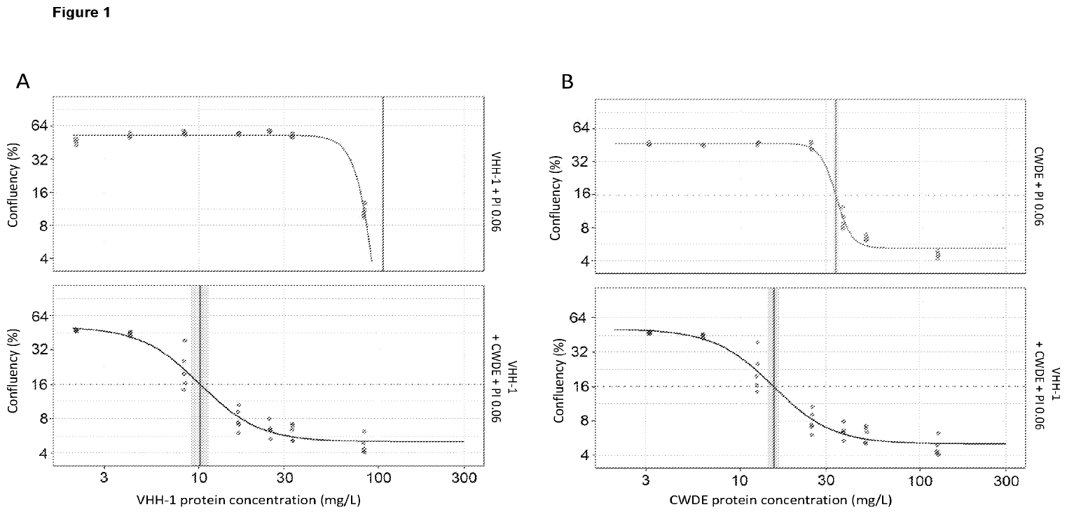

The results of the above experiment for VHH-1 are summarised in FIG. 1. The IC₅₀ value for both the CWDE and VHH were determined separately (FIGS. 1A and 1B, top panel). IC50 values and their 95% confidence intervals were extracted from a nonlinear fit of a symmetric log-logistic function (4 parameters) fit to log 2 transformed confluence data. For VHH-1 the IC₅₀ value was reached at an estimated concentration of 105.2 mg/L. For the CWDE the IC₅₀ value was reached at 34.0 mg/L. Hereafter, both the VHH-1 and CWDE were mixed at a ratio of 1.5 (CWDE:VHH) and a serial dilution was made in a microtiter plate and confluence data acquired as described above. This surprisingly showed that the IC₅₀ of the mixture was reached with significantly lower quantities of both VHH-1 and CWDE. More specifically, the IC₅₀ was reached at a concentration of 10.2 mg/L VHH1 and 15.3 mg/L CWDE.

When synergy is assessed by each dose regime a clear indication of synergy between the tested VHH and CWDE emerged. The separate results of the dose regimes are shown for VHH-1 in FIG. 2 and Table 1. Table 1 provides statistical model coefficients and their significance for a model to assess any behaviour beyond additive according to Confluence (%)˜PI+CWDE+VHH+CWDE:VHH. The PI (protease inhibitor), CWDE and VHH terms report the linear (additive) effects of each component. The CWDE:VHH term reports activity beyond (or beneath) additive for the interaction between CWDE and VHH. If the coefficient for this term is statistically significant and negative, there is synergy between the CWDE and VHH components in their suppressive effects on fungal confluence. A negative interaction term indicates that the observed fungal growth is significantly less than would be expected based on independent (additive) effects alone. All explanatory variables were set to either 0 or 1 in modelling, depending on whether the relevant components or combinations were absent or present in the treatment cocktail, so that the reported coefficients in the Estimate column of Table 1 are the observed effects of the reported dose on confluence. The model is based on S. R. Colby. (1967). Calculating Synergistic and Antagonistic Responses of Herbicide Combinations, Weeds Vol. 15, No. 1, pp. 20-22. As in several of the analysis done herein this can be shown for multiple dose regimes, the strongest performing combination is presented. For VHH-1 the panel in FIG. 2 with dose regime of VHH-1 at 16.7 mg/L and CWDE at 25 mg/L was picked for further discussion. A synergistic interaction between VHH-1 and CWDE is observed with a % change of −87% more suppression observed, relative to the buffer growth level, than is expected from independent additive effects of the VHH and CWDE components alone.

TABLE 1
Statistical analysis of dose regime VHH-1 at 16.7 mg/L and CWDE at 25 mg/L.

| | Estimate | | | | | |
|---|---|---|---|---|---|---|
| | (% confluence) | C.I. | % change | % change C.I. | p | Adj. p |
| Buffer | 55.3 | | | | | |
| Protease inhibitor (0.06 X) | −12.5 | (−15.6, −9.4) | −22.5% | (−28.1%, −16.9%) | 2.4e−11 | 1.0e−10 |
| CWDE | 2.0 | (−1.6, 5.6) | 3.6% | (−2.8%, 10.1%) | 0.149 | 0.311 |
| VHH-1 | 11.3 | (7.7, 14.9) | 20.5% | (14.0%, 26.9%) | 4.3e−09 | 1.2e−08 |
| Interaction between | −48.2 | (−53.6, −42.7) | −87.0% | (−96.9%, −77.2%) | 7.2e−20 | 6.0e−19 |
| VHH-1 and CWDE | | | | | | |

The ‘Estimate’ column shows the model-estimated mean in units of percent confluence for the reference treatment, and the difference from the reference for the subsequent rows. C.I. stands for 95% confidence interval. The % change column shows effects, with the buffer normalized to 100%, that is, full and uninhibited fungal growth. P-values for 4 pairwise tests, comparing treatment effects to the buffer control, were corrected for multiple hypothesis testing (Adj. p) using the Benjamini-Yekutieli method. Significant effects at an adjusted p-value cutoff of 0.05 are in bold.

### Example 2.2 Cell Wall Degrading Enzymes from Filamentous Fungi and VHH Antibody VHH-W

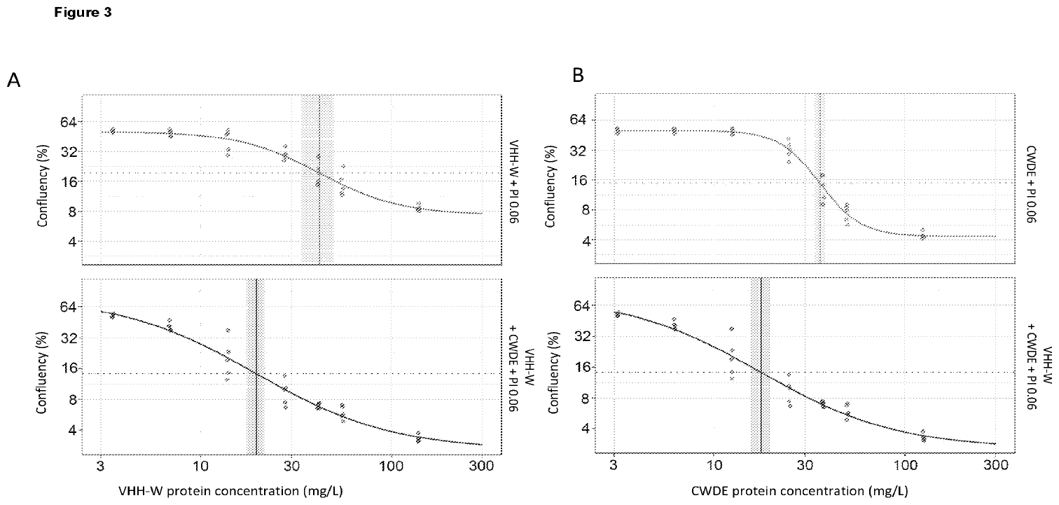

The results of the experiment set out under Example 2 for VHH-W are summarised in FIG. 3. Exactly like set-out in Example 2.1, the IC50 value for both the CWDE and VHH were determined separately (FIGS. 3A and 3B, top panel). For VHH-W the IC₅₀ value was reached at an estimated concentration of 42.0 mg/L. For the CWDE the IC₅₀ value was reached at 36.1 mg/L. Hereafter, both the VHH-W and CWDE were mixed at a ratio of 0.9 (CWDE:VHH) and a serial dilution was made in a microtiter plate and confluence data acquired as described above. This surprisingly showed that the of the mixture was reached with significantly lower quantities of both VHH-W and CWDE. More specifically, the was reached at a concentration of 19.6 mg/L VHH-W and 17.7 mg/L CWDE.

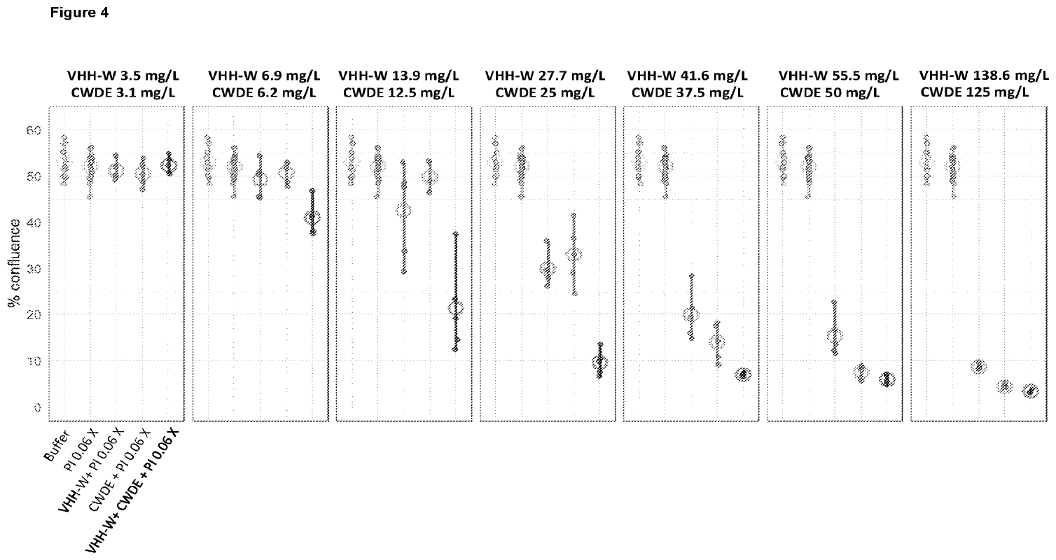

The separate results of the dose regimes are shown for VHH-W in FIG. 4 and Table 2. Exactly like set-out in Example 2.1 and for the dose regime with VHH-W at 13.9 mg/L and CWDE at 12.5 mg/L, a synergistic interaction between VHH-W and CWDE is observed with a % change of −35% more suppression observed, relative to the buffer growth level, than is expected from independent additive effects of the VHH and CWDE components alone.

TABLE 2
Statistical analysis of dose regime VHH-W at 13.9 mg/L and CWDE at 12.5 mg/L.

| | Estimate | | | | | |
|---|---|---|---|---|---|---|
| | (% confluence) | C.I. | % change | % C.I. | p | Adj. p |
| Buffer | 52.9 | | | | | |
| Protease inhibitor (0.06 X) | −0.9 | (−5.5, 3.6) | −1.8% | (−10.4%, 6.9%) | 0.593 | 1.000 |
| CWDE | −2.4 | (−9.0, 4.2) | −4.6% | (−17.1%, 7.9%) | 0.338 | 0.938 |
| VHH-W | −9.6 | (−16.2, −3.0) | −18.2% | (−30.7%, −5.7%) | 3.8e−04 | 1.6e−03 |
| Interaction between VHH-W | −18.6 | (−29.3, −8.0) | −35.2% | (−55.4%, −15.0%) | 3.4e−05 | 2.8e−04 |
| and CWDE | | | | | | |

The ‘Estimate’ column shows the model-estimated mean in units of percent confluence for the reference treatment, and the difference from the reference for the subsequent rows. C.I. stands for 95% confidence interval. The % change column shows effects, with the buffer normalized to 100%, that is, full and uninhibited fungal growth. P-values for 4 pairwise tests, comparing treatment effects to the buffer control, were corrected for multiple hypothesis testing (Adj. p) using the Benjamini-Yekutieli method. Significant effects at an adjusted p-value cutoff of 0.05 are in bold.

### Example 2.3 Cell Wall Degrading Enzymes from Filamentous Fungi and VHH Antibody VHH-X

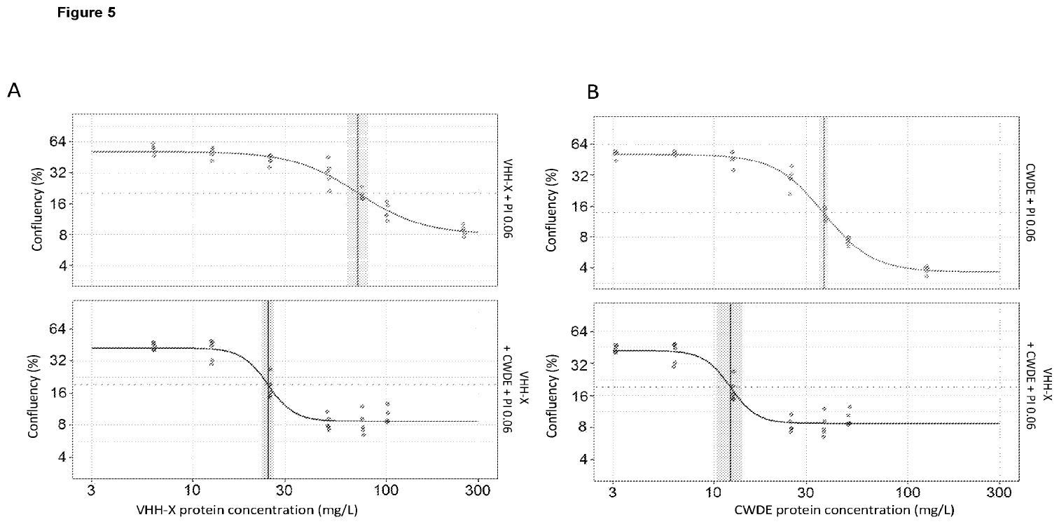

The results of the experiment set out under Example 2 for VHH-X are summarised in FIG. 5. Exactly like set-out in Example 2.1, the value for both the CWDE and VHH were determined separately (FIGS. 5A and 5B, top panel). For VHH-X the value was reached at an estimated concentration of 71.5 mg/L. For the CWDE the value was reached at 36.9 mg/L. Hereafter, both the VHH-X and CWDE were mixed at a ratio of 1.5 (CWDE:VHH) and a serial dilution was made in a microtiter plate and confluence data acquired as described above. This surprisingly showed that the IC₅₀ of the mixture was reached with significantly lower quantities of both VHH-X and CWDE. More specifically, the was reached at a concentration of 24.5 mg/L VHH-X and 12.1 mg/L CWDE.

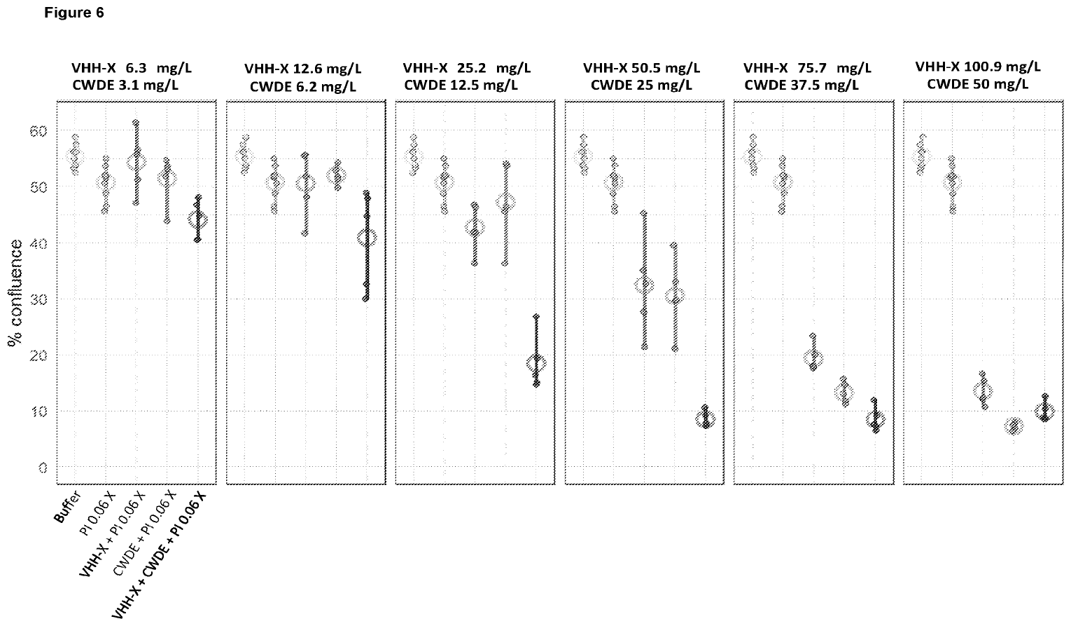

The separate results of the dose regimes are shown for VHH-X in FIG. 6 and Table 3. Exactly like set-out in Example 2.1 and for the dose regime with VHH-X at 25.2 mg/L and CWDE at 12.5 mg/L, a synergistic interaction between VHH-X and CWDE is observed with a % change of −37% more suppression observed, relative to the buffer growth level, than is expected from independent additive effects of the VHH and CWDE components alone.

TABLE 3
Statistical analysis of dose regime VHH-X at 25.2 mg/L and CWDE at 12.5 mg/L.

| | Estimate | | | | | |
|---|---|---|---|---|---|---|
| | (% confluence) | C.I. | % change | % C.I. | p | Adj. p |
| Buffer | 55.3 | | | | | |
| Protease inhibitor (0.06 X) | −4.6 | (−9.9, 0.6) | −8.4% | (−17.9%, 1.1%) | 0.028 | 0.077 |
| CWDE | −3.6 | (−9.6, 2.5) | −6.4% | (−17.4%, 4.6%) | 0.135 | 0.281 |
| VHH-X | −8.1 | (−14.2, −2.0) | −14.7% | (−25.7%, −3.7%) | 1.5e−03 | 6.3e−03 |
| Interaction between VHH-Y | −20.5 | (−29.9, −11.2) | −37.1% | (−53.9%, −20.3%) | 2.9e−06 | 2.4e−05 |
| and CWDE | | | | | | |

The ‘Estimate’ column shows the model-estimated mean in units of percent confluence for the reference treatment, and the difference from the reference for the subsequent rows. C.I. stands for 95% confidence interval. The % change column shows effects, with the buffer normalized to 100%, that is, full and uninhibited fungal growth. P-values for 4 pairwise tests, comparing treatment effects to the buffer control, were corrected for multiple hypothesis testing (Adj. p) using the Benjamini-Yekutieli method. Significant effects at an adjusted p-value cutoff of 0.05 are in bold.

### Example 2.4 Cell Wall Degrading Enzymes from Filamentous Fungi and VHH Antibody VHH-Y

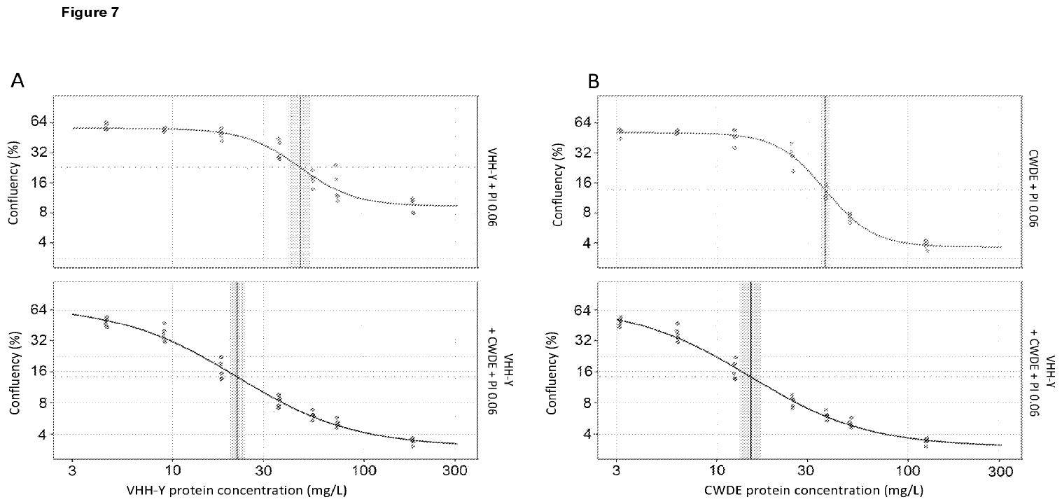

The results of the experiment set out under Example 2 for VHH-Y are summarised in FIG. 7. Exactly like set-out in Example 2.1, the IC₅₀ value for both the CWDE and VHH were determined separately (FIGS. 7A and 7B, top panel). For VHH-Y the IC₅₀ value was reached at an estimated concentration of 46.5 mg/L. For the CWDE the IC₅₀ value was reached at 36.9 mg/L. Hereafter, both the VHH-Y and CWDE were mixed at a ratio of 1.6 (CWDE:VHH) and a serial dilution was made in a microtiter plate and confluence data acquired as described above. This surprisingly showed that the IC₅₀ of the mixture was reached with significantly lower quantities of both VHH-Y and CWDE. More specifically, the IC₅₀ was reached at a concentration of 21.8 mg/L VHH-Y and 15.1 mg/L CWDE.

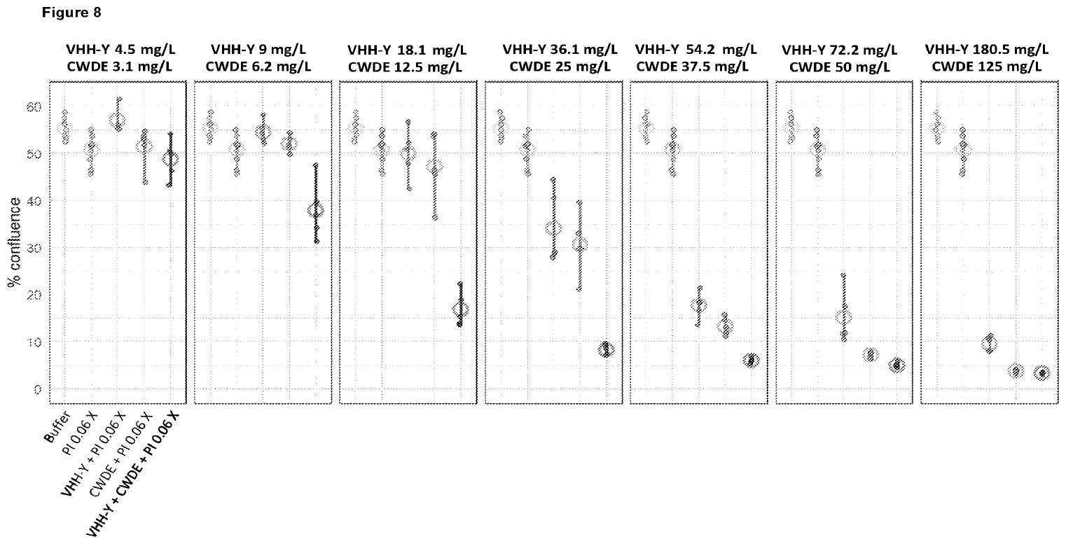

The separate results of the dose regimes are shown for VHH-Y in FIG. 8 and Table 4. Exactly like set-out in Example 2.1 and for the dose regime with VHH-Y at 18.1 mg/L and CWDE at 12.5 mg/L, a synergistic interaction between VHH-Y and CWDE is observed with a % change of −53% more suppression observed, relative to the buffer growth level, than is expected from independent additive effects of the VHH and CWDE components alone.

TABLE 4
Statistical analysis of dose regime VHH-W at 18.1 mg/L and CWDE at 12.5 mg/L.

| | Estimate | | | | | |
|---|---|---|---|---|---|---|
| | (% confluence) | C.I. | % change | % C.I. | p | Adj. p |
| Buffer | 55.3 | | | | | |
| Protease inhibitor (0.06 X) | −4.6 | (−9.9, 0.6) | −8.4% | (−17.9%, 1.1%) | 0.027 | 0.112 |
| CWDE | −3.6 | (−9.6, 2.5) | −6.4% | (−17.4%, 4.5%) | 0.133 | 0.368 |
| VHH-Y | −0.8 | (−6.8, 5.3) | −1.4% | (−12.3%, 9.6%) | 0.746 | 1.000 |
| Interaction between VHH-Y | −29.6 | (−38.8, −20.3) | −53.5% | (−70.2%, −36.8%) | 3.5e−09 | 2.9e−08 |
| and CWDE | | | | | | |

The ‘Estimate’ column shows the model-estimated mean in units of percent confluence for the reference treatment, and the difference from the reference for the subsequent rows. C.I. stands for 95% confidence interval. The % change column shows effects, with the buffer normalized to 100%, that is, full and uninhibited fungal growth. P-values for 4 pairwise tests, comparing treatment effects to the buffer control, were corrected for multiple hypothesis testing (Adj. p) using the Benjamini-Yekutieli method. Significant effects at an adjusted p-value cutoff of 0.05 are in bold.

### Example 2.4 Cell Wall Degrading Enzymes from Filamentous Fungi and VHH Antibody VHH-Z

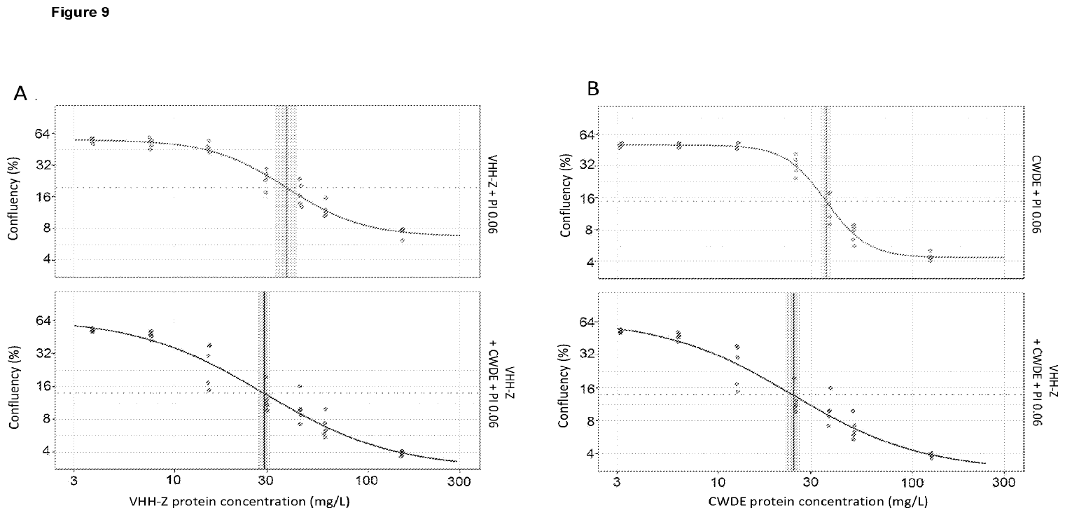

The results of the experiment set out under Example 2 for VHH-Z are summarised in FIG. 9. Exactly like set-out in Example 2.1, the IC50 value for both the CWDE and VHH were determined separately (FIGS. 9A and 9B, top panel). For VHH-Z the IC₅₀ value was reached at an estimated concentration of 38.0 mg/L. For the CWDE the value was reached at 36.1 mg/L. Hereafter, both the VHH-Z and CWDE were mixed at a ratio of 1.7 (CWDE:VHH) and a serial dilution was made in a microtiter plate and confluence data acquired as described above. This surprisingly showed that the IC₅₀ of the mixture was reached with significantly lower quantities of both VHH-Z and CWDE. More specifically, the was reached at a concentration of 29.1 mg/L VHH-Z and 24.3 mg/L CWDE.

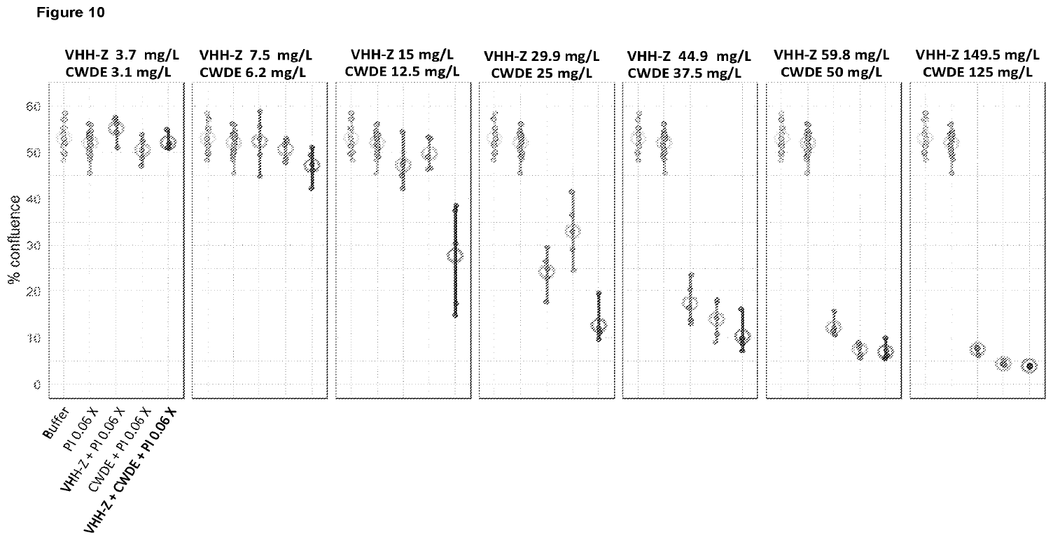

The separate results of the dose regimes are shown for VHH-Z in FIG. 10 and Table 5. Exactly like set-out in Example 2.1 and for the dose regime with VHH-Z at 15.0 mg/L and CWDE at 12.5 mg/L, a synergistic interaction between VHH-Z and CWDE is observed with a % change of −32% more suppression observed, relative to the buffer growth level, than is expected from independent additive effects of the VHH and CWDE components alone.

TABLE 5
Statistical analysis of dose regime VHH-Z at 15 mg/L and CWDE at 12.5 mg/L.

| | Estimate | | | | | |
|---|---|---|---|---|---|---|
| | (% confluence) | C.I. | % change | % C.I. | p | Adj. p |
| Buffer | 52.9 | | | | | |
| Protease inhibitor (0.06 X) | −0.9 | (−5.0, 3.1) | −1.8% | (−9.4%, 5.9%) | 0.546 | 1.000 |
| CWDE | −2.4 | (−8.3, 3.4) | −4.6% | (−15.6%, 6.4%) | 0.279 | 0.774 |
| VHH-Z | −4.8 | (−10.6, 1.1) | −9.0% | (−20.0%, 2.0%) | 0.037 | 0.152 |
| Interaction between VHH-Z | −17.2 | (−26.6, −7.8) | −32.5% | (−50.3%, −14.7%) | 1.8e−05 | 1.5e−04 |
| and CWDE | | | | | | |

The ‘Estimate’ column shows the model-estimated mean in units of percent confluence for the reference treatment, and the difference from the reference for the subsequent rows. C.I. stands for 95% confidence interval. The % change column shows effects, with the buffer normalized to 100%, that is, full and uninhibited fungal growth. P-values for 4 pairwise tests, comparing treatment effects to the buffer control, were corrected for multiple hypothesis testing (Adj. p) using the Benjamini-Yekutieli method. Significant effects at an adjusted p-value cutoff of 0.05 are in bold.

### Example 3: CWDEs Digest Fungal Cell Walls and Cause the Formation of Protoplasts

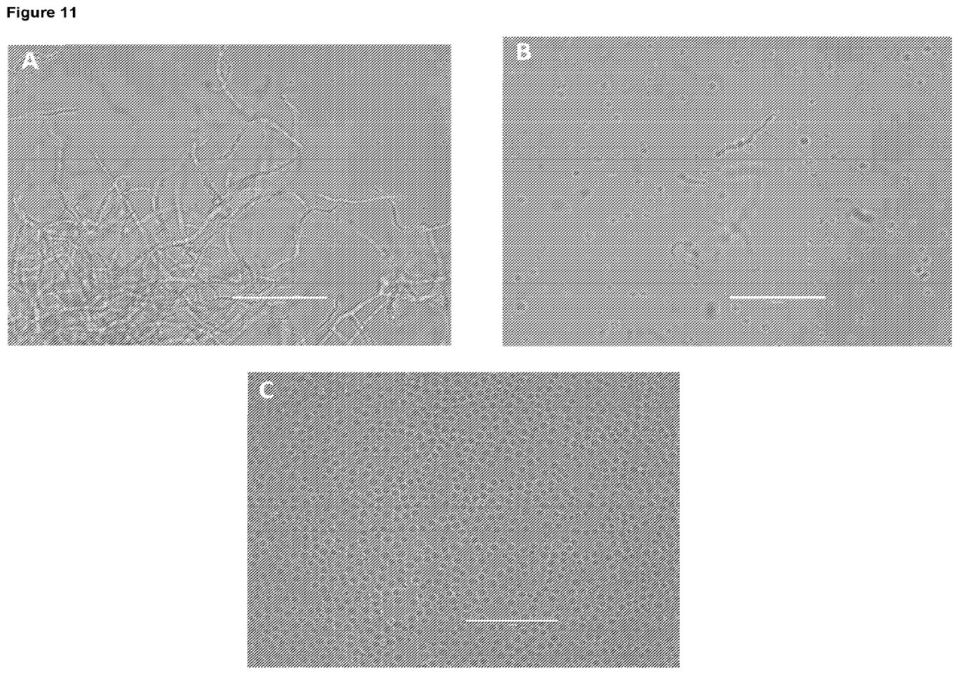

In order to test whether enzymes or mixtures of enzymes comprise CWDEs, a test was set-up. Therefore Botrytis cinerea mycelium was cultured overnight in YPD broth (10 g/L yeast extract, 20 g/L peptone, and 20 g/L glucose), filtered, and washed with FF1 buffer (1.2 M MgSO₄·7H2O, 7 mM NaH₂PO₄·2H₂O, pH 5.8). Washed mycelium was added to the CWDE solution (1.5 g in 15 mL FF1 buffer, pH 7.0) and incubated 2 to 4 hours at 28° C., 70 rpm. Protoplasts were separated from mycelium by filtration. Protoplasts were then centrifuged 15 min at 4000 rpm at 4° C. with FF2 buffer (0.1 M Tris-HCl, 0.6M D-sorbitol). The interphase was collected and transferred to a new tube. FF3 buffer (10 mM Tris-HCl, 10 mM CaCl₂, 1.2M D-sorbitol, pH 7.5) was added to the sample and centrifuged 5 min at 2500 rpm, 4° C. Supernatant was discarded and the pellet was resuspended in 1 mL of FF3 buffer. Pictures were captured in bright field after the incubation in CWDE solution or in FF2 buffer for negative controls. Purified protoplast pictures were captured after the last purification step. The CWDE of this example was the commercially available enzyme cocktail VinoTaste Pro available from Novozymes and reported to comprise B-glucanase activity. FIG. 11 shows the protoplast formation by a CWDE, before incubation (FIG. 11A), during incubation with a CWDE (FIG. 11B) and after purification (FIG. 11C).

### EMBODIMENTS

The invention includes at least the following embodiments
1. A composition comprising at least one polypeptide and at least one cell wall disrupting agent.
2. The composition of statement 1, wherein the at least one polypeptide is an antibody.
3. The composition of statement 2, wherein the antibody is a heavy chain variable domain of a heavy chain antibody (VHH) or a functional fragment thereof.
4. The composition according to any one of statements 1 to 3, wherein the polypeptide specifically binds to a fungus.
5. The composition according to statements 4, wherein the polypeptide specifically binds to at least one plasma membrane component of said fungus.
6. The composition according to any one of statements 1 to 5, wherein the polypeptide is capable of binding to a lipid-containing fraction of the plasma membrane of Botrytis cinerea, said lipid-containing fraction being obtainable by a method comprising:
   fractionating hyphae of Botrytis cinerea by total lipid extract thin-layer chromatography and selecting the fraction with a Retention Factor (Rf) higher than the ceramide fraction and lower than the non-polar phospholipids fraction
7. The composition according to statement 5, wherein the plasma membrane component is a sphingolipid.
8. The composition according to statement 7, wherein the sphingolipid is a glucosylceramide.
9. The composition of statement 6, wherein the polypeptide is a heavy chain variable domain of a heavy chain antibody (VHH) and comprises the amino acid sequence set out in any one of SEQ ID Nos 1, 2, 6, 10 or 15 or an amino acid sequence having at least about 80% sequence identity thereto.
10. The composition of statements 7 or 8, wherein the polypeptide is a heavy chain variable domain of a heavy chain antibody (VHH) and comprises the amino acid sequence set out in any one of SEQ ID Nos 16 to 99 or an amino acid sequence having at least about 80% sequence identity thereto.
11. The composition of any one of statements 1 to 5, wherein the polypeptide is a heavy chain variable domain of a heavy chain antibody (VHH) and comprises the amino acid sequence set out in any one of SEQ ID Nos 1, 2, 6, 10 or 15 to 99 or an amino acid sequence having at least about 80% sequence identity thereto.
12. The composition of statement 1, wherein the polypeptide is a antimicrobial peptide or AMP.
13. The composition according to any preceding statement, wherein the at least one cell wall disrupting agent is an enzyme.
14. The composition according to statement 13, wherein the enzyme is a cell wall degrading enzyme.
15. The composition according to statements 13 or 14, wherein the enzyme is a glucanase and/or a chitinase.
16. The compositions according to statements 15, wherein the composition comprises one or more of a glucanase and one or more of a chitinase.
17. The composition according to statements 15 or 16, wherein the glucanase is a beta-1,3-glucanase.
18. The composition according to any one of statements 13 to 17, wherein the cell wall degrading agent is obtained or obtainable from a fermentation of one or more microbial species.
19. The composition according to statement 18, wherein the cell wall degrading agent is obtained or obtainable from a fermentation of one or more filamentous fungal species.
20. The composition according to statement 19, wherein the filamentous fungal species is one or more of a Trichoderma species and/or one or more of an Aspergillus species.
21. The composition according to statement 20, wherein the Trichoderma species is Trichoderma harzianum and the Aspergillus species is Aspergillus niger.
22. The composition according to statement 18, wherein the cell wall degrading agent is obtained or obtainable from a fermentation of one or more bacterial species.
23. The composition according to statement 22, wherein the bacterial species is a Arthobacter luteus.
24. The composition according to any one of statements 18 to 23, wherein the cell wall degrading agent is obtained or obtainable from a method comprising the steps of:
   a) culturing or fermenting one or more fungal or bacterial species, together or separately, under conditions to allow growth of the fungal or bacterial species;
   b) obtaining the fermentation broth or broths from step a);
   c) clarifying the fermentation broth or broths obtained from step b) to remove cellular material;
   d) optionally purifying the clarified broth or broths from step c) to increase the protein concentration of the broth or broths; and
   e) combining the broths if the fungal or bacterial species were cultured or fermented separately;
   thereby providing the cell wall degrading agent.
25. The composition according to any one of statements 18 to 21, wherein the cell wall degrading agent is obtained or obtainable from a method comprising the steps of:
   a) culturing or fermenting Trichoderma harzianum and Aspergillus niger, together or separately, under conditions to allow growth of the fungal species;
   b) obtaining the fermentation broth or broths from step a);
   c) clarifying the fermentation broth or broths obtained from step b) to remove cellular material;
   d) optionally purifying the clarified broth or broths from step c) to increase the protein concentration of the broth or broths; and
   e) combining the broths if the fungal species were cultured or fermented separately; thereby providing the cell wall degrading agent.
26. The composition according to any one of statements 18, 22 or 23, wherein the cell wall degrading agent is obtained or obtainable from a method comprising the steps of:
   a) culturing or fermenting Arthobacter luteus, under conditions to allow growth of the bacterial species;
   b) obtaining the fermentation broth from step a);
   c) clarifying the fermentation broth obtained from step b) to remove cellular material; and
   d) optionally purifying the clarified broth from step c) to increase the protein concentration of the broth;
   thereby providing the cell wall degrading agent.
27. The composition according to any one of statements 13 to 26, wherein the enzyme is active at temperatures from about 0° C. to about 50° C.
28. The composition according any one of statements 13 to 26, wherein the enzyme is resistant to denaturation.
29. The composition according to any one of statements 13 to 26, wherein the enzyme is resistant to denaturation at temperatures of from about 0° C. to about 50° C.
30. The composition according to any preceding statement, wherein, when applied to a fungus or to a plant or part of a plant comprising or infected by a fungus, the cell wall disrupting agent disrupts the cell wall of said fungus.
31. The composition according to any preceding statement, wherein the cell wall that is disrupted is the cell wall of a fungus.
32. The composition according to any preceding statement wherein the polypeptide and cell wall disrupting agent interact with the same fungal spore or fungal mycelium.
33. The composition according to any preceding statement, wherein said fungus is a plant pathogenic fungus.
34. The composition according to statement 33, wherein the genus of said plant pathogenic fungus is chosen from the group comprising Alternaria, Ascochyta, Botrytis, Cercospora, Colletotrichum, Diplodia, Erysiphe, Fusarium, Leptosphaeria, Gaeumanomyces, Helminthosporium, Macrophomina, Nectria, Penicillium, Peronospora, Phoma, Phymatotrichum, Phytophthora, Plasmopara, Podosphaera, Puccinia, Pyrenophora, Pyricularia, Pythium, Rhizoctonia, Scerotium, Sclerotinia, Septoria, Thielaviopsis, Uncinula, Venturia, Verticillium, Magnaporthe, Blumeria, Mycosphaerella, Ustilago, Melampsora, Phakospora, Monilinia, Mucor, Rhizopus, and Aspergillus.
35. A composition according to any one of the preceding statements, which is an agrochemical composition which optionally further comprises one or more agrochemically suitable carriers and/or one or more suitable adjuvants
36. Use of a composition according to any of one of the preceding statements as an anti-fungal agent.
37. The use according to statement 36 as an anti-fungal agent on plants.
38. Use of a composition according to any one of statements 1 to 35 in a method of treating or preventing a plant or a part of said plant from an infection with a plant pathogenic fungus.
39. A method for protecting or treating a plant or a part of said plant from an infection with a plant pathogenic fungus, at least comprising the step of applying to said plant or to a part of said plant, a composition according to any one of statements 1 to 35, under conditions effective to protect or treat said plant or a part of said plant against said infection with said plant pathogenic fungus.
40. A post-harvest treatment method for protecting or treating a harvested plant or a harvested part of said plant from an infection with a plant pathogenic fungus, at least comprising the step of applying to said harvested plant or to a harvested part of said plant, a composition according to any one of statements 1 to 35, under conditions effective to protect or treat said harvested plant or a harvested part of said plant against said infection with said plant pathogenic fungus.
41. A method of inhibiting or killing the growth of a plant pathogenic fungus, comprising at least the step of applying to a plant or to a part of said plant, a composition according to any of one of statements 1 to 35.
42. The method or use of any one of statements 36 to 41, wherein the composition is applied at an application rate of below 200 g of total weight of said polypeptide and cell wall disrupting agent per hectare.
43. The method or use of statement 41, wherein the application rate is between 10 g/ha and 100 g/ha.
44. A composition comprising a cell wall degrading agent, wherein the cell wall degrading agent is obtained or obtainable from a fermentation of one or more microbial species.
45. The composition according to statement 44, wherein the cell wall degrading agent is obtained or obtainable from a fermentation of one or more filamentous fungal species.
46. The composition according to statement 45, wherein the filamentous fungal species is one or more of a Trichoderma species and/or one or more of an Aspergillus species.
47. The composition according to statement 46, wherein the Trichoderma species is Trichoderma harzianum and the Aspergillus species is Aspergillus niger.
48. The composition according to statement 44, wherein the cell wall degrading agent is obtained or obtainable from a fermentation of one or more bacterial species.
49. The composition according to statement 48, wherein the bacterial species is a Arthobacter luteus.
50. The composition according to any one of statements 44 to 49, wherein the cell wall degrading agent is obtained or obtainable from a method comprising the steps of:
   a) culturing or fermenting one or more fungal or bacterial species, together or separately, under conditions to allow growth of the fungal or bacterial species;
   b) obtaining the fermentation broth or broths from step a);
   c) clarifying the fermentation broth or broths obtained from step b) to remove cellular material;
   d) optionally purifying the clarified broth or broths from step c) to increase the protein concentration of the broth or broths; and
   e) combining the broths if the fungal or bacterial species were cultured or fermented separately;
   thereby providing the cell wall degrading agent.
51. The composition according to any one of statements 44 to 47, wherein the cell wall degrading agent is obtained or obtainable from a method comprising the steps of:
   a) culturing or fermenting Trichoderma harzianum and Aspergillus niger, together or separately, under conditions to allow growth of the fungal species;
   b) obtaining the fermentation broth or broths from step a);
   c) clarifying the fermentation broth or broths obtained from step b) to remove cellular material;
   d) optionally purifying the clarified broth or broths from step c) to increase the protein concentration of the broth or broths; and
   e) combining the broths if the fungal species were cultured or fermented separately;
   thereby providing the cell wall degrading agent.
52. The composition according to any one of statements 44, 48 or 49, wherein the cell wall degrading agent is obtained or obtainable from a method comprising the steps of:
   a) culturing or fermenting Arthobacter luteus, under conditions to allow growth of the bacterial species;
   b) obtaining the fermentation broth from step a);
   c) clarifying the fermentation broth obtained from step b) to remove cellular material; and
   d) optionally purifying the clarified broth from step c) to increase the protein concentration of the broth;
   thereby providing the cell wall degrading agent.
53. A composition according to any one of statements 44 to 52, which is an agrochemical composition which optionally further comprises one or more agrochemically suitable carriers and/or one or more suitable adjuvants
54. Use of a composition according to any of one of the statements 44 to 53 as an anti-fungal agent.
55. The use according to statement 54 as an anti-fungal agent on plants.
56. Use of a composition according to any one of statements 44 to 53 in a method of treating or preventing a plant or a part of said plant from an infection with a plant pathogenic fungus.
57. A method for protecting or treating a plant or a part of said plant from an infection with a plant pathogenic fungus, at least comprising the step of applying to said plant or to a part of said plant, a composition according to any one of statements 44 to 53, under conditions effective to protect or treat said plant or a part of said plant against said infection with said plant pathogenic fungus.
58. A post-harvest treatment method for protecting or treating a harvested plant or a harvested part of said plant from an infection with a plant pathogenic fungus, at least comprising the step of applying to said harvested plant or to a harvested part of said plant, a composition according to any one of statements 44 to 53, under conditions effective to protect or treat said harvested plant or a harvested part of said plant against said infection with said plant pathogenic fungus.
59. A method of inhibiting or killing the growth of a plant pathogenic fungus, comprising at least the step of applying to a plant or to a part of said plant, a composition according to any of one of statements 44 to 53.
60. The method or use of any one of statements 54 to 59, wherein the composition is applied at an application rate of below 200 g of total weight of said polypeptide and cell wall disrupting agent per hectare.
61. The method or use of statement 60, wherein the application rate is between 10 g/ha and 100 g/ha.

1. A composition comprising at least one polypeptide and at least one cell wall disrupting agent.

2. The composition of claim 1, wherein the at least one polypeptide is an antibody.

3. The composition of claim 2, wherein the antibody is a heavy chain variable domain of a heavy chain antibody (VHH) or a functional fragment thereof.

4. The composition according to any one of claims 1 to 3, wherein the polypeptide specifically binds to a fungus.

5. The composition according to claim 4, wherein the polypeptide specifically binds to at least one plasma membrane component of said fungus.

6. The composition according to any one of claims 1 to 5, wherein the polypeptide is capable of binding to a lipid-containing fraction of the plasma membrane of Botrytis cinerea, said lipid-containing fraction being obtainable by a method comprising:
fractionating hyphae of Botrytis cinerea by total lipid extract thin-layer chromatography and selecting the fraction with a Retention Factor (Rf) higher than the ceramide fraction and lower than the non-polar phospholipids fraction

7. The composition according to claim 5, wherein the plasma membrane component is a sphingolipid.

8. The composition according to claim 7, wherein the sphingolipid is a glucosylceramide.

9. The composition of claim 6, wherein the polypeptide is a heavy chain variable domain of a heavy chain antibody (VHH) and comprises the amino acid sequence set out in any one of SEQ ID Nos 1, 2, 6, 10 or 15 or an amino acid sequence having at least about 80% sequence identity thereto.

10. The composition of claim 7 or 8, wherein the polypeptide is a heavy chain variable domain of a heavy chain antibody (VHH) and comprises the amino acid sequence set out in any one of SEQ ID Nos 16 to 99 or an amino acid sequence having at least about 80% sequence identity thereto.

11. The composition of any one of claims 1 to 5, wherein the polypeptide is a heavy chain variable domain of a heavy chain antibody (VHH) and comprises the amino acid sequence set out in any one of SEQ ID Nos 1, 2, 6, 10 or 15 to 99 or an amino acid sequence having at least about 80% sequence identity thereto.

12. The composition of claim 1, wherein the polypeptide is a antimicrobial peptide or AMP.

13. The composition according to any preceding claim, wherein the at least one cell wall disrupting agent is an enzyme.

14. The composition according to claim 13, wherein the enzyme is a cell wall degrading enzyme.

15. The composition according to claim 13 or 14, wherein the enzyme is a glucanase and/or a chitinase.

16. The compositions according to claim 15, wherein the composition comprises one or more of a glucanase and one or more of a chitinase.

17. The composition according to claim 15 or 16, wherein the glucanase is a beta-1,3-glucanase.

18. The composition according to any one of claims 13 to 17, wherein the cell wall degrading agent is obtained or obtainable from a fermentation of one or more microbial species.

19. The composition according to claim 18, wherein the cell wall degrading agent is obtained or obtainable from a fermentation of one or more filamentous fungal species.

20. The composition according to claim 19, wherein the filamentous fungal species is one or more of a Trichoderma species and/or one or more of an Aspergillus species.

21. The composition according to claim 20, wherein the Trichoderma species is Trichoderma harzianum and the Aspergillus species is Aspergillus niger.

22. The composition according to claim 18, wherein the cell wall degrading agent is obtained or obtainable from a fermentation of one or more bacterial species.

23. The composition according to claim 22, wherein the bacterial species is a Arthobacter luteus.

24. The composition according to any one of claims 18 to 23, wherein the cell wall degrading agent is obtained or obtainable from a method comprising the steps of:
a) culturing or fermenting one or more fungal or bacterial species, together or separately, under conditions to allow growth of the fungal or bacterial species;
b) obtaining the fermentation broth or broths from step a);
c) clarifying the fermentation broth or broths obtained from step b) to remove cellular material;
d) optionally purifying the clarified broth or broths from step c) to increase the protein concentration of the broth or broths; and
e) combining the broths if the fungal or bacterial species were cultured or fermented separately;
thereby providing the cell wall degrading agent.

25. The composition according to any one of claims 18 to 21, wherein the cell wall degrading agent is obtained or obtainable from a method comprising the steps of:
a) culturing or fermenting Trichoderma harzianum and Aspergillus niger, together or separately, under conditions to allow growth of the fungal species;
b) obtaining the fermentation broth or broths from step a);
c) clarifying the fermentation broth or broths obtained from step b) to remove cellular material;
d) optionally purifying the clarified broth or broths from step c) to increase the protein concentration of the broth or broths; and
e) combining the broths if the fungal species were cultured or fermented separately;
thereby providing the cell wall degrading agent.

26. The composition according to any one of claims 18, 22 or 23, wherein the cell wall degrading agent is obtained or obtainable from a method comprising the steps of:
a) culturing or fermenting Arthobacter luteus, under conditions to allow growth of the bacterial species;
b) obtaining the fermentation broth from step a);
c) clarifying the fermentation broth obtained from step b) to remove cellular material; and
d) optionally purifying the clarified broth from step c) to increase the protein concentration of the broth;
thereby providing the cell wall degrading agent.

27. The composition according to any one of claims 13 to 26, wherein the enzyme is active at temperatures from about 0° C. to about 50° C.

28. The composition according any one of claims 13 to 26, wherein the enzyme is resistant to denaturation.

29. The composition according to any one of claims 13 to 26, wherein the enzyme is resistant to denaturation at temperatures of from about 0° C. to about 50° C.

30. The composition according to any preceding claim, wherein, when applied to a fungus or to a plant or part of a plant comprising or infected by a fungus, the cell wall disrupting agent disrupts the cell wall of said fungus.

31. The composition according to any preceding claim, wherein the cell wall that is disrupted is the cell wall of a fungus.

32. The composition according to any preceding claim wherein the polypeptide and cell wall disrupting agent interact with the same fungal spore or fungal mycelium.

33. The composition according to any preceding claim, wherein said fungus is a plant pathogenic fungus.

34. The composition according to claim 33, wherein the genus of said plant pathogenic fungus is chosen from the group comprising Alternaria, Ascochyta, Botrytis, Cercospora, Colletotrichum, Diplodia, Erysiphe, Fusarium, Leptosphaeria, Gaeumanomyces, Helminthosporium, Macrophomina, Nectria, Penicillium, Peronospora, Phoma, Phymatotrichum, Phytophthora, Plasmopara, Podosphaera, Puccinia, Pyrenophora, Pyricularia, Pythium, Rhizoctonia, Scerotium, Sclerotinia, Septoria, Thielaviopsis, Uncinula, Venturia, Verticillium, Magnaporthe, Blumeria, Mycosphaerella, Ustilago, Melampsora, Phakospora, Monilinia, Mucor, Rhizopus, and Aspergillus.

35. A composition according to any one of the preceding claims, which is an agrochemical composition which optionally further comprises one or more agrochemically suitable carriers and/or one or more suitable adjuvants.

36. Use of a composition according to any of one of the preceding claims as an anti-fungal agent.

37. The use according to claim 36 as an anti-fungal agent on plants.

38. Use of a composition according to any one of claims 1 to 35 in a method of treating or preventing a plant or a part of said plant from an infection with a plant pathogenic fungus.

39. A method for protecting or treating a plant or a part of said plant from an infection with a plant pathogenic fungus, at least comprising the step of applying to said plant or to a part of said plant, a composition according to any one of claims 1 to 35, under conditions effective to protect or treat said plant or a part of said plant against said infection with said plant pathogenic fungus.

40. A post-harvest treatment method for protecting or treating a harvested plant or a harvested part of said plant from an infection with a plant pathogenic fungus, at least comprising the step of applying to said harvested plant or to a harvested part of said plant, a composition according to any one of claims 1 to 35, under conditions effective to protect or treat said harvested plant or a harvested part of said plant against said infection with said plant pathogenic fungus.

41. A method of inhibiting or killing the growth of a plant pathogenic fungus, comprising at least the step of applying to a plant or to a part of said plant, a composition according to any of one of claims 1 to 35.

42. The method or use of any one of claims 36 to 41, wherein the composition is applied at an application rate of below 200 g of total weight of said polypeptide and cell wall disrupting agent per hectare.

43. The method or use of claim 41, wherein the application rate is between 10 g/ha and 100 g/ha.
